(19) United States
(12) Patent Application Publication
(10) Pub. No.: US 2015/0058148 A1
(43) Pub. Date: Feb. 26, 2015

(54) SYSTEMS AND METHODS FOR AUTOMATICALLY ADJUSTING PRICING FOR GROUP ACTIVITIES OVER A DATA NETWORK

(71) Applicant: Aryk Erwin Grosz, Palo Alto, CA (US)

(72) Inventor: Aryk Erwin Grosz, Palo Alto, CA (US)

(21) Appl. No.: 14/531,935

(22) Filed: Nov. 3, 2014

Related U.S. Application Data
(63) Continuation-in-part of application No. 14/327,465, filed on Jul. 9, 2014.
(60) Provisional application No. 61/845,210, filed on Jul. 11, 2013.
(60) Provisional application No. 61/905,466, filed on Nov. 18, 2013.
(60) Provisional application No. 61/906,080, filed on Nov. 19, 2013.
(60) Provisional application No. 62/045,251, filed on Sep. 3, 2014.

(51) Int. Cl. G06Q 30/06; G06Q 30/02

(52) U.S. Cl. CPC G06Q 30/0605; G06Q 30/0283
USPC 705/26.2

(57) ABSTRACT

Disclosed herein are systems, methods, and apparatus for updating pricing information for participation in a group activity for a plurality of users. In one embodiment, a method comprises enabling definition of group activities for participation by the users, definition including at least attributes desired of users to participate; creating personal profiles for users of the system, including one or more of personal attributes, data regarding activity preferences, activity participation history, user location, and user calendar of pending activity; determining initial pricing to be enforced for participation in a pending group activity; evaluating information about users scheduled to participate in the pending group activity periodically after the initial pricing is determined; adjusting the pricing for the activity based on results of the periodic evaluation; and publishing an updated pricing accessible to the participating users over the network.

### CROSS REFERENCE TO RELATED APPLICATIONS

The present application is a Continuation-In-Part of and claims priority to non-provisional U.S. Ser. No. 14/327,465, filed on Jul. 9, 2014, entitled “SYSTEMS AND METHODS FOR CREATING AND MANAGING GROUP ACTIVITIES OVER A DATA NETWORK,” which itself claims priority to provisional applications U.S. Ser. No. 61/845,210, filed on Jul. 11, 2013, to U.S. Ser. No. 61/905,466, filed on Nov. 18, 2013, and U.S. Ser. No. 61/906,080, filed on Nov. 19, 2013. In addition, the present application directly claims priority to provisional application U.S. Ser. No. 62/045,251, filed on Sep. 3, 2014. The entire disclosures of each of the above-referenced applications are each hereby incorporated by reference in their entireties herein.

### NOTICE OF COPYRIGHTS AND TRADEDRESS

A portion of the disclosure of this patent related document contains material which is subject to copyright protection. This patent related document may show and/or describe matter which is or may become tradedress of the owner. The copyright and tradedress owner has no objection to the facsimile reproduction by anyone of the patent disclosure as it appears in the Patent and Trademark Office patent files or records, but otherwise reserves all copyright and tradedress rights whatsoever.

### FIELD OF THE INVENTION

The present invention is generally in the field of social networking over a data network, and pertains particularly to methods and apparatus for automatically aggregating individuals for the purpose of participating in group activities.

### BACKGROUND OF THE INVENTION

The statements in this section merely provide background relevant to the invention, and may not be prior art.

The field of Internet-hosted networking is continually evolving. Social networking comprises a subset of the broader field of Internet-hosted networking, which includes networking sites adapted for business professionals, such as LINKEDIN, MEETUP, and the like, as well as networking sites adapted for friends generally, such as FACEBOOK, and the like. In both business and social networking, a registered user has a user profile that generally captures a subset of information about the user that is rather limited in scope. The profile may include education, profession, partner status, and similar information so that other registered users may view it and decide whether or not to become connected to that user. Other categories of connections may include family and business associates.

In some networking sites, such as those tailored for business or professionals, other features like instant messaging, like, follow user, comment, status update, etc. are generally available. In some business and social networking sites, there may be events that are created or promoted through the sites where other users (both registered and unregistered) may be invited to attend. These events are typical events like musical events, parties, business seminars, and the like that are promoted by users who wish to take advantage of the social or business network to reach people in their social circles. Generally speaking these promotions are ad hoc and have no conventions for regulating exactly who is invited. In this vein the ability to control attendance and the characteristics of those attending are marginal at best. Therefore, what is needed is a network-based service that overcomes the limitations mentioned above relative to aggregating individuals to participate in group activities promoted over a network.

Furthermore, none of the existing social networks are able to accomplish the simultaneous task of allowing friends and acquaintances who are known to each other to participate in a group activity together with strangers.

Therefore, it would be an advancement in the state of the art to provide a system, method, and apparatus for intelligently and automatically grouping individuals into groups for the purpose of participating in activities. It would be a further advancement to allow both groups of friends and strangers to interact in social activities. Finally, it would be an even further advancement in the state of the art to allow the automatic generation of pricing information for participation in the group activity.

It is against this background that the various embodiments of the present invention were developed.

### BRIEF SUMMARY OF THE INVENTION

In an embodiment of the invention a system is provided comprising a network-connected server having a processor and coded instructions executed by the processor from a non-transitory physical storage medium, providing functions: enabling definition of group activities for participation by one or both of the user and other users, definition including at least attributes desired of users to participate, creating personal profiles for users of the system, including one or more of personal attributes, data regarding activity preferences, activity participation history, user location, and user calendar of pending activity, determining initial pricing to be enforced for participation in a pending group activity, evaluating information about users scheduled to participate in the pending group activity periodically after the initial pricing is determined, adjusting the pricing for the activity based on results of the periodic evaluation, and publishing an updated pricing accessible to the participating users over the network.

In one embodiment the network is the Internet network. In one embodiment the information about the users includes one or a combination of group profile data and user profile data. Also in one embodiment the information about the users includes information about users newly scheduled to participate in the group activity after the initial pricing. In yet another embodiment new pricing is generated regarding users for whom information has changed since a previous iteration. In still another embodiment new pricing is generated based on information about user participation history, including purchase history.

In one embodiment new pricing is generated based on changes in one or a combination of number of total participants, gender mix of participants, membership status of participants relative to the group activity, age mix of the participants and past behavior of participants at the same or similar activity. Also in one embodiment new pricing is generated based on information about registration to specific sub-activities included in the main group activity. In another embodiment original and new pricing is generated by a third-party vendor hosting and managing the group activity. And in another embodiment new pricing is generated based on information about amounts of monies users have spent on the activity prior to participation.

In another aspect of the invention a method is provided comprising steps: enabling, by execution of coded instructions from a non-transitory physical medium by a processor of a network-connected server, definition of group activities for participation by one or both of the user and other users, definition including at least attributes desired of users to participate, creating personal profiles for users of the system, including one or more of personal attributes, data regarding activity preferences, activity participation history, user location, and user calendar of pending activity, determining initial pricing to be enforced for participation in a pending group activity, evaluating information about users scheduled to participate in the pending group activity periodically after the initial pricing is determined, adjusting the pricing for the activity based on results of the periodic evaluation, and publishing an updated pricing accessible to the participating users over the network.

In one embodiment of the method the network is the Internet network. Also in one embodiment the information about the users includes one or a combination of group profile data and user profile data. Also in one embodiment the information about the users includes information about users newly scheduled to participate in the group activity after the initial pricing.

In another embodiment new pricing is generated regarding users for whom information has changed since a previous iteration. In yet another embodiment new pricing is generated based on information about user participation history, including purchase history. In another embodiment new pricing is generated based on changes in one or a combination of number of total participants, gender mix of participants, membership status of participants relative to the group activity, age mix of the participants and past behavior of participants at the same or similar activity.

In still another embodiment new pricing is generated based on information about registration to specific sub-activities included in the main group activity. In yet another embodiment original and new pricing is generated by a third-party vendor hosting and managing the group activity. And in yet another embodiment new pricing is generated based on information about amounts of monies users have spent on the activity prior to participation.

In another embodiment of the invention, a system is provided comprising a network-connected server having a processor, and coded instructions executed by the processor from a non-transitory physical storage medium, providing functions: registering a plurality of persons to the system, creating a profile for individual ones of the plurality of persons, the profile for each person comprising personal characteristics of the person, enabling the profiled person to create a group activity in the system, defining at least characteristics desired of the other persons by the first person to engage in the created group activity, using the characteristics desired of the other persons as search criteria to search for and match other persons to the created group activity, and inviting some or all of the matched persons to participate in the group activity.

In one embodiment, the network is the Internet network. Also in one embodiment, individual ones of other persons invited to a group activity accept the invitation to join the activity. Also in one embodiment, group activities created are populated by individual ones of the other persons accepting the invitations. In another embodiment, group activities created are stored and tracked while pending until the group activity takes place and is completed. In another embodiment, the system further comprises registered enterprises acting as activity vendors, wherein an individual activity vendor creates and promotes a group activity. In another embodiment, persons associated with a pending group activity are periodically reminded of the pending group activity.

In another aspect of the invention, a method is provided comprising steps: registering a plurality of persons to a system through execution of coded instructions from a non-transitory medium by a processor of a network-connected server, creating a profile for individual ones of the plurality of persons, the profile for each person comprising at least personal characteristics of the person, enabling the profiled person to create a group activity in the system, defining at least characteristics desired of the other persons by the first person to engage in the created group activity, using the characteristics desired of the other persons as search criteria to search for and match other persons to the created group activity, and inviting some or all of the matched persons to participate in the group activity.

In one embodiment, the network is the Internet network. Also in one embodiment, individual ones of other persons invited to a group activity accept the invitation to join the activity. Also in one embodiment, group activities created are populated by individual ones of the other persons accepting the invitations. Also in one embodiment group activities created are stored and tracked while pending until the group activity takes place and is completed.

In another embodiment, the method further comprises registered enterprises acting as activity vendors, wherein an individual activity vendor creates and promotes a group activity. In another embodiment, persons associated with a pending group activity are periodically reminded of the group activity.

Other embodiments of the present invention include systems, methods, and apparatus for automatically aggregating a plurality of system users into participants for a group activity having a plurality of assigned spaces, the participants automatically grouped into a plurality of subgroups based on desired attributes of each member of the subgroup. In some embodiments, the method comprises generating a personal profile of each system user; generating one or more preference profiles of a desired participant for a respective group activity; identifying the personal profiles of the system users that meet the one or more preference profiles; comparing information in the personal profiles to determine a strength-of-match between system users populating the group activity; grouping of the participants into the plurality of subgroups according to the strength-of-match between each member of the subgroup; and assigning the participants of the group activity, grouped into the subgroups, to the plurality of spaces in the group activity. For example, if an individual was assigned seats on a plane, the three seats attached together could comprise a subgroup, in one embodiment. In the case of one long row of chairs, the system is able to seat people optimally. In that situation, the system would weight the people to the left and the right of a given person the highest since those are the people easiest to interact with, and in such an embodiment, the subgroups are all of the subgroups consisting of three adjacent seats in a row. The system therefore solves an optimization problem where the system is maximizing the preferences between different individuals, individually, as well as to optimize overall seating optimization for the entire group, as described in greater detail below.

Other embodiments of the invention include the systems, methods, and apparatus described here, wherein the subgroups comprise two people in a pair.

Other embodiments of the invention include the systems, methods, and apparatus described here, wherein the assigned spaces are seats in an environment selected from the group consisting of transportation, buses, airplanes, boats, theater, movies, opera, dinner arrangements, auditoriums, arenas, and so on.

Other embodiments of the invention include the systems, methods, and apparatus described here, wherein the assigned spaces are seats in any event where seats can by assigned.

Other embodiments of the invention include the systems, methods, and apparatus described here, comprising the additional steps of determining initial pricing to be enforced for participation in a pending group activity; evaluating information about users scheduled to participate in the pending group activity periodically after the initial pricing is determined; adjusting of the pricing for the activity based on results of the periodic evaluation; and publishing of an updated pricing accessible to the participating users over the network.

Other embodiments of the invention include the systems, methods, and apparatus described here, wherein each personal profile comprises at least one respective attribute, each preference profile comprises at least one respective attribute, and personal profiles of system users that meet the preference profile comprise personal profiles that share a defined amount of attributes with the preference profile.

Other embodiments of the invention include the systems, methods, and apparatus described here, wherein each personal profile comprises at least one respective attribute, each preference profile comprises at least one respective attribute, and personal profiles of system users that meet the preference profile comprise personal profiles that share a defined combination of attributes with the preference profile.

Other embodiments of the invention include the systems, methods, and apparatus described here, wherein each personal profile comprises at least one respective attribute, each preference profile comprises at least one respective attribute, and personal profiles of system users that meet the preference profile comprise personal profiles that share a defined key attribute with the preference profile.

Other embodiments of the invention include the systems, methods, and apparatus described here, wherein a notification is sent to each system user with a personal profile that meets the preference profile.

Other embodiments of the invention include the systems, methods, and apparatus described here, wherein a system user comprises a system-identified user on a social interaction network accessible by the system, wherein access of profile information of said user on the social interaction network is used to generate a personal profile for said user.

Other embodiments of the present invention provide methods, systems, and apparatus wherein users can have multiple group profiles of which to match participants to. For example, current grouping technologies only have the ability to create a group (2 or more people) with one preference profile. For example, dating applications specify preferences for the dating groups. The present invention provides for a system that can create an event having two or more group preference profiles per event, per individual. For example, the system allows a creation of an event wherein all the men share one characteristic in common, and all the women share a different characteristic in common, therefore having two preference profiles for the event for each individual. In one concrete example, such an event could have all of the men be single and play football, and all the women be single and play softball. The current system involves advanced heuristics to optimize the group so that every member of the group, having multiple group profiles, are all optimized with respect to each of the multiple group preference profiles for each individual member.

Other embodiments of the present invention will become apparent from the detailed description that follows.

### BRIEF DESCRIPTION OF THE DRAWINGS

The drawings, when read with the detailed description, provide an understanding of the invention in which:

FIG. 1 is an architectural overview of a communications network supporting aggregation of individuals for participating in group activities.

FIG. 2 is a sequence diagram depicting interactions between basic components integral to a service for aggregating individuals for participating in group activities.

FIG. 3 is a block diagram depicting a matching engine for grouping users according to specific criteria specified by a user.

FIG. 4 is a block diagram depicting a monitoring and notification system for notifying users when other users participate or intend to participate in a group activity.

FIG. 5 is a block diagram depicting a system for dynamic management of contacts.

FIG. 6 is a block diagram depicting a system for browsing users and activities.

FIG. 7 is a process flow chart depicting steps for deriving a score for users matching a group profile during a search operation.

FIG. 8 is an architectural overview of a data network supporting determination of compatibility strength between users on the network.

FIG. 9 is a process flow chart depicting steps for determining a compatibility strength value between at least two network users.

FIG. 10 is a block diagram of a network supporting distribution of an interface for configuring and managing group profiles.

FIG. 11 is a display view of an interactive group profile template for building a custom group profile.

FIG. 12 is a block diagram depicting basic components and architecture supporting group profile matching and assessment of strength level of matching.

FIG. 13 is a process flow chart depicting steps for assigning a strength measurement or value to a set of matching group profiles.

FIG. 14 is a process flow chart depicting steps for creating pairs or subgroups of users participating in a group activity.

FIG. 15 is a block diagram depicting components involved in promoting group activities based on historical statistics about activity participation.

FIG. 16 is a process flow chart depicting steps for promoting a group activity based on behavioral attributes.

FIG. 17 is a block diagram depicting components involved in enabling a user to search for group activities hosted on a network.

FIG. 18 is a process flow chart depicting steps for searching group activities hosted on a network.

FIG. 19 is a block diagram depicting components involved in suggesting and promoting group activities to users based on location data and user availability.

FIG. 20 is a process flow chart depicting steps for suggesting and promoting one or more activities to users based on location and availability data.

FIG. 21 is a block diagram depicting components involved in automatic price adjustment for group activities.

FIG. 22 is a process flow chart depicting steps for adjusting pricing for a group activity based on one or more changed conditions.

FIG. 23 is a block diagram depicting components involved in generating a group profile from profile attributes of participating users.

FIG. 24 is a process flow chart illustrating steps for creating a group profile from participant data.

FIG. 25 is a process flow chart depicting steps for triggering automated registration for or notification of a group activity.

FIG. 26 is a block diagram depicting basic components for providing automatic notification which may include invitations to users of pending activities.

FIG. 27 is a block diagram depicting basic components for fulfilling vendor requirements in vendor-hosted or sponsored group activities.

FIG. 28 is a block diagram depicting steps for fulfilling group activity requirements for third-party vendors.

FIG. 29 is a sequence diagram depicting interaction between basic components integral to a system for managing conflicting user participation timeslots for overlapping activities.

FIG. 30 is a block diagram depicting an unscheduled group activity.

FIG. 31 is a process flow chart depicting steps for creating and filling requirements for enabling an unscheduled activity.

FIG. 32 is a block diagram depicting basic components for enabling user-participation rating relative to a group activity.

FIG. 33 is a process flow diagram depicting steps for publishing a ratings page and inviting participants to rate other participants.

FIG. 34 is a block diagram depicting an interface component for enabling a user to rank profile attributes.

FIG. 35 is a process flow chart depicting steps for ranking profile attributes.

### DETAILED DESCRIPTION OF THE INVENTION

### Definitions

“Group curation” refers to group aggregation based on specific criteria submitted by the user.
“Attributes” refers to user traits, characteristics, and qualities. In this regard, the user desires to participate in an activity that includes one or more other users that share certain traits, characteristics, and/or qualities.
“Activity” refers to a group activity requiring at least two individuals to participate.
“Group activity” broadly defines any activity requiring participation by two or more individuals. Activities may be created by users registered with the service.
“Activity vendors” are generally business entities that charge fees for or offer promotions through group activities. Activity vendor represents any entity that creates, promotes, or sponsors a group activity that the vendor desires to promote through the service in order to fulfill vacancies relative to the number of people desired or, in some cases required, in order for the activity to occur.
“Personal profile” is information about a user of the system that includes information, comprising gender, age, interests, photographs, etc.
“Preference profile” is information about one or more preferences of a user of the system, comprising information representing other users the user is interested in interacting with, including gender, age, interests, sexual orientation, etc.
“Initial pricing” is a price for participation in a group activity that is initially selected by the system.
“Adjusted pricing” is a price for participation in the group activity that is modified by the system after user activity and purchase history has been evaluated by the system.
“Publication” is a presentation (such as via a GUI on a browser) of information, including pricing information, in a format in which users can view the information on their user devices.
“Communications network” is a collection of terminal nodes, links and any intermediate nodes which are connected so as to enable telecommunication between the terminals. The Internet is a widely communications network.
“Storage medium” and “physical medium” refers to an article of manufacture in which computer program code may be stored, said program code later to be executed by a computer having at least one processor, such as a server.
“Data repository” refers to a central place, such as a database, where data is stored and maintained. It is also a logical (and sometimes physical) partitioning of data where multiple databases which apply to specific applications or sets of applications reside.
“Interface”, “user interface”, and “graphical user interface (GUI)” is a user interface (UI) in a display of a computer screen, where a user of a computer system can provide input.
“Client-server connection” is a connection between a sever and a user-operated computer via a communications network.
“User-device” and “user-operated computer” is a computer with a display, input options, a processor and a memory, often in the form of a laptop, desktop, tablet, smartphone, or the like.
Reference in this specification to “one embodiment” or “an embodiment” means that a particular feature, structure, or characteristic described in connection with the embodiment is included in at least one embodiment of the invention. The appearance of the phrases “in one embodiment” in various places in the specification is not necessarily all referring to the same embodiment, nor is a separate or alternative embodiment mutually exclusive of other embodiments. Moreover, various features are described which may be exhibited by some embodiments and not by others. Similarly, various requirements are described which may be requirements for some embodiments but not other embodiments.

### Overview

The invention provides a network-hosted system, service, and apparatus for aggregating individuals for the purpose of participating in user-sponsored or third-party sponsored group activities. The present invention is described in enabling detail using the following examples, which may describe more than one relevant embodiment falling within the scope of the present invention.

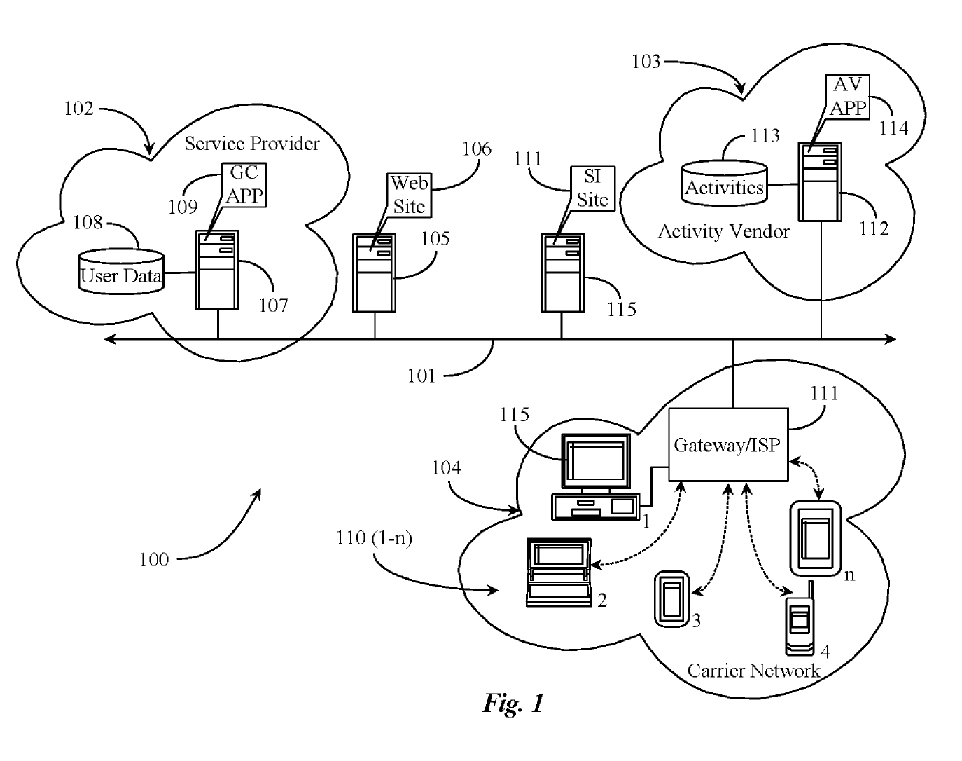

FIG. 1 is an architectural overview of a communications network supporting the aggregation of individuals for the purpose of participating in group activities. Communications network 100 includes an Internet network depicted herein by an Internet backbone 101. Internet backbone 101 includes all of the lines, equipment, and access points that make up the Internet network as a whole, including connected sub networks. Therefore, there are no geographical limitations to the practice of the present invention.

Communications network 100 includes a carrier network 104. Carrier network 104 is a communications carrier network capable of providing Internet access to users depicted herein as users 110 (1-n). Carrier network 104 may represent any wired or wireless carrier network, including a public switched telephone network (PSTN), a wireless digital network, or any subnet connected to Internet backbone 101 for the purpose of providing Internet access and communication over the Internet to users 110 (1-n).

Internet backbone 101 may be referred to hereinafter as Internet 101 in this specification. Internet 101 supports a web server 105. Web server 105 includes at least one data repository and a processor including accessible memory containing all of the instruction required to enable function as a web server capable of serving web pages to users. Server 105 may be hosted by a service provider such as service provider 102 depicted in this example. Server 105 may be hosted by a third-party without departing from the spirit and scope of the present invention.

Server 105 includes a website 106. Website 106 represents an access point to services offered by service provider entity 102. Website 106 may include log-in features and service registration features for users who wish to register for a social interaction service platform, hereinafter “Group Curation Platform.” A group curation platform is a social interaction platform that helps a user discover other users in the process of participating in one or more group activities available through the site. Users 110 (1-n) may go online through a media gateway/Internet service provider (ISP) 111 and may access website 106 to register for services or to access their account. Users 110 (1-n) may connect wirelessly or through wire lines to a gateway/Internet service provider (ISP) 111 having connection to Internet 101.

A service provider 102 is depicted in this example, and represents an enterprise promoting and providing the services of the present invention. Service provider 102 includes an application server 107. Application server 107 includes a data repository and a processor including memory containing all of the instruction required to enable function as an application server. Users visiting website 106 who have interest in joining the unique social interaction network offering group aggregation and curation services may be redirected from server 105 to server 107 to set up and activate their accounts. Users may then login directly into their accounts from website 106, or from any other portal or digital space having a link to the account interface.

Application server 107 includes a group curation (“GC”) application (“APP”) 109. GC application 109 facilitates access to services by serving a user interface (UI) to requesting users for display on their devices. A UI 115 is depicted in display on the desktop computer representing user 110 (1). UIs similar or the same as UI 115 are displayed on the devices of users 110 (2-n). Different versions of UI 115 may be served according to the type and operating platform of the requesting devices. In this example, the user-operated device includes a desktop computer (1), a laptop computer (2), a smart phone (3), a cell phone (4) and a tablet touch-screen device (n).

In one embodiment, the UI is downloaded to the requesting device and may be operated once the users log-in to their accounts. UI 115 and similar instances enable users to access different features and capabilities related to the group curation service. For example, GC APP 109 includes one or more components that allow users to create a group activity and to use the service to promote the activity and to aggregate other users to participate in the created activity. Group curation refers to group aggregation based on specific criteria submitted by the user. In this regard, the user desires to participate in an activity that includes one or more other users that share certain traits, characteristics, and/or qualities. For the purposes of this specification, the term “attributes” shall be used to refer to user traits, characteristics, and qualities.

Users registered with the service may create their own personal profiles that describe various aspects about themselves including, but not limited to, gender, race, sexual orientation, education level, college(s) attended, titles, job description, physical characteristics, religious affiliations, political affiliations, memberships in groups, and so on. The user profile is used later to help group users by certain attributes specified by other users, or by the system in some embodiments. Users may also create a preference profile through GC APP 109.

A preference profile is a string or list of attributes created by a user that defines generally or in more granular detail the types of individuals (characterized by attributes) that the generating user desires to interact with relative to participation in a group activity. A preference profile may list many of the same attributes that users have in their personal profiles so the system may match users to a preference profile, thus aggregating those users to form a group of users that are potential candidates for participating in the activity. A preference profile may be characterized as preferences submitted by a user, wherein the preferences are used as search criteria for discovering other users.

A user may create an activity profile. An activity profile is a string or list of activity types with or without additional attributes and/or conditions associated with it. For example, if a user is a hiker, then the activity of hiking and similar activities involving hiking may be listed by the user as activity preferences. In one embodiment, a user may add descriptors that describe the level of intensity and skill level for an activity. For example, in hiking, descriptors (added attributes to the title hiking) may include the descriptors easy, moderate, and difficult. In this way, more granularity may be added to a user's preference to engage in certain activities where varied levels of skill in the activity are possessed by individuals.

The term “group activity” broadly defines any activity requiring participation by two or more individuals. Activities may be created by users registered with the service. In one embodiment, activities may be sponsored or hosted by third-party vendors termed “activity vendors”. Activity vendors are generally business entities that charge fees for or offer promotions through group activities. An activity vendor 103 is depicted in this example. Activity vendor 103 represents any entity that creates, promotes, or sponsors a group activity that the vendor desires to promote through the service in order to fulfill vacancies relative to the number of people desired or, in some cases required, in order for the activity to occur.

Activity vendor 103 includes an activity server 112. Activity server 112 includes at least one data repository and a processor with memory storing all the instructions required to serve configured activities for promotion through the service. Through some business or contractual arrangement, agreement activity vendor 103 may work with service provider 102 to get activities promoted and filled with individuals. An activity vendor may maintain preference profiles that may be linked to certain activities to define generally, or in a more granular way, the types of individuals with which the entity desires to fill the vacancies.

Server 112 hosts an activity vendor (“AV”) application (“APP”) 114. Application 114 includes functionality for describing activities and for configuring requirements and parameters for activity participation including participant requirements, pricing, seat availability, etc. Configured activities for promotion may be stored in a data repository such as repository 113 labeled “activities”. Configured activities are digital files that may be transmitted from server 112 over Internet 101 to server 107 where they may be promoted and stored with other activities, either user created or system created.

In one embodiment, individuals that might participate may be un-registered users having profiles that are discovered on a social interaction network. Data about potential activity participants may be leveraged to help aggregate such individuals for activity participation. Information that may be leveraged includes, but is not limited to, profile information, friend status, and geographic location of the individual. Internet 101 supports a web server 110 adapted to host a social interaction (“SI”) website 111. Individuals that are registered with the service of the invention may give permission to the service to access profile information and friend status from their homepage. Such information may be supplemental to their service profile information and association states with other users on the curation platform.

In one aspect of the present invention, an activity that is promoted may accept non-registered users as participants. In one embodiment, the non-registered users may be members of one or more social interaction groups that maintain profile data and other data on behalf of those users. In this aspect, non-registered users may be invited through their social network profile pages to participate in pending activities as part of a recruitment campaign for new members or as part of a regular service agreement. In one embodiment, such users may subscribe to the service of the present invention and may receive messages and status updates from the service through their social interaction messaging and/or posting interface.

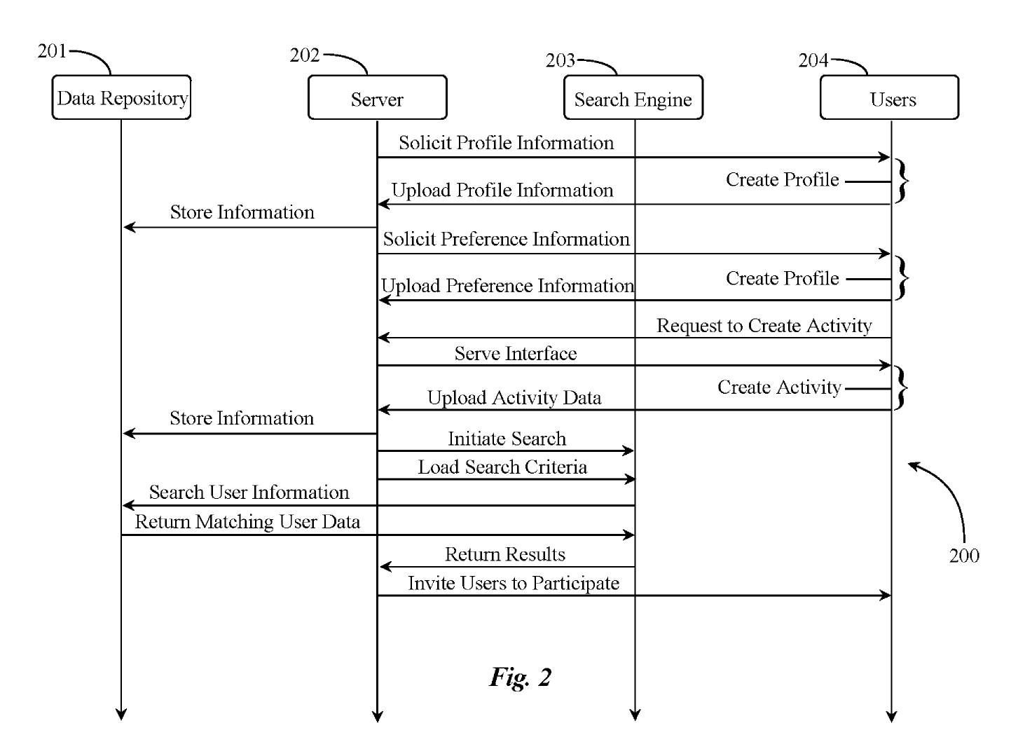

FIG. 2 is a sequence diagram 200 depicting interaction between basic components integral to a service for aggregating individuals for the purpose of participating in group activities. Sequence diagram 200 involves a server 202 that is analogous to server 107 of FIG. 1 above. Server 202, aided by instruction analogous to GC application 109 of FIG. 1, may solicit profile information from registered users through an electronic interface like interface 115 of FIG. 1. The profile information is solicited for the purpose of later using the information to group individuals together who share certain traits, commonalities, outlooks, etc. Profile information may include typical demographic information like age, gender, political affiliations, ethnicity, religious affiliations, education level, and other such information. Profile information may also include other attributes that may classify the individual in a more granular way. These attributes may include, but are not limited by, the attributes of occupation, annual income, drink or not, smoke or not, marital status, engagement status, kid status, activity level, humor characteristics, and sexual orientation. Other attributes not discussed here may also apply.

Server 202 solicits profile information from a user, generally by serving an electronic interface to the user's end device. In this example, the end device is represented by a box labeled users 204. Users 204 represent connected devices able to access the network and display the electronic interface, such as user-operated devices 110 (1-n) described above. The interface includes at least one template or form for the user to fill-in with profile data. In one embodiment, a profile management application may make available certain categorical information and statistics in order to aid users in what types of information they are willing to add to the network. Once users 204 are connected they may create their profiles. In one embodiment, they may create their profiles off-line and then upload the profiles after they log-in to the service. Users 204 upload their profile information to server 202.

Server 202 stores the profile information uploaded by users 204. The information describes the personal profile data submitted by the users. Server 202 may solicit preference information from users 204. Preference information includes profile attributes that describe the classes or types of individuals with whom users want to participate in certain activities. In one embodiment, preference information may be linked or tied to specific types of activities in which users wish to participate. For example, for one activity type, a user may specify preferences for the types of individuals the user desires to interact with for that specific activity type. In this aspect, the preference information uploaded by a user for a different activity type may be different.

Preference information may be likened to a preference profile that may or may not be associated with a specific activity category or type. Users 204 may create preference profiles and upload them to server 202 using the same electronic interface used to upload personal profile information. Server 202 stores and maintains the preference data in repository 201.

Users 204 may create group activities through the electronic interface. Group activity types that are created by users may include virtually any type of activity requiring two or more participants. The term “activity” used in this specification shall refer to a group activity requiring at least two individuals to participate. Group activities may be created that are free to participants or that require participants to pay a fee to join. Users may, at any time while connected to server 202, request to create a group activity. Server 202 may serve users 204 an electronic interface analogous to interface 115 of FIG. 1 including a template, form, or other input field(s) for entering group activity information including activity type, number of participants desired, pricing information, location, time and date, etc.

Once a group activity is created, the user uploads the group activity data to server 202. The server stores and maintains the activity information in a repository, such as data repository 201. Group activities that have specific start times and dates may be scheduled on a calendar application or database reminder application so that updates, such as reminders and the like, can be generated and sent to participating users. After a user creates a group activity, server 202 may initiate a data search operation to discover users who may be interested in participating in the created activity. A search engine may be leveraged that may search data stores for users or individuals whose personal profile attributes have some level of match to one or more preference profiles created by the user(s) sponsoring the activity.

A group activity might be generated by one user, but there may be more than one user that hosts, sponsors, or otherwise is responsible for one or more aspects of a group activity. For example, a group activity might be a bake sale for the parent/teachers organization (PTO) that is actually created by one user from the group. In another case, a group activity for conducting interviews to fill one or more job positions might be created by a user who is a manager for a company that may have other users at the event. In other cases, a group activity might be a fishing day on a boat owned by one user who generated the activity. Server 202 may submit specific search criteria for the group activity that was previously specified by the generating user, as preference profile data or attributes that define the characteristics and attributes of individuals the user wishes to attend the group activity.

Search engine 203 performs a data search of personal profile information previously stored in a data repository, such as repository 201, associated with individuals who might qualify by attribute matching as participants for the generated group activity. In one embodiment, preference attributes submitted by users are used as search criteria to match against attributes of personal user profiles. In one embodiment, a percent matching threshold is enforced to limit the search results to users whose personal profiles significantly match the preference profile submitted by the user to a percentile at or above the preset threshold value. In one embodiment, the preference profile used as the search criteria is tailored for the group activity. In other words, the attributes in the preference profile are the attributes that the user desires the participants to have in their personal profiles.

Once the results are aggregated, they are returned by the search engine. The results include at least the identification of matching individuals and their contact information. The results may be recorded and might be listed electronically for user evaluation. In one embodiment, the user may receive the results in a list and may manually invite users. In one embodiment, the system automatically invites any individuals that match the criteria for participation, including the submitted preference attributes. Server 202 receives the results from the search engine, and using an automated notification application, automatically generates and sends invitations out to those matching individuals. Notifications may be sent in the form of emails, text messages, postings, voice calls, etc.

In sequence diagram 200, the process focuses on system-initiated search, match, and automated notification to those individuals considered suitable as candidates for participation. Individuals who receive notifications may join the activity or may decline the activity. If an individual does not respond to notifications, the system may interpret that as a declination of the invitation. The system maintains the group activity on a calendar or scheduling application, and may provide timely alerts or notifications to individuals who have signed up to participate. In one embodiment, the system may automatically enter the activity information to the individual's personal calendar application or scheduling application in addition to maintaining an activity schedule at the server.

In one embodiment, the group activity includes one or more sub-activities in which the participants might participate. The system may, in one embodiment, perform additional attribute matching at a more granular level relative to the known participants to determine which of the main participants would be good candidates for any optional sub-activities available to those participating in the main activity. An example might be a business seminar where a main group of individuals is participating. Sub-activities in this case might include specific workshops for which a portion of the individuals in the main participation group would likely be candidates. Those individuals may be determined by further matching, if necessary. Those who match the attributes desired for the sub-activities may be solicited or invited to join those sub-activities while attending the main event.

### Matching Engine

In one embodiment of the invention, a matching engine is provided in the form of logic integrated with a search engine, such as search engine 203 described above. The matching engine may perform additional functions, such as ranking and sorting search results based on user-submitted criteria that are more granular than criteria for matching profile attributes to preference profile attributes used as search criteria by the search engine.

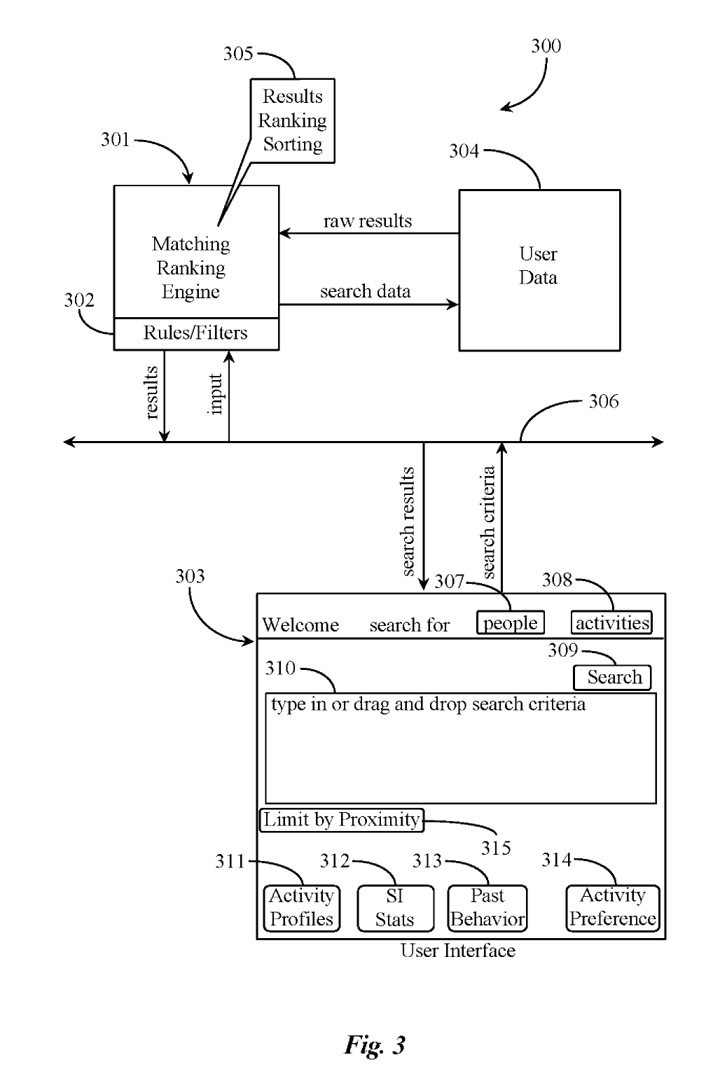

FIG. 3 is a block diagram 300 depicting a matching engine for grouping users according to specific criteria specified by a user. A matching engine 301 is depicted in this example and is adapted for creating virtual groupings of network users for consideration in participation in group activities. Matching engine 301 is hosted on a server maintained by a service provider. Matching engine 301 may be executed through a user interface 303 operated by a network user that is connected to the hosting server over the Internet network 306.

User interface 303 may be analogous to user interface 115 of FIG. 1, wherein a search interface may be executed and displayed on the connected user's device display. User interface 303 depicts a search page requested by the operating user for the purpose of searching for potential users that may be candidates for participation in a group activity created and promoted by the operating user. Interface 303 depicts a welcome greeting and a search option 307 for initiating a search. Interface 303 includes a search option 308 for searching for pending activities.

Interface 303 includes at least one text input field 310 adapted to accept criteria specified by the operating user for not only matching network users to the criteria, but also for ranking the search results and sorting the results according to additional user criteria. In one embodiment, a user may type search criteria into field 310, or the user may drag and drop criteria into the field from some other pre-existing data source. In one embodiment, a user may have one or more activity profiles 311, also termed “preference profiles” in this specification, attached to their accounts relative to certain activity types created by the user and pending in the system, or that are created by other users, activity vendors, or the system itself. Option 311 allows the operating user to select from pre-generated activity profiles. The operating user may see a list of activity profiles by selecting option 311 and may select an activity profile to add to field 310 by drag and drop operation.

An activity profile contains a list or string of attributes relative to other network users which the operating user may desire the users who are ultimately invited to participate in a specific activity have in common, as specified in their personal profiles. The data format of the attributes used as search criteria may vary. In one aspect, the list is a collection of words separated by commas or semicolons. In one aspect, the list is a binary string. In still another aspect, the list of attributes is presented in a markup language or some descriptive code language. It is important to note herein that the attributes contained in activity profiles attached to a user account may vary widely from profile to profile depending upon the activity type for which users are being grouped. For example, the attributes desired of individuals invited to participate in a hiking trip may be completely different from the attributes desired of individuals invited to participate in a music concert. The attributes submitted into field 310 are used in at least one matching algorithm designed to search user data stores, illustrated herein as user data 304, to discover candidate users for consideration in participation in the activity.

In one embodiment, an operating user may, through interface 303, add further criteria on top of activity profile criteria in order to further refine or narrow search results more to the user's liking. One such option 312 allows the operating user to add social interaction statistics as search criteria. By selecting option 312, the user may see examples of social interaction (“SI”) statistics that might be used to match individuals who have social interaction accounts containing information that has been made available to the system of the present invention through permission, contract, or by other methods. Examples of SI statistics might include, whether or not individuals have SI accounts where information is available. Another example might be how many “mutual friends” the operating user and potential activity participation candidates share. Another example might be how many SI friends that the potential activity participants have associated with their accounts. An SI account may also be an account hosted by the service where individual users may maintain personal profiles, and may friend and follow other users on the service of the invention.

In one embodiment of the invention, an operating user may select an option 313 to see examples of behavioral statistics or past behavior of network users with respect to activity participation in the recent or more distant past. An example of such behavioral statistics might include whether or not an individual has ever participated in the promoted activity or the number of times the individual has participated in the same or a similar activity. Another example might include records of activity “likes” and “dislikes” that may be associated with individual account data.

In one embodiment of the invention, an option 314 is provided for adding search criteria in the form of activity preference data to match activity preference indications made by or discovered about candidate individuals. An activity preference statement is simply a list or an indication of one or more activity types or specific pending activities that a user wants or desires to attend. This information may be solicited from users, updated periodically, and attached to user accounts. Activity following data may be part of this information as well as archived or recorded data from any activity searches submitted by candidate users.

In one embodiment, an operating user may select one or more options 312-314 to access partly fill-able electronic forms that help the user determine and quantify the added search criteria. For example, in SI module 312, a form may pop up with a statement that a user has certain friends in common. The user may then fill in the friends in common desired. The resulting search results may then be further ranked and sorted based on those criteria. In this way, it is possible for a user having a pending activity to populate it with participants, to refine the list of candidates in a very granular way. A user may further refine search results by specifying a proximity threshold value to impose as a condition for participation. A proximity setting option 315 is provided and adapted to enable the user to pre-specify a proximity threshold such as “show matching individuals within 10 miles” of the geolocation of the pending activity. Once all of the search criteria are submitted, the input is uploaded to matching engine 301 over Internet 306.

Matching engine 301 includes a rules base, rules cache, or repository 302 that contains any rules and any filters, including customer added filters, used to further refine search results. Engine 301 uses the input data in the search engine process, looking for qualified users in user repository 304. Raw results are returned to matching engine 301 for further processing. Matching engine 301 includes a results ranking and sorting application 305 for further refining raw results before presenting final search results to the operating user for display in interface 303. In this embodiment, ranking may cause an individual who scores high on matching attributes to be weighted lower in the results based on the individual not satisfying some other user-specified condition. Likewise, an individual who scores low on matching attributes may be weighted higher in the results based on the individual satisfying some other user-specified condition.

In one embodiment, a criterion within the criteria submitted as search input is critical for inclusion into a group result. For example, an individual may not qualify to participate in an activity specified by a user. However, if the individual is an SI “friend” of the operating user, that may be sufficient to guarantee that the individual will get an invitation regardless of other indications or qualifications observed. In one embodiment of the invention, a user may simply type in key words and phrases to use to search for other individuals for participation in a group activity. In this embodiment, the system may simply search user profile data for anything that matches the user input.

It is noted herein that over time, user profile data, activity profile data, as well as other data considered for matching individuals to a group activity may change and evolve. Therefore, subsequent searches performed to group individuals may return different results for the same activity type, search input, and ranking rules applied. After ranking search results, the results may be sorted according to some order specified by the operating user.

### User Notification of Activity of Other Users

In one embodiment of the invention, users may be notified when other users sign up for a group activity or are interested in attending a group activity.

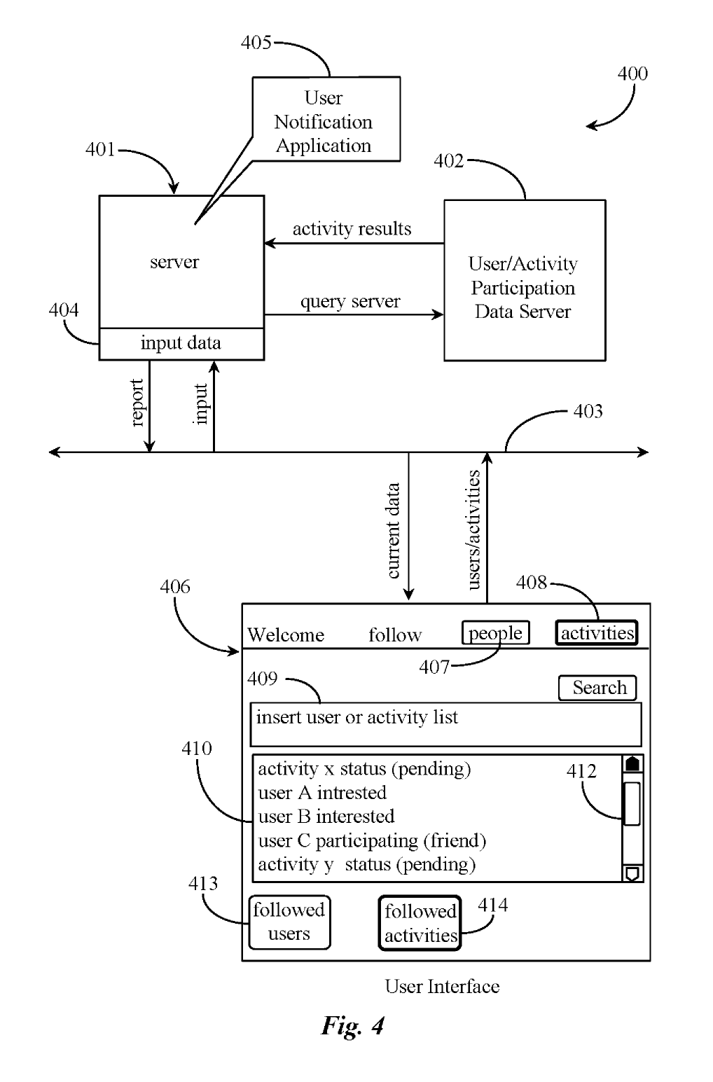

FIG. 4 is a block diagram depicting a monitoring and notification system 400 for notifying users when other users participate or intend to participate in a group activity. System 400 includes a server 401. Server 401 may be analogous to server 107 of FIG. 1 above. Server 401 includes a processor and at least one data repository, the processor including memory containing all of the software and instruction to enable function as a data server. Server 401 is connected to an Internet backbone 403. Server 401 is adapted to communicate with other servers connected to the network and with the aid of SW may perform searches of data sources and may query other network-connected servers in the course of performing its duties.

A user interface 406 is depicted in this example and represents any operating user connected to server 401 using a computing appliance or device running a browser capable of network navigation and communication. User interface 406 may be analogous to user interface 115 of FIG. 1. An operating user is assumed to be present and operating interface 406 in this example. The user operating appliance 406 may connect to server 401 over Internet 403 and access user interface 406 for display and operation.

User interface 406 may be analogous to interface 115 of FIG. 1. In this embodiment, the operating user desires to be notified when users that the operating user is following are participating in or plan to participate in a group activity. In one embodiment the operating user has an option 407 to follow people (other users) who are clients of the service. In one embodiment the operating user may follow activities by invoking option 408 for following specific activities.

In following people the operating user may select option 407 and then select other users to follow so that the system can monitor those users with respect to activity participation and then notify the user of their states on demand or in periodic updating. In following activities, the operating user may select option 408 and then submit information relative to activity types and or specific activities that are pending in the system and that the operating user may be interested in following.

In one embodiment the operating user may follow both people and activities simultaneously. Interface 406 includes an input field 409 for accepting user input relative to other users and/or activities the operating user wishes to follow. In one embodiment the operating user may retrieve a pre-configured list containing at least the identifications of other users that the operating user is currently following by invoking option 413 to view and/or access a list of followed users. In one embodiment the operating user may add to the list or subtract from the list during editing operations.

In one embodiment an operating user may follow specific group activities that are pending in the system. The operating user may retrieve a list of followed activities by invoking an option 414 labeled followed activities. An operating user may retrieve a preconfigured list of followed users or may generate one through interacting with option 413. Invoking option 413 may result in display of a configuration interface that allows the operator to browse other network users and to determine which of those users, if any, to follow. In one embodiment the operator may initiate a search for users whose profile attributes match to preference attributes specified by the operating user. The operating user may elect to follow all users whose profile attributes match those attributes specified by the operator in a preference profile or activity profile.

In another embodiment the operating user may follow other users indirectly by following certain activities in which the operator is interested in participating. When following a group activity that is pending in the system the operating user may be notified periodically of the state of commitment by other network users to participate in the activity. In this way the operating user may find that one or more other users that are being followed by the operating user are signed up to participate in the activity or has viewed the activity and have expressed interest in participating in the group activity.

In this example the operating user has invoked option 414 and submits a portion or all of the activity data as an activity list into input field 409. The user may then search the pending activities and see the participation states associated with those activities. In one embodiment the user may select one or more than one followed activity for use as search criteria. The activity list is uploaded to server 401 as input data 404 for inclusion in a query or search operation. In this example the data is used in a query sent from server 401 to a data server 402. Data server 402 is adapted to look for and return current information about the activities identified in the query.

Server 402 may use a state monitoring application (not illustrated) to monitor all pending activities in the system for participation status. Participation status may include the number of and identification of the other network users who are signed up to participate in the group activity. Participation status may also include the number of and identification of all the other network users who are interested in the activity but have not yet signed on to participate in the activity. Server 402 obtains the latest information and returns the results to server 401 acting as a proxy in this example. In another embodiment the operating user's device might be redirected to server 402 and may submit the query directly to the server. In one embodiment network users may control whether or not they may be followed by other users.

Server 402 returns activity results back to server 401. The activity results include at least the activity descriptions, activity schedules, and identification of users that are currently signed up to participate in the activity or that are receiving alerts or notifications related to the activity. Server 401 may compile the results into an activity report or summary with the aid of notification application 405. The report or summary may be sent to the operating user as current activity data for display on the user's connected device. In this example, the activity data is displayed in a results window 410.

The summary may list the status of one or more than one pending activity and associated user data. In window 410, activity X has user A and user B interested in the activity. In this case the users have applied to receive updates on the activities because they are interested in attending but have not yet signed on to participate. User C is participating in the activity, meaning the user has signed on to participate in the activity. User C is a “friend” or the operating user receiving the notification. Window 410 may be scrolled using a scroll bar 412. Activity Y is also included and the users associated with activity Y can be viewed by scrolling down in the window.

In another embodiment, the operating user may insert a user list into input field 409. The user list may be a list of users who are being “followed” that the operating user has preconfigured for use in a search or query. In the event the operating user has elected to receive notification based on a user list, the identified users would be listed with the activities they have signed on to or are interested in under each listed user. Data about followed users may include whether the user is a “friend” of the operating user. Data may also include whether the user and the operating user have any mutual friends or any other associative relationship that might be iterated in the results.

In one embodiment the operating user may request periodic updates based on a single query or search for the same list of users or activities that are followed. In one embodiment the operating user may first search for compatible users for certain activities for which there is interest, and then elect to follow some or all of those users receiving continuing updates. In one embodiment the operating user may first search for pending activities and then elect to follow some or all of those activities with respect to any users who might have interest in or have signed on to participate in the followed activities. Any updates discovered through monitoring are included in the next notification or alert to the operating user.

### Dynamic Contact List Management

In one embodiment, the evolving state of an operating user's friends and following list may be incorporated into a contact list associated with any communications applications or applications that support communication residing on the operating user's server-connected device.

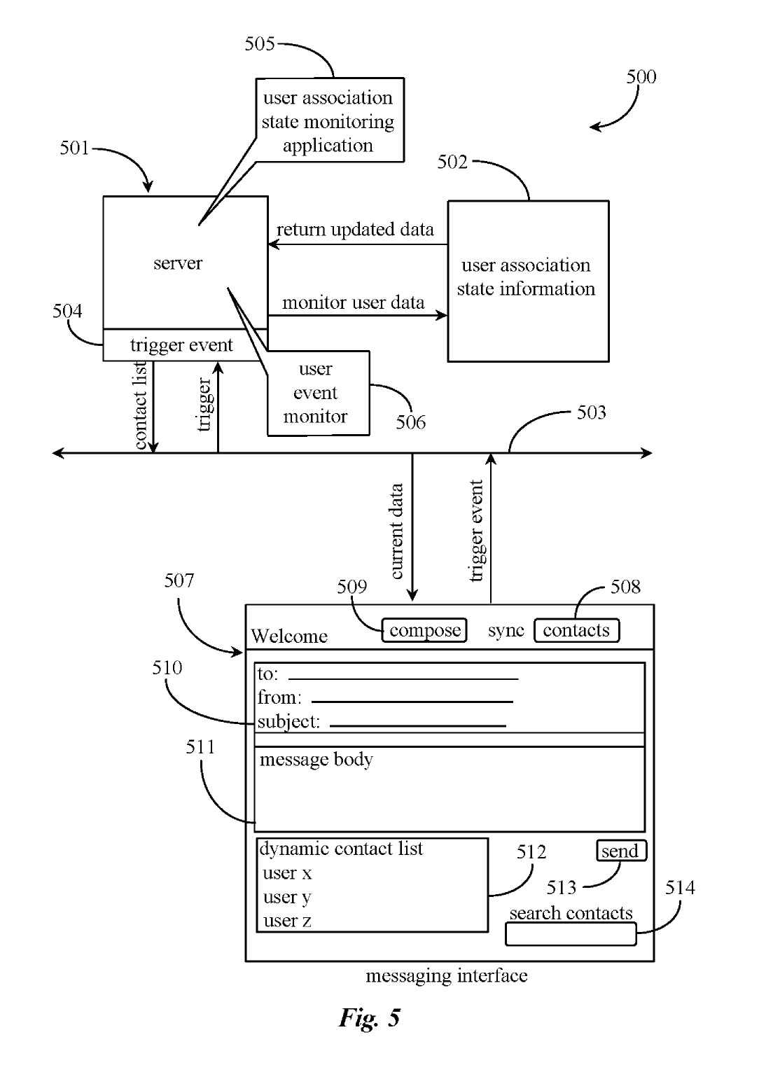

FIG. 5 is a block diagram 500 depicting a system for dynamic management of contacts. Diagram 500 depicts a server 501 having connection to an Internet network 503. Server 501 is analogous in description to server 107 of FIG. 1. Server 501 hosts a user association state-monitoring application 505. Association state refers to the state of association an operating user has with other network users registered with the service of the present invention. For example some other network users may be social interaction contacts of the operating user and therefore may exhibit different states of association to the operating user. An association state may be friend, family, associated, contact with one or more mutual friends, and so on. Likewise, some of the network users may be users that the operating user has elected to follow in order to be informed when those users perform an action, such as signing on to participate in a group activity, that the user is interested in or registering an interest in participating in a group activity.

State monitoring application 505 may be integrated with group curation application 109 of FIG. 1. In this example, association state information for users relative to other users is stored in a data repository 502 on behalf of operating users. Operating users refers to users who are practicing the invention in some form. Repository 502 is analogous to repository 108 of FIG. 1. It will be apparent to one with skill in the art that data stored for users may be held in one data storage facility or in more than one data storage facility without departing from the spirit and scope of the present invention.

In this example an operating user is working with a messaging interface associated with a user interface analogous to interface 115 of FIG. 1. However, other applications resident on the connected operator's device may be enhanced for dynamic contact management according to one or more aspects of the invention. Server 501 hosts a user event monitoring application 506. User event monitor 506 may be part of the group curation application described further above. User monitoring application 506 monitors events occurring on the operating user's connected device. More specifically, the application monitors for any trigger event that would support the necessity of a contact list. Initiation of communication from the user's connected device using any application serves as a classic trigger event.

Messaging interface 507 includes an option 509 for composing a message. In this example, the operating user is in the process of drafting a message to send. The message includes an address pane 510 for inserting one or more contact addresses as recipients or receivers of the message. A message body 511 is provided for containing the message text. Interface 507 includes a dynamic contact list 512. Contact list 512 may contain contact information about users who are not subscribed to or are not otherwise participating in the service of the invention. Dynamic contact list 512 may include the contact information of users that, like the operating user, are registered with the group curation service of the invention.

Messaging interface 507 may be an interface that is integrated with other features in the user interface accessed by the operating user in order to practice the invention. In another embodiment, the messaging interface may be tied to an application that is resident on the user's connected device or appliance. In one embodiment a user may synchronize contacts relative to a user contact list by invoking sync contacts option 508. In this regard, any contact information held for the operating user by the service may be sent to the operating user wherein the individual contacts are imported into, extracted to, or otherwise made a part of the regular contact list for that application. Interface 507 includes an option 514 for searching contacts and an option 513 for sending messages once they are satisfactorily drafted. Other features and functions typical of a communications interface may be assumed to be present in this example.

Some information about state associations between an operating user and other users is preconfigured by the operating user such as users being followed, for example. Some information about state associations between an operating user and other users is discovered by the system, such as by analyzing social graph information with respect to other users who may have mutual friends or contacts, have engaged in certain activities together, or have some other discoverable aspect that could be viewed as an associative state between the users. Therefore the aggregate of an operating user's states of association with other users may evolve and change over time regardless of the user's actions.

In use of the present invention, contact list 512 may be updated with contact information discovered through monitoring of user association state information relative to the operating user in combination with monitoring of user initiation of communication using any application that is associated with a contact list. In response to a monitored trigger event detected at server 501 with the aid of user event monitor 506, server 501 returns a list of contacts to the operating user's device that are incorporated into contact list 512 associated with the messaging interface. The contact information sent as current data represent any additional contacts that may be incorporated into the operating user's list of contacts based on new discovery of associations between the operating user and the potential contacts.

In one embodiment of the invention, messaging interface 507 is a feature of the service of the invention. New contact data may be added when some state between the operating user and the added contact is known, such as a following state, joining a same activity, interested in a same activity, became friends in a social application, became friends on the service of the invention, or any other state of association deemed sufficient to include the contact information in a list of contacts. In one embodiment being added to another user's contact list based on discovered or preconfigured association is an option for any user. In this embodiment a user may elect not to be added to another user's list unless permission is given. In one embodiment the added contact data is flagged or marked in the operating user's contact list in order to keep it separated from other regular contacts until the operating user has accepted the added information. In one embodiment if a state association no longer exists between the operating user and any added contact, the contact may be automatically removed from the operating user's contact list.

In one embodiment geolocation of a user relative to an operating user and a group activity that both users are interested in is sufficient for adding the contact data to the operating user's contact list. The operating user's contact data for messaging may also be reserved to add to the other user's contact list based on a next trigger event. This may also be the case when adding any contact data to the operating user's list that the operating user's data is made available to the user whose contact data was added.

In one embodiment application 505 may consult one or more filters or follow one or more rules relative to users whose contact information may be targeted for addition to a contact list of another user. For example, the contact information might be withheld even though a common association state exists between the users if the users are not compatible based on common attributes, are not interested in the same activities, or some other rule or filter that defines one or more additional conditions which must be met before transferring any contact information to the user's appliance or device.

### User Operated Browsing Interface

In one embodiment of the present invention an operating user connected to the service over the network may browse other network users registered with the service and any activities that have been created by the service, activity vendors, or other network users.

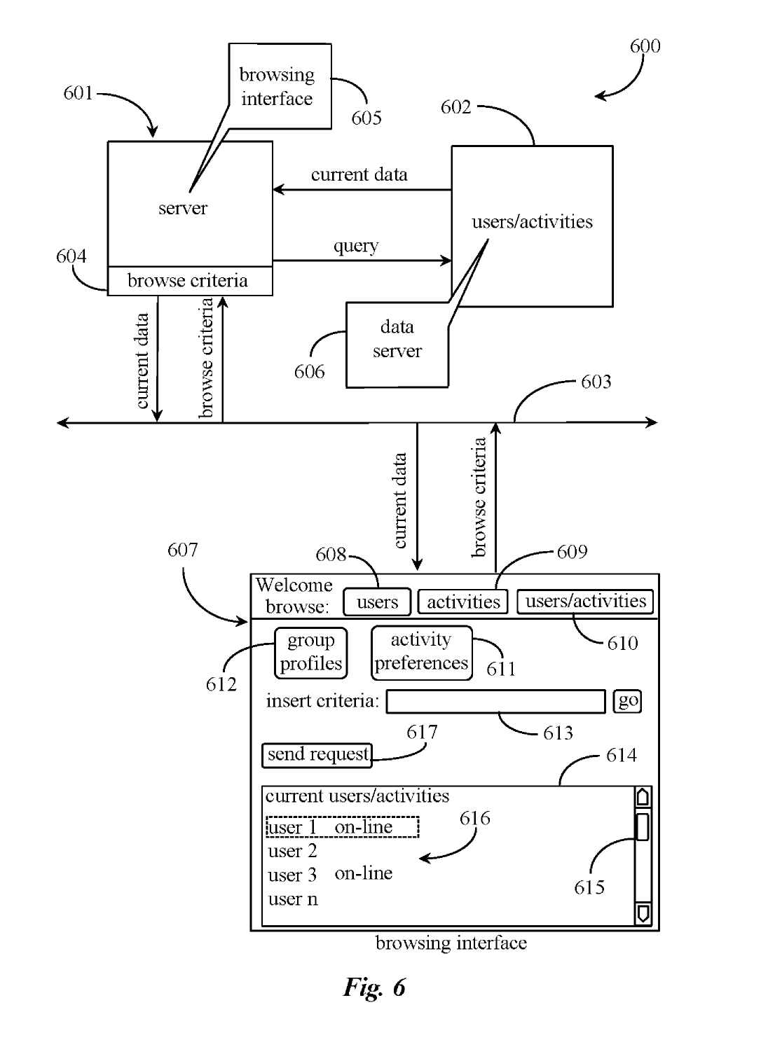

FIG. 6 is a block diagram 600 depicting a system for browsing users and activities. System 600 includes a server 601 analogous to server 107 of FIG. 1 connected to Internet 603. Server 601 hosts a browsing interface application 605. Browsing interface application 605 may be part of group curation application 105 described further above relative to FIG. 1. Browsing interface application 605 is adapted to serve a browsing interface 607 to an operating user upon request. Browsing interface 607 is depicted herein as displayed for an operating user connected to the service using a network-capable device or appliance.

An operating user working with browser interface 607 may opt to browse other network users by invoking an option 608 for browsing users. In one embodiment the operating user may select an option 609 for browsing group activities. In one embodiment the operating user may select an option 610 for browsing users and activities. An operating user may leverage a group profile for use as a browsing filter or constraint by selecting option 612. Likewise the operating user may leverage an activity preference profile for use as a browsing filter or constraint by selecting option 611.

By invoking option 612 the operating user may view and select from one or more group profiles the user has preconfigured for use. The group profile attributes in the profile selected will function as match points to screen which other network users may be visible to the operating user during browsing. Likewise invoking the option activity preferences 611 enables the operating user to view and select from one or more activity preference profiles or data sets preconfigured by the user. The descriptive terms in the activity preference profile will function as match points to screen which pending activities may be visible to the operating user during browsing.

Browsing interface 607 includes a data input field 613 and an associated submission button labeled “go” for accepting input from the operating user and submitting the input to use as browsing criteria in an effort to narrow the field of visible users and/or activities to those types of users and activities in which the operating user is most interested. Input field 613 is adapted by logic to accept multiple keywords and multiple words used in context as browsing criteria for users, activities, or a combination thereof. In one embodiment the operating user may browse users and activities with no constraints, matching, or filtering. An operating user may drag and drop a group profile into data input field 613 in order to submit the browsing criteria to the service for application. The operating user may drag and drop an activity preference data set or profile into input field 613 in order to submit the preference data set to the service for application.

Once an operating user has selected a browsing option and submitted input into field 613, the browsing criteria is uploaded to server 601 as browse criteria 604 for use in the browsing session. Server 601 has access to a data repository 602 adapted to contain all of the latest data about users registered with the service and pending activities scheduled for participation. A data server application 606 is provided and associated with data repository 602. Server 606 is adapted to accept queries from server 601 with or without constraints.

Browsing interface 607 includes a browsing window 614 that is scrollable using a scrollbar 615. Window 614 displays visible data 616 about current users and or activities the user is browsing. In this example data 616 is about users registered with the service of the invention. The user list is interactive and may include presence data indicating whether or not the browsed users are currently connected to the service or not. In one embodiment the operating user may select or highlight a listed user, like user 1, who is currently on-line, and then send that user a request by invoking option 617. The request may be a friend request, a message, or an invitation to a group activity. In the case that data 616 is about activities instead of users, the operating user may highlight or select an activity and then send a request relative to that activity. The request may be to join the activity or to express an interest in following the activity. In following users or activities the operating user may set conditions for being notified about the current state of the user or activity.

In one embodiment of the present invention, the browsing interface may be made available in limited function to users who are not yet registered with the service of the invention. For example, to promote recruitment of users to the service of the invention, the interface may be distributed to users that are registered with social networking sites. These users may be allowed to browse registered users and pending activities and may see the current states of these without the ability to set conditions or filters or to send requests relative to or to otherwise interact with identified users and or group activities. If an unregistered user desires he or she may select a link that may redirect to the registration process available to all potential users. In one embodiment presence information included with browsed data may include current geolocation of users.

### Scoring Users Targeted in a Search Operation

In one embodiment, when a search operation is conducted for the purpose of aggregating individuals as potential candidates for participation in a group activity, the matching individuals may be automatically scored or ranked against a preset value to further isolate users who may be better suited for interaction with the search initiating user.

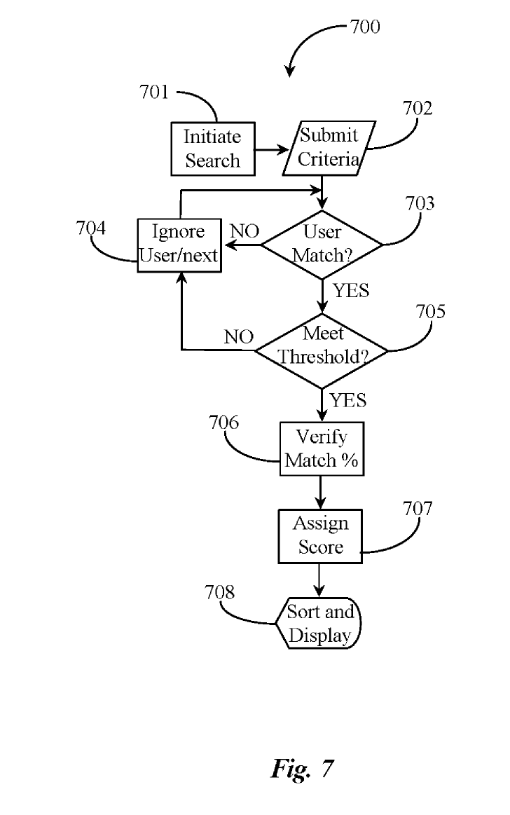

FIG. 7 is a process flow chart 700 depicting steps for deriving a score for users matching a group profile during a search operation. In step 701 an operating user initiates a search operation in order to identify other network users that may be good candidates for joining a group activity that the user has joined or that the user has created. In searching for other users to invite to an activity the operating user may use a group profile as search criteria, whereby attributes contained within the group profile are matched one per one to attributes contained in the personal profiles of the searched users. The search might be conducted relative to an activity the operating user has created or wishes to join, and may help fill vacancies by inviting some or all of users that match certain criteria.

The operating user may insert a group profile as search criteria in step 702. In other embodiments, an operating user may also type in attributes and set certain conditions for qualifying or excluding users from the list of potential candidates. During the active search operation the system determines for each user whether that user matches to some degree the search criteria used such as group profile attributes, for example. If the user does not match user-submitted criteria, the process moves to step 704 and the user that did not match is ignored and the next user is evaluated. It is noted herein that the process may run in parallel for many users that may be subjects or targets of the search operation. The process continually loops back to step 703 determine match state for each of the individuals targeted.

If the system determines that a user matches search criteria at step 703, the process moves forward to step 705 and the system makes a determination if the match state of the user meets or exceeds a preset threshold value set by the operating user or by the system. In one embodiment the threshold value is a percentage of match to the multiple attributes contained in the search profile. For example, if the threshold value calls for attributes in the user's personal profile to match one half or better of the attributes used as search criteria, then the threshold value is 50 percent match. The user must meet or exceed this 50% match threshold to be included in the search results.

If a user's match percentage does not meet or exceed the threshold value in step 705, then the process resolves back to step 704 and the user is ignored. It is important to note herein that in one embodiment steps 703 and 705 may occur together in one evaluation operation performed by the search engine. If the user's match value meets or exceeds the threshold value at step 705 the system may then verify the exact percentage value of the match. In one embodiment this may be any percentage match at or above the preset threshold value. For users whose percentages are validated the system may score those users at step 707 by leveraging one or more than one algorithm to assign a score based at least in part of the percentage of match to search criteria.

In one embodiment there might be additional factors that are considered in score assignment. For example, if a user is matched at the threshold value but not above the threshold value and the user is already a friend of the operating user, that fact may be considered a weighting factor resulting in a higher score than otherwise might be the case. Many different weighting factors may be applied to scoring. Some factors may bump up the score while others may lower the score to the point where the user is then excluded from the search results even though they met the threshold value. Therefore, one user having a lower initial overall score may bump a user having a higher initial score once weighting factors and constraints are considered.

In one embodiment, a score may be weighted or averaged with other scores attributed to the users. Such scores might be based on levels of activity participation in the past or on level of activity creation and or promotion. In step 708 the system may rank and sort the user data according to score and then may present the results in ascending or descending order for display on the operating user's connected device or appliance. The operating user may select individuals from the results for invitation to one or more group activities. In another embodiment the qualifying users may automatically be invited by the system to participate in a group activity based on the number required or desired to participate in the group activity for which the search was conducted. The system or user may continue to invite more users on the results list depending on the responses or lack thereof from the first group of users that were invited. In one embodiment an invitation algorithm may be provided that may predict the overall rate of invitation rejection, and may therefore invite more users based on that ratio with the expectation of filling the activity with a first round of invitation.

### Determining Strength Value Between Network Users

In one embodiment of the present invention a network user looking for individuals to participate in an activity can initiate an operation to determine amongst a pool of other network users, those users with whom the user may be more compatible based on a variety of criteria and in a manner that is not dependant on search criteria or group profile attribute matching described further above.

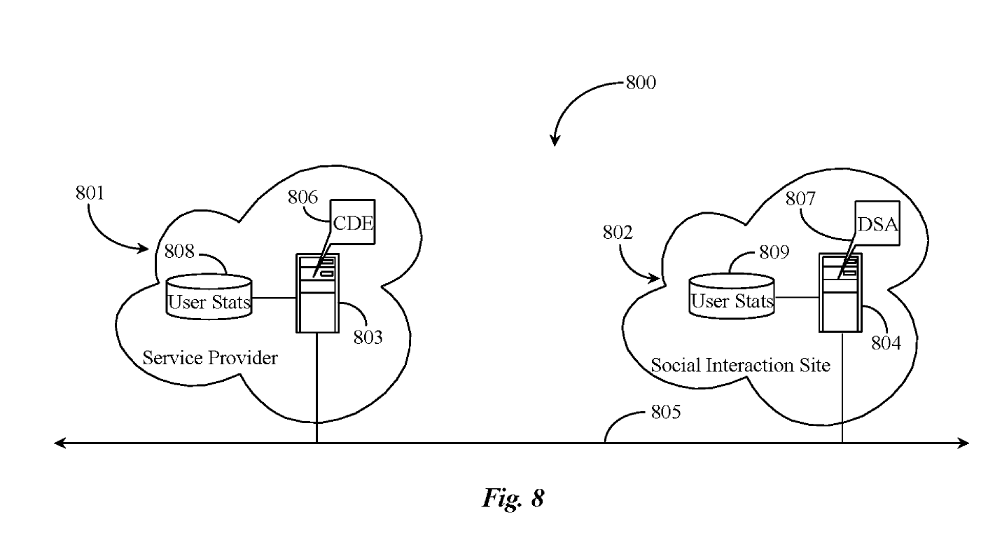

FIG. 8 is an architectural overview of a data network 805 supporting determination of relationship strength between users on the network. Data network 805 may be the Internet network in this example and may be referred to as Internet 805 in this specification. Internet 805 is analogous in description with Internet 101 of FIG. 1. A service provider 801 is depicted in this embodiment and is analogous to provider 102 also of FIG. 1. Service provider 801 includes a data server 803 analogous to server 107 of FIG. 1 and a data repository 808 connected thereto that is analogous to repository 108 of FIG. 1.

In this embodiment, server 803 hosts a compatibility determination engine (CDE) 806. CDE 806 may be part of group curation application 109 described further above with reference to FIG. 1. CDE 806 is adapted to make a determination of and to quantify or assign value to compatibility strength between two or more network users that might be considered candidates for participation in a group activity. There may be many different levels or veins of compatibility between network users that might be exploited to determine users who might be most compatible to a specific user planning an activity. In one embodiment the system might initiate an operation on behalf of a network user in order to promote a group activity to the user or to encourage the user to create a group activity.

Internet 805 supports a social interaction site 802. Social interaction site or domain 802 includes a social interaction server 804 and a connected data repository 809. Social interaction server 804 is analogous to server 115 of FIG. 1. Social interaction server 804 hosts a data service application (DSA) 807. DSA 807 is adapted to work with CDE application 806 to provide server access to certain user information based on permission from social interaction users whom are also registered with the service of the present invention. In some embodiments of the invention social graph information about other network users, as it relates to a specific user, may be collected from any network source or repository and may be analyzed to help determine compatibility strength between those users and a specific network user. DSA 807 may be part of GC AAP 109 distributed over the network to one or more than one social interaction platform as a client of the group curation platform.

Any particular user who is registered with the service of the invention may have one or more than one social interaction account. These accounts may include such services as Facebook™, Myspace™ and others. Likewise, registered users may have other accounts that enable social networking between users, like music download communities such as iMesh™, iTunes™ and others. Social graph information about these users may be leveraged with their permission to use to ascertain compatibility strength of those users to any other user selected. Connected users are not depicted in this example but may be assumed present.

In one embodiment the system of the invention may select a user that might be interested in participating in a certain type of activity. The selected user may have a personal profile registered with the service. The selected user may have an activity preference profile indicating which type or types of group activities in which the user wants to participate. The selected user may also have one or more than one social interaction account of the types discussed above. The relationship between the selected user and the service might be such that the user has stated interest in participating in one or more types of group activities, but has not initiated or created any activities or joined any activities for a period of time. Therefore the service model may call for encouraging that user to create an activity, for example, and to then fill the activity with candidate users that the system has determined are the most compatible users considering a variety of criteria.

In another embodiment a network user registered with the service may leverage a variety of criteria in order to discover other users with which they wish to interact during a group activity previously created by that user. Information that might be used to ascertain compatibility may include social graph information. This information may include indication of any other network users that happen to be social interaction “friends” of a target user who has created a group activity or is being incentivized to create a group activity by the system. The information might include indication of other network users who are not friends with the target user, but who share mutual friends with the target user.

Other associative relationships between the target user and other network users may also be leveraged, like group membership information, information about the user following other users, or other users following the target user, or the target user and other users sharing a commonality of following other specific users. In one aspect offline associative characteristics might also be considered if known or discernable to the system by discovery of the information posted or otherwise published. For example, if two service-registered users are neighbors and friends offline but otherwise do not interact over the network, they might be considered compatible to participate in a same group activity at least to a certain degree, even if there is no information suggesting that they may share an interest in certain group activity types.

In one embodiment a connected user may simply wish to discover other network users with whom they might be compatible in some particular way for the purpose of simply becoming friends with those users, or requesting to follow those users, but not necessarily inviting them to participate in group activities. Friend and follow relationships may exist between the target or operating user and other users in one or more than one service account. The method for determining compatibility strength between two users may utilize a wide variety of information including profile attribute match data. A model for compatibility based on multiple information sources may be generated by the system based on a specific user, or it may be generated by the user through data submission, including a list of attributes and or conditions and states that may be important to the user and that the user desires that the other network users share.

It is noted herein that the method for determining a compatibility strength value between two network users may be leveraged in searching for users to invite to a group activity or in browsing users to follow or befriend, or in forming virtual user groups for correspondence, or for future reference for other purposes.

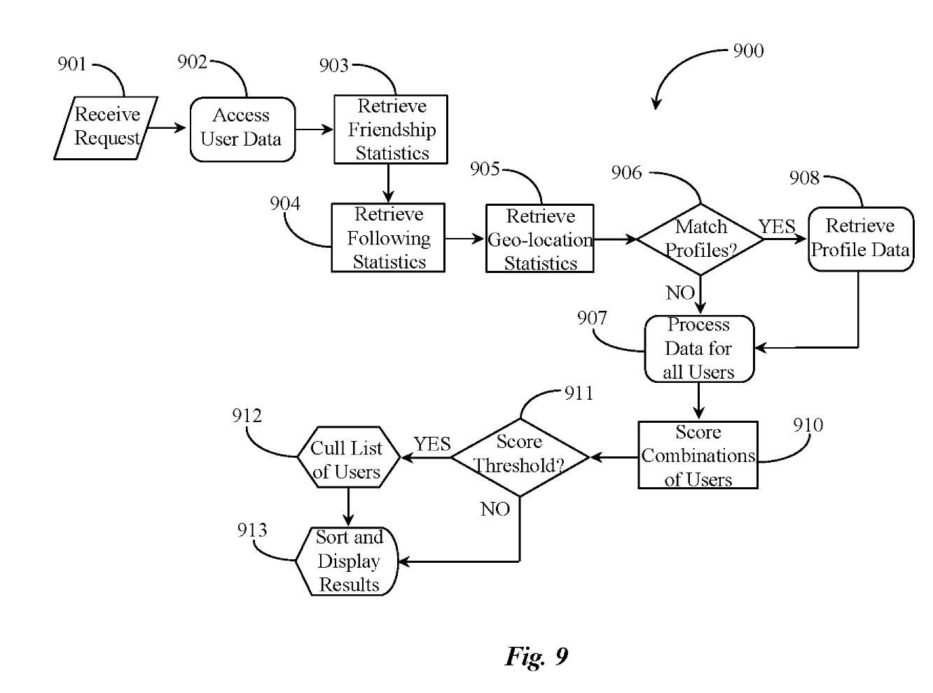

FIG. 9 is a process flow chart 900 depicting steps for determining a compatibility strength value between at least two network users. At step 901 the system, more particularly a server aided by the group curation application, receives a request to determine compatibility strength between a user and one or more other users registered with the service of the invention. Such a request may be initiated by a user or by the system on behalf of a user. In one embodiment a user may initiate the request on behalf of another user. The request may contain certain criteria including conditions and states other users may share with the user that is subject to the request.

At step 902 the system attempts to access user data based on the information or a compatibility model created by the system or by a user. It is important to note herein that searching for other users based on a compatibility model may be performed using no user profile criteria or activity preference criteria. In one embodiment the characteristics in a compatibility model are arbitrary and may not match the preferences of profile information about the target user for which the search or browsing operation is performed. In one embodiment a search engine is used to access the data based on criteria. In another embodiment a browsing interface is used to access or “view” data about other users.

In this example several criteria are observed as part of a compatibility specification or model. For example in step 903 the system might access other users' data focusing on social graph information such as friendship status. In this step other users who are already friends with the target user are identified. In one embodiment users who are not friends with the user but have one or more mutual friends with the user are also identified. The social graph information about the other users might be accessed from multiple locations, for example from Facebook™ and other accounts that the target user shares with the users whose data is accessed.

At step 904 the system might access following statistics. Again, this data might be sourced in multiple locations on the Internet, for example the target user may be following the network activities of another user at one or another common service account and at the service of the present invention. For example a compatibility model may specify that the system identify friends of the target user; users who are following the target user; users that the targeted user is currently following; users who are following the same other users that the target user is following; and/or users who are being followed by one or more of the same users that are following the target user. In one embodiment following statistics have been previously aggregated for the target user relative to all other registered users known to the system. In this case they may be accessed locally without communication with any third party services.

At step 905 the system might access geolocation statistics of other users relative to the geolocation of the targeted user. For example a compatibility model may include a geolocation constraint such as users who reside within a specified radius of the target user. For example the target user may desire to physically meet all or some users who are compatible according to other aspects of a compatibility model. It is noted herein that a compatibility model may be unique to one user. In one embodiment a compatibility model may be generated for a virtual user by the system in order to aggregate a group of users who may then be considered compatible to one another. In this way the system may create virtual grouping of users for future reference.

At step 906 the system might determine whether it is required to perform profile attribute matching to qualify individuals for inclusion into the aggregated group of users. It is important to note herein that a compatibility model may or may not include a profile attribute matching condition. Moreover, a compatibility model may include fewer or more requirements for searching data for particular characteristics like following or friendship relationships. At step 906, if the system determines that no profile attribute matching is called for, then the process moves to step 907 where the data retrieved is processed for all of the identified users. If at step 906 the system determines that profile matching is called for, then the process moves to step 908 and the system accesses the profile data about the users for use in matching attributes to attributes of the activity profile preference profile or personal profile of the target user.

It is noted herein that the notion of compatibility between users may vary greatly according to why users are virtually grouped. In some cases it may be desired to group users who have characteristics that differ from characteristics of a target user. For example if the target user is planning a political debate contest as a group activity, then the user may wish to aggregate users who have opposing characteristics, such as political beliefs so that the debate will be lively. Such polar differences in characteristics can be specified in a compatibility model that is tailored for a specific event.

At step 910 the system may score all of the different user combinations. For example, if 50 users are discovered, then there may be 50 “scores”, one for each combination of the target user with one of the 50 candidate users. There may be users who tie with respect to having a same score relative to being compatible to the target user or the compatibility model specified for the search. A scoring algorithm may be leveraged to assign a numerical value to a combination based on alignment of the various characteristics, attributes, states, and conditions set before the search.

At step 911 the system may determine if there is a score threshold value that is preset and functions as a constraint for inclusion into a virtual group of users. If at step 911 the system determines that there is no score threshold value, then the process may move to step 913 where the system sorts and displays the results for the target user or system on behalf of a targeted user. If at step 911 there is a threshold that must be met or exceeded, then the process moves to step 912 where the system culls the results of users who failed to meet or exceed the threshold value. The process then moves to step 913 where the system sorts and displays the results.

### Generating and Managing Group Profiles

In one embodiment of the present invention a user connected to the service of the invention may create a group profile for characterizing the types and mix of individuals with which the user would desire to interact during a group activity.

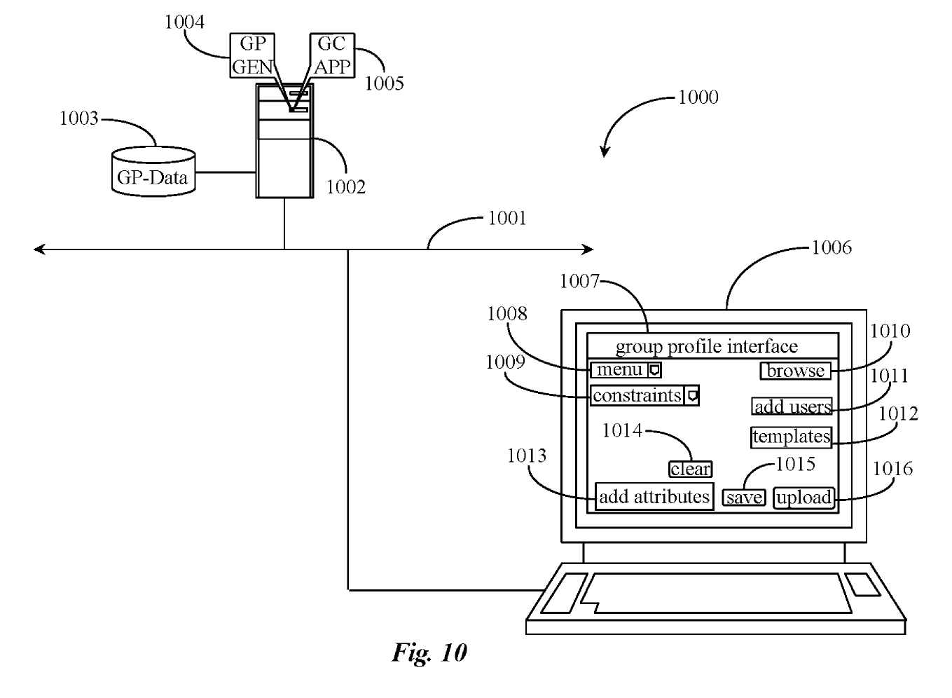

FIG. 10 is a block diagram of a network 1000 supporting distribution of an interface for configuring and managing group profiles. Network 1000 is characterized in this example by a network backbone 1001 analogous to backbone 101 of FIG. 1. Network backbone 1001 represents the Internet network in this embodiment and may be referred to herein as Internet 1001. Internet 1001 supports a server 1002 analogous to server 107 of FIG. 1. Server 1002 hosts a group curation platform 1005 and a group profile generator 1004. Group profile generator 1004 may be part of the GC application 109 described with reference to FIG. 1. Group profile generator 1004 is adapted in one embodiment to facilitate users in their efforts to create group profiles for use in aggregating candidate individuals for participating in group activities.

A group profile is an aggregation of attributes that may match characteristics of certain other network users who may be matched to a specific activity by virtue having at least personal profile characteristics that match up with those characteristics expressed in a group profile. Users may have one or more than one group profile associated with their accounts. Each profile may be tied to one or more activities that the generating user wishes to fill relative to vacancies or to participate in with other users.

In this example GP generator 1004 is a parent application to a client group profile configuration interface 1007 distributed to or accessed by a client appliance 1006 and open in display on the appliance. In one embodiment, interface 1007 is downloaded to appliance 1006 and displayed on the appliance when executed. In this embodiment data displayed in the interface is served by server 1002. In another embodiment interface 1007 is hosted at server 1002 and client appliance 1006 may access it by connecting to server 1002 and remotely executing an instance of the interface. Interface 1007 is adapted to accept user input in the form of at least group profile attributes submitted by the user to the service for the purpose of creating a group profile to be associated with one or more group activities.

In one embodiment, interface 1007 may include a menu 1008. In this case, the menu may be a drop down menu that may contain generic group profile attribute categories and examples of common attributes that may be selected or deselected relative to inclusion in a new or custom group profile being created by a user operating from appliance 1006. Example categories might include ‘gender”, “political leaning”, “relationship status”, “education”, “income level”, “skill level” (relative to activity description) and the like. Selectable attributes may be listed beneath each included category. In one embodiment a user may, through menu 1008, select pertinent categories and attributes that may be activated or selected to be included in the group profile.

In one embodiment interface 1007 includes a constraint menu 1009. Constraint menu 1009 may be utilized with menu 1008 to include one or more constraints or rules to apply to one or more categories and or attributes selected under those categories. A constraint might be a mathematical constraint or condition that the user desires to affect an attribute section. For example, a user might select both female and male attributes under the category gender and then apply a mathematical constraint such as 60% female and 40% male for the desired gender mix for participating in the activity or activities. Another example of a constraint might be specifying an income level for participants, like an annual income “above $30,000 but below $80,000. In one embodiment a constraint may be a geographical constraint specifying a geolocation threshold for participation in a specific activity or activities. For example a constraint might be potential participants must reside within 10 miles of the activity.

In one embodiment interface 1007 includes one or more text input fields or links to such fields for the user to type in additional attributes that may not be included in menu 1008. One such facility may be a text input field 1013 for adding additional attributes. Element 1013 may be a link to a text input field or form rather than an input field already displayed in interface 1007. In this case, invocation of link 1013 may cause display of an interactive text interface for typing in such attributes. In one embodiment, additional input text fields or interfaces may be provided in conjunction with menu options available through invoking menu 1009.

In one embodiment one or more group profile templates are provided for creating custom group profiles from those generic templates. In this embodiment a user may obtain a current group profile template by invoking a link 1012 to access a template list or grouping of templates that exist in the system relative to an activity or activities. The user may then build a custom group profile from that template by supplementing the template data with user-submitted data, and then saving the template as a new group profile created by the user. In one embodiment a user operating appliance 1006 may browse existing group profiles by invoking a browse option 1010. The user may elect to adopt one or more existing group profiles for use in aggregating potential participants for one or more activities.

It is noted herein that the existing group profiles might also be modified relative to attributes, activation or deactivation of categories, and application or non application of constraints. It is also noted herein that group profiles may be attributed to specific activities and different activities created by a user may rely upon very different group profiles for aggregating potential participants for those activities. Likewise, two differing group profiles may be created for a single activity without departing from the spirit and scope of the present invention.

In the process of adding attributes to a group profile data set, the user may simply type the attributes into a text interface under a category using commas, semicolons, or other punctuation to separate the attributes in the list. The added attributes may be associated with or added relative to categories to which those attributes apply. For example, an attribute for a female who is single may be “mother”, implying that among single female candidates for participation in an activity; they should be mothers or single moms.

In one embodiment a user operating appliance 1006 through interface 1007 may add one or more user identifiers by selecting an option 1011 “add users” to the group profile for the purpose of automatically inviting those users to participate in an activity, regardless of whether they significantly fit the attribute signature or not. In this embodiment the users added may be existing friends of the user creating the profile. The added users may be users that the operating user is following and with which the user wishes to interact. The added users may also be users that the operating user just would like to meet during activity participation.

In one embodiment invoking add users option 1011 results in a display of existing users that are friends or are in some sort of following relationship with the profile-generating user. In one embodiment invoking add users option 1011 results in display of a menu, text field, or other facility adapted to enable the user to add users who are currently not listed as users that have relationship or history with the operating user. The system may, upon invocation of option 1011, aggregate a list of users for the operating user so that the operating user might scroll the list and select users to add to the generated profile. In one embodiment, browse option 1010 may also be adapted to enable the operating user to browse users, templates, group profiles, and activities.

After entering information for creating a group profile the operating user might clear the list by invoking clear option 1014. The user may save the profile data for upload by invoking save option 1015. The user may then submit or upload the data to the service as a new group profile through invocation of upload option 1016. Finished group profiles may be stored on behalf of the user associated to one or more activities in a data repository 1003. It is noted herein that group profiles may be generated and associated to a user's account that are not associated with any particular activities. It is also noted herein that a group profile may be generated and associated with one or more activities but that are not specifically associated with any particular user. This means that the system may generate group profiles for its own purposes, for example to aggregate potential candidates for participation in a group activity that is not yet created or scheduled in the system by one or more users.

Application 1004 is adapted to receive information from the operating user and to generate a machine-readable version of the group profile and to save that profile in repository 1003 on behalf of the generating user. It is noted herein that such machine-readable versions of group profiles may be generated using code, markup language, or any other machine-readable media that the system might use to execute the profile when searching for individuals that might fit the profile in a significant way, satisfying a preponderance of the attributes and meeting constraints applied to categories and attributes.

It is also noted herein that the system may maintain a help interface or may provide help suggestions in real time to operating users that are in the process of creating a group profile. Such system aid may also include a prediction or a preview of the chances that an activity might be filled relative to vacancies by other network users in light of a particular group profile. For example, if a group profile is highly narrow and constrictive as defined by numerous attributes and constraints, it may be difficult to meet the requirements in time to fill the vacancies for a scheduled activity. Therefore the system may make suggestions throughout the process to help guide the operating user to create a useful profile that is likely to be successful in terms of matching users to the attributes contained within the profile in time to fulfill the activity. However, in one embodiment, a constraint may be not to schedule an activity until participants matching the group profile criteria are found, and once the individuals have been invited and have accepted those invitations the activity could then be scheduled to take place.

In an embodiment where templates may be used to create new group profiles, such templates may be automatically updated or may “self update” if conditions warrant it. One example might be if many users have used a particular template and have added one or more common attributes not previously included on the generic versions of the template. In this case a threshold might be established where a certain number of instances of users adding a particular attribute to a template may result in that attribute being automatically included as a selectable option in future versions of the template.

In one embodiment an operating user may execute a generated group profile as a test to determine if an adequate number of qualified participation candidates might be found in a timely manner to schedule an activity. In this case the candidates may not be invited but only identified and displayed to the operating user that is contemplating scheduling a group activity with the service in order to demonstrate to the user that there are sufficient other users known to the system that might participate in the activity according to the profile information.

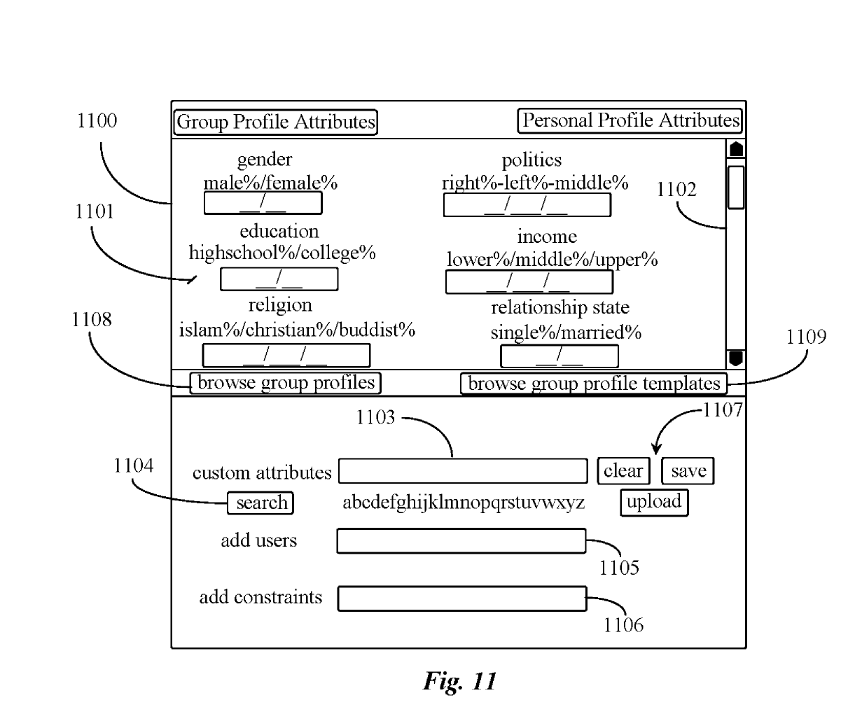

FIG. 11 is a display view of an interactive group profile template 1100 for building a custom group profile. Template 1100 may be served to an operating user through an electronic interface such as interface 1007 displayed on the user's appliance while connected to a server such as server 1002 described above. Group profile template 1100 may include a workspace 1101 for setting mathematical constraints associated with specific attributes and broader demographic and other attribute categories. For example, under the category gender a user might input a percentage of both male and female participants as a desired mix of gender for potential group activity participants. Under a broad category politics the options may include right, left, and middle along with input fields for applying a percentage. A user may require that 50% of the potential candidates lean to the right relative to politics, 25% leaning to the left, and 25% grounded in the middle or moderate relative to politics in general. Workspace 1101 may include a scroll bar 1102 for scrolling down through listed attribute options.

Percentages or ratios may be applied to the total aggregation of potential participants for many different attributes. In one embodiment constraints may include specific thresholds, such as income thresholds, relative to the broader category income level. Percentages or ratios of the total number of aggregates might also be applied to religious orientation and relationship states. There are many different possibilities.

Template 1100 may include a text input field 1103 for the user to type in additional custom attributes that may not be included in the generic version of the template. In one embodiment a user may use a search option 1104 to search for specific attributes by keyword or phrase. In one embodiment, existing attributes that may be known to the system but not already on the template might be discoverable by browsing them by alphabetical order. For example selecting (a) may result in display of a list of attributes starting with the letter “a”. Options 1107 include a clear button, a save button and an upload button as described further above relative to interface 1007 of FIG. 10.

Template 1100 includes a text input field 1105 for adding specific users to a group profile and a text input field 1106 for adding additional constraints to a group profile. In one embodiment specific users might be added by typing into text input field 1105 an identification of one or more users to add. In one embodiment a list of users may be dragged and dropped into text interface 1105. An option 1108 is provided for browsing existing group profiles, and an option 1109 for browsing existing group profile templates. In one embodiment, as a user works on a template and adds attributes and constraints, the system may search in the background for existing group profiles that currently are the best match to the group profile in progress given the current information provided. In this way a user may opt to select a finished profile and adopt a profile created by another user and associate the pre-existing profile to his or her account. In one embodiment template 1100 includes a “test” option for enabling a user to initiate a test case where the system may perform a search to see if there are enough users in the system to satisfy the conditions in the profile before the operator makes a decision to upload the profile or to promote or schedule an activity.

In one embodiment of the invention previous user groups that have already been discovered using attribute matching might be made available to users who are contemplating scheduling an activity and generating a profile for that activity. For example just identifying the activity may be sufficient information for the system to display one or more previously aggregated virtual groups that have been discovered for the same type or very similar type of activity. The user may then have an option of selecting a pre-aggregated group of individuals to invite to the activity instead of using a group profile as input for aggregating a fresh list of users.

In one embodiment of the invention a template may be updated if statistics show that one or more attributes not currently part of the template is added to a version of the template by multiple users, perhaps meeting or exceeding a preset threshold value governing the updating process. Once this threshold value is reached or exceeded the attribute or attributes may be offered in a new or latest version of the template as default attributes. It is also noted herein that certain attribute categories and attributes under those categories might be skipped by an operating user who does not see a requirement for specifying them for a specific activity. These categories and options may remain unchecked in the interface or template so the system may ignore them. In one embodiment an operating user may type in attributes or drag and drop an attribute set into a search field associated with search option 1104 or with the browse templates option 1109 in order to call up a list of the most closely matching templates known to the system.

### Comparing Group Profiles

In one embodiment of the invention group profiles generated by individuals or by the system may be correlated in order to determine, at a strength level, how close virtual groups of network users might be in terms of common characteristics. Group profiles may be associated to user accounts and may be relative to one or more types of group activities a user has in the system or in which the user desires to participate. A group profile communicates to the system which sets of characteristics of other users are desired most or more to be predominant among the group and or mixed among the group to a pre-specified ratio.

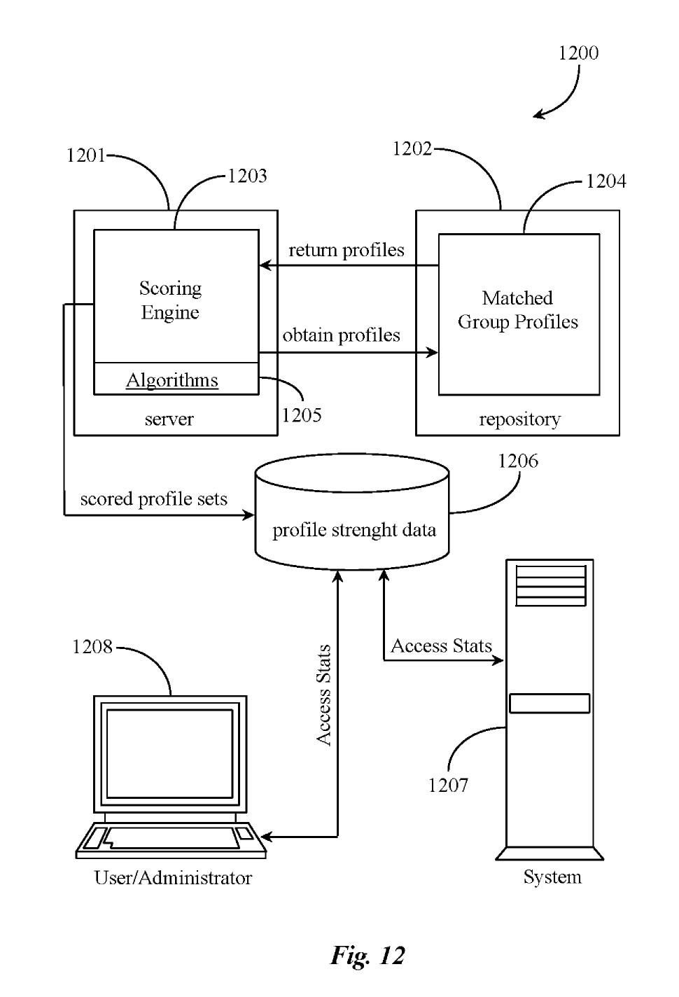

FIG. 12 is a block diagram 1200 depicting basic components and architecture supporting group profile matching and assessment of strength level of match. Diagram 1200 depicts a network server 1201, which may be analogous to server 107 of FIG. 1. Server 1201 supports a scoring engine 1203 for quantifying match strength level between two or more group profiles. Scoring engine 1203 may be a part of or integrated with GC APP 109 of FIG. 1.

This embodiment assumes that two or more group profiles generated by individuals or by the system have been matched to one another at least by virtue of sharing to common attributes. Diagram 1200 depicts a data repository 1202. Data repository 1202 may be analogous to data repository 108 of FIG. 1. Data repository 1202 may be directly accessible from server 1201 or it may be directly accessible to another server in communication with server 1201 without departing from the spirit and scope of the invention. Data repository 1202 contains a record of group profiles that have been previously matched together through at least sharing some common attributes. A set of matched group profiles might include just two group profiles that have been matched or more than two matching profiles. In the case of more than two matching profiles there may be more than one match value that quantifies a match. For example, profiles A, B, and C may be included in a matched set of profiles. Profile A will match to profile B at one level and to profile C at another level. Likewise profile B will match to profile A at one level and to profile C at another level and so on.

Matched profiles 1204 may include summary and or detailed information describing match percentage or scores and indications of match of singular attributes shared between the profiles. A match score might be a percentage value, a numerical value between 0 and some number, or it might be a number of icons like stars used in a star rating system. A single match score can, in one embodiment, be attributed to three or more group profiles to reflect the lowest matching score between two of the profiles in the matched set of profiles. For example a profile A may contain fifty attributes of 100 listed attributes that are determined to match another profile B, whereas the profile B may share sixty of 100 attributes that match to profile C. Therefore a singular match score of fifty % may be attributed to the whole set of matched profiles. The final score may also be an average of all the scores derived.

Scoring engine 1203 is adapted to refine values relative to attribute matching by determining and quantifying certain overlap match conditions that may be discovered in matching attributes that are not a one hundred percent match. This may occur due to implicit or implied ranges that may be present in an attribute. For example if a group profile A includes a desired age level of potential female participants set at between 18 and 30, but group profile B includes a smaller range for that attribute between 20 and 28, the match is not 100 percent. Overlap condition defined as the area of complete match is only between 20 and 28. Therefore, a 60 percent match value might be inferred to the matching attributes between the profiles under the category female participants. This might be the case for all matching attributes that might be expressed as a range of integers such as age, income level, years of education or study, levels of skill, weight in units of measure, etc.

Scoring engine 1203 may leverage one or more than one algorithm 1205 in the process of refining match score of a profile match to determine the actual strength of the match between profiles in a very granular way. For two compared profiles a large percentage of matching attributes may be only partial matches where the overlap defines the extent of the match between the attributes compared. In one embodiment the system may use group profile sets in a search to aggregate potential users that might be likely to participate in a specific activity type. One benefit of this practice is that the system may show availability of users in the system that may be considered more likely to accept invitations to a particular group activity that other users or the system might be interested in promoting over the network. In one embodiment, the practice is undertaken to show potential third-party activity vendors that their activities could be filled with users that, from a marketing perspective, are more likely to join the activity and certain other activities in the future.

In general practice server 1201 aided by scoring engine 1203 may request and obtain sets of matched group profiles 1204 from repository 1202. The group profiles aggregated into sets have previously been found to match one another at least to a certain degree according to the existence of common attributes shared between them. In one embodiment group profiles matched to one another must match beyond a minimum match percentage threshold to be considered viable matches. In one embodiment group profiles that have been matched together have also been leveraged previously in at least one search for network users whose personal profile attributes match those specified in the group profile. Data about the numbers of matching users in previous searches against personal profiles of users might be included in the group profile data or metadata. In one embodiment this data may be key in selecting a specific group profile to use as a base profile to match to other profiles to derive a set of matching profiles.

Group profiles requested as part of a matching set are returned to server 1201 for further analysis. The scoring engine may determine for each matching profile which matched attributes are expressed using a range of units and of those which are overlapping relative to the total number units of range in each profile relative to that common attribute. Scoring engine 1203 may leverage one or more algorithms 1205 to specifically calculate an overlap value for each common attribute expressed using a range of units. Once the individual range expressing attributes are processed for a set of profiles, the scoring engine may aggregate or sum the scores and then average them for the number of attributes to derive a single score that reflects the profile match strength between profiles in the profile set.

In one embodiment, the final match strength assessment is a score applied using some numerical scoring system or some other way to express values. The scored profile data or sets information may be stored for later reference in a data repository 1206 labeled profile strength data. This data may be considered statistical data in one embodiment. The system, represented herein by a server 1207, might at any point access statistics relative to match strength between the profiles in general. In one embodiment a user or network administrator may access profile strength data from repository 1206. Reasons for accessing the data may vary between users and between activity vendors.

In one embodiment a user may generate a group profile to invite potential participants to fill an activity that is being promoted over the network. In case the group profile did not generate enough potential users during a search to satisfactorily fill the activity, the group profile may be compared by itself to group profile sets that have already been matched together for the same type of activity and scored according to match strength. In this way the user might discover many more potential users that might be invited to participate in the activity. The matched profiles might include attributes not specified in the original group profile provided by the user. The matched profiles may also include fewer attributes than are specified in the generated profile.

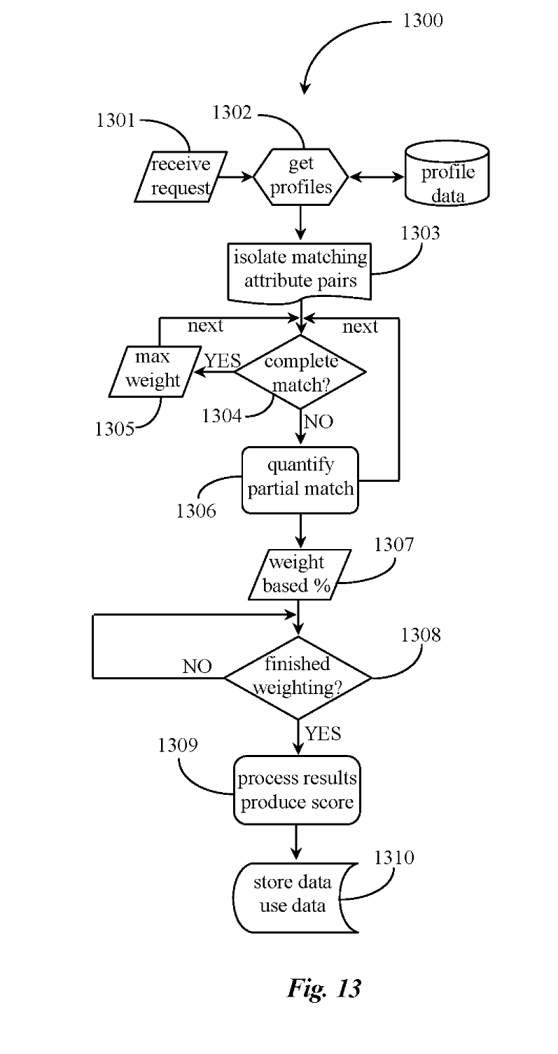

FIG. 13 is a process flow chart 1300 depicting steps for assigning a strength measurement or value to a set of matching group profiles. In step 1301 the system may receive a request from a user or a component of the system to ascertain the match strength of a set of matching group profiles. The user may be an individual registered to use the system or an activity vendor registered to use the system. At step 1302 the system may retrieve a set of matching group profiles for analysis from a repository containing the profile information.

In step 1303 the system aided by the scoring engine described further above may isolate the matching attribute pairs relative to the matching profiles. In one embodiment the attribute list is cleansed after initial matching to only reveal the attributes that matched or were common to each group profile in the group profile set retrieved. In one embodiment the group profile of a network user is compared to a group profile from another network user, the profiles specific to one group activity type. If it is found that the two profiles have a significant match beyond a preset threshold they may be included in the system as a set of matching group profiles. The process of steps 1303 through 1308 may result in an overall score that disqualifies the set for further consideration by virtue of the fact that after refinement, the strength value of the match may be lower than the original match estimate.

For each attribute the system might determine if the match is complete in step 1304. If the system determines a complete match (100%) for an attribute in step 1304, a maximum weight may be attributed to that attribute in step 1305. The process may then loop back and perform the same determination for the next attribute in the list of matching attributes.

If the system determines at step 1304 that the match is not 100% or a complete match, the process moves to step 1306 where the system quantifies the partial match. The system aided by the scoring engine accomplishes this by using one or more algorithms to determine the area of match overlap between the attributes. In this case the attributes are associated with a range of units specifying a condition or constraint to that attribute. The ranges may be different between the group profiles in the matched set revealing an area of 100% match and an area of 100% mismatch. The condition is validated and quantified in this step. It is possible that a matching attribute has identical ranges of units associated with it in each group profile containing the attribute in which case it is determined to be a 100% match. It may be the case where a matching attribute is associated with a range of units in one group profile and an absolute value in another group profile.

In step 1307 the system may determine a weighting factor for the matching attribute that expresses the overall percentage of match between different ranges of units tied to that attribute in each group profile. If there is more mismatch the weighting factor will be more negative for that attribute. If the mismatch is less evident a more positive weight may be applied to that particular attribute up to one hundred percent matching attribute (maximum weighting). For the attribute age 18-30 and 17-30 are a very close match but not 100%. For the same attribute, 18-30 and 15-20 is more of a remote match. Steps 1304 through 1307 are performed for each isolated attribute shared in common among the group profiles in the retrieved set.

At step 1308 the system determines whether it is finished weighting all of the isolated attributes shared in common among the group profiles. If the system determines at step 1308 that it is not finished weighting attributes, the process loops back to step 1308 until the system is finished weighting all of the attribute matches. Once the system determines the weighting process is completed for all of the matching attributes at step 1308, the scoring engine processes the results at step 1309 to produce a score equated to an overall match strength between the group profiles in the set. This process may involve one or more algorithms and may include summing, averaging, or other mathematical processes or calculations. The resulting data may be stored at step 1310 for future reference or it may be utilized at step 1310 in other system processes or operations. At step 1310 the system may alternatively use the data to promote further operations aimed at ultimately attracting individuals to participate in.

### Grouping Activity Participants During Activities

In one embodiment of the invention network users who have been aggregated into a group to participate in a group activity and who have committed to participate may be further paired or grouped into pairs or smaller subgroups during activity participation.

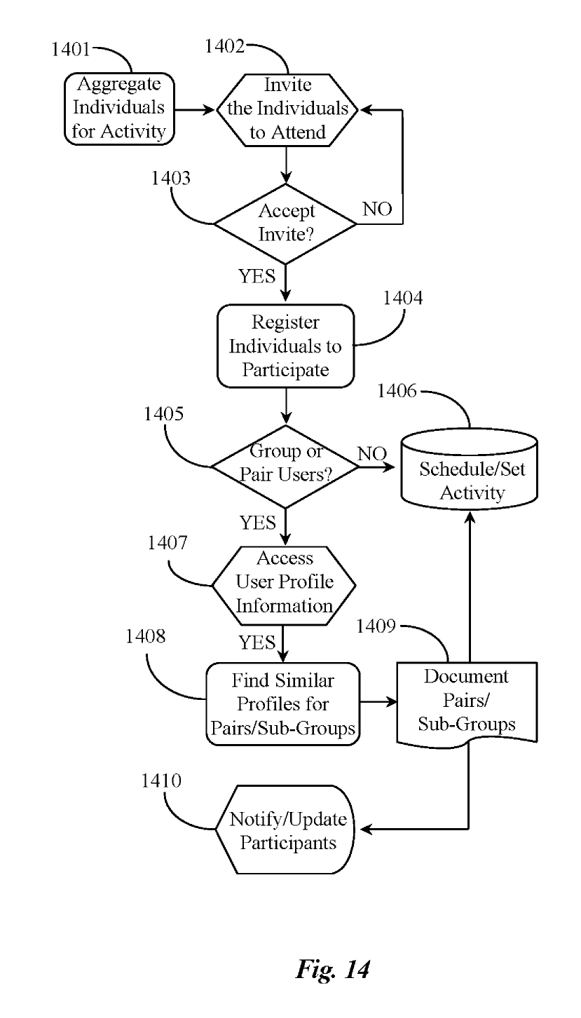

FIG. 14 is a process flow chart 1400 depicting steps for creating pairs or subgroups of user participating in a group activity. At step 1401 the system aggregates individuals for participation in a group activity. In this step the system aggregates the individuals based on matching attributes between the group profile attached to the activity and each of the individuals personal profiles attached to their accounts. After the individuals are included in a virtual grouping of individuals, those individuals are invited by the system to participate in the group activity for which they were aggregated.

Individuals may accept or decline invitations to participate in the group activity. At step 1403 for each individual the system determines whether the individual has accepted the invitation or not. If there are individuals that did not accept the invitation to participate, the process may resolve back to step 1402 where other individuals may be invited. The other individuals may be part of the pre-aggregated group or they may be new individuals discovered in a second attribute matching process. In one embodiment the individuals that do not accept the invitation are ignored for that activity and no other replacements are sought.

For individuals that accept the invitation to participate in the activity the system determines their acceptance at step 1403 and then registers those individuals to participate in the group activity at step 1404. Registration may include listing those individuals on a participant list or roster and perhaps confirming their commitments to participate in the group activity. Steps 1401 through 1404 have been described further above as one method for forming a virtual group that consists of individuals having the characteristics desired by a user for invitation to a particular activity for which the user has requested an aggregation of individuals.

In step 1405 the system determines whether or not the group activity is of a type that might require participants to pair up or group together in smaller subgroups during the participation in the activity. One example might be a dinner ride on a train where each available seat accepts three individuals. For each seat individuals may be assigned seating based on similarities between their personal profiles. In other words a seat of three individuals on the dinner train might be considered a subgroup of individuals. Another example might be a rope pull event where opposing teams must be determined. Yet another example might be a business plan workshop or class where individuals are grouped into subgroups where each subgroup collaborates to produce a business plan that is judged at the end of the event.

If the system determines that no subgrouping or individual pairing is required to fill the activity, then the process may move directly to step 1406 where the system may activate, schedule or otherwise set the activity to occur. In this case participants are not grouped into smaller subgroups or paired for seating or any other interactions. If the system makes a determination that the group activity requires or calls for pairing or grouping individuals further, then the process moves to step 1407 where the system accesses personal profile information attached to the accounts of those individuals. The user profile information comes from personal profile data and not group profile data that may also be attached to their accounts.

At step 1408 the system, aided by attribute matching software described further above, determines the number of individuals required in a subunit or group and attempts to divide the total number of individuals into such pairings or groups based on how similar the personal profiles of those users are to one another. In seating arrangements the number may be two, three, or more users such as seating at a table. For other requirements the numbers per subgroup might vary. It is highly activity dependent.

Attribute matching may be performed across all of the individuals to determine, for example, which users are most similar to one another and therefore more likely to interact successfully with one another in the seating or grouping arrangements. In one embodiment the process works to create subgroups or pairs of individuals whose profiles most strongly match each other. This should not be construed as limiting criteria. In another embodiment subgroups or pairs might be determined based on polar opposite attributes like male with female or young with old, or republican with democrat. In this use case it is desired that individuals be paired or grouped together with the assumption that matched individuals will more likely get along and interact more. Other criteria might seek to pair a group of individuals with the assumption that they will perform a task better.

Once the individual pairs or subgroups have been identified in step 1408 they are documented at step 1409. Documentation may include seating assignments consisting of seat location or number and identification of the individual. Table location and identification of users assigned to the table is another example of documentation. Once all of the participating individuals are paired or grouped, the system may notify and update participants with the information at step 1410. From step 1409 the process may also move back to step 1406 where the system schedules or otherwise sets or activates the activity to be pending in the system as an activity that will occur.

It is noted herein that the system may perform the steps 1407 through 1410 before or after scheduling the activity or activating the status of an activity. In one embodiment, the system may perform steps 1407 through 1410 while the participants are at a group activity but before the activity gets underway. In that scenario, the results, such as seating arrangements table seating, etc. might be published at the event on a network connected appliance and individuals might also receive text messages with the information that pertains to them.

### Promoting Group Activities Based on Behavioral Attributes

In one embodiment of the invention group activities are automatically promoted to users who have similar behavioral attributes relative to their histories of group activity participation.

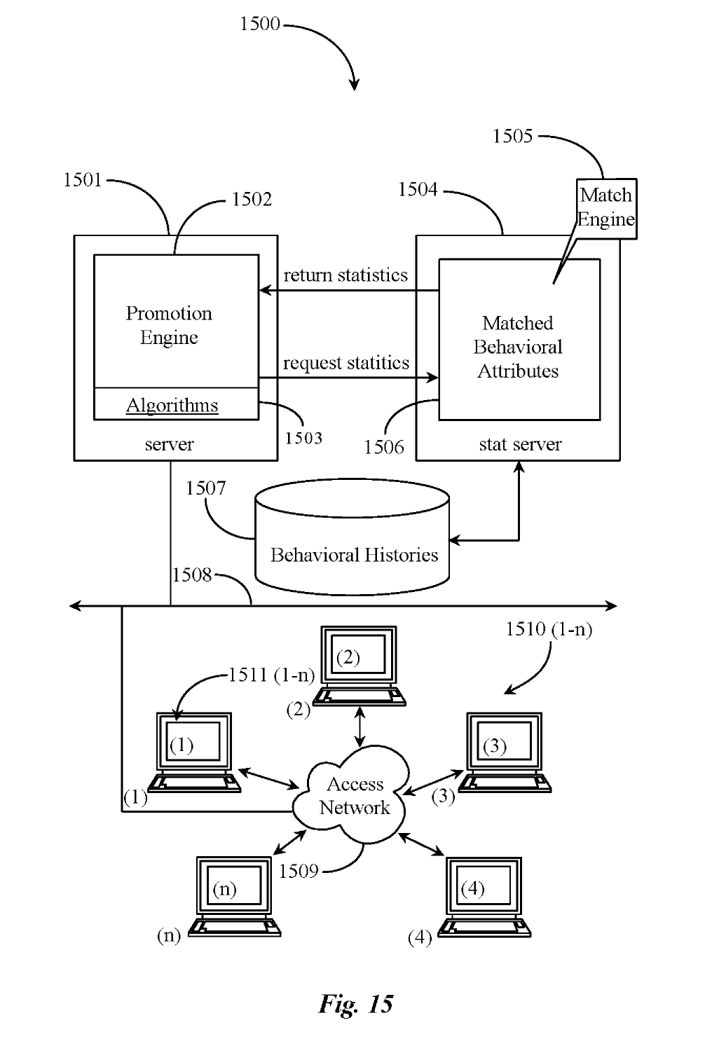

FIG. 15 is a block diagram 1500 depicting components involved in promoting group activities based on historical statistics about activity participation. Diagram 1500 includes a server 1501 which may be analogous in description to server 107 of FIG. 1. Server 1501 is connected to a network backbone 1508 which may be analogous in description to backbone 101 of FIG. 1. Server 1501 supports an activity promotion engine 1502. Promotion engine 1502 is adapted to promote group activities that are pending in the system wholly or at least in part on matching individuals with similar histories in attending and participating in group activities that are the same as or similar to the group activity for which the individuals are being aggregated.

Server 1501 has access separately or over the network to a statistics server 1504. Statistics server 1504 includes a processor and a memory, the memory including instructions for accessing user historical data relative to activity participation and for qualifying individuals as potential candidates to participate in a specific pending group activity based at least on past participation in the same or similar activities. In one embodiment individuals may be ranked relative to the intensity or frequency of past participation in a same or similar activity type. Server 1504 has access to a data repository 1507 containing behavioral histories of individual network users registered with the service of the invention. The data contained in repository 1507 is the result of ongoing monitoring of activity participation among network users over time. The data may include identification of the specific activities participated in including time and date. The data may reveal the intensity or frequency of participation in those activities. The data may reveal the duration of participation in each activity relative to the duration of each activity.

In one embodiment server 1504 supports an attribute-matching engine 1505 similar in construction to matching and ranking engine 301 of FIG. 3. In this embodiment historical events of attendance and or participation by individuals relative to group activities held in the past are matched up to an activity that is currently pending and for which individuals are sought as potential candidates for invitation to the pending group activity. Matching engine 1505 accepts as input at least a description of a group activity for which candidates are being aggregated. In one embodiment the description includes specific keywords that may be used as matching criteria to match with keywords contained in the user history data relative to past activity participation events in each individual's personal history of activity participation.

Server 1504 serves statistics to server 1501 relative to matched behavioral attributes 1506, which may be the result of the matching process performed by matching engine 1505. A behavioral attribute for an individual might include the activity type, the duration of participation in the activity, or the frequency (number of times) the individuals have participated in the same or similar activity. Server 1501 may receive a system request, for example, to discover individuals to vet as potential participants in a group activity. Server 1501 requests and receives statistics that have been processed by matching engine 1505. It is noted herein that matching engine 1505 may be hosted by server 1501 instead of server 1505 without departing from the spirit and scope of the present invention.

Activity-promotion engine 1502 may receive statistics about individuals and evidence of their past participation in at least the same activity or similar activities. The statistics received at server 1501 may include the identification of the individuals and contact information for the individuals. Promotion engine 1502 may be leveraged to further rank the strength of matching parameters for all of the individuals who had at least one incidence of participation in a same or similar activity. Promotion engine 1502 may rely upon one or more than one algorithm 1503 to rank matching strength for each individual identified in the returned statistics. In one embodiment ranking may be a part of the function of matching engine 1505 without departing from the spirit and scope of the present invention.

Promotion engine 1502 is adapted to generate invitations to send to those individuals that match the activity type promoted by virtue of past activity participation records revealing past participation by those individuals in the same or in a similar activity type. Invitations might include invitation emails or text messages, or other types of communications carrying invitations. In one embodiment invitations may be sent to social interaction site home pages operated by qualified individuals. In this example invitations to participate in a specific group activity for which matching was conducted are sent over network 1508 to individuals 1510 (1-n) connected to network 1508 through access network 1509. Individuals may receive invitations through an interactive user interface such as interfaces 1511 (1-n).

In one embodiment of the invention matching past participation to a specific activity may be conducted on top of profile-attribute matching. In one embodiment historical evidence of past participation in the same or similar group activity is the only criteria used to aggregate potential candidates for invitation to a specific activity. Similar activity types where the activities are not exactly the same as a pending activity may be characterized by activity categories. For example, a jog-a-thon may be a similar activity as a walk-a-thon, which may be considered similar to a relay for life, a fun run, a trail hike, etc. In one embodiment, individuals may be ranked according to how similar one activity is to the group activity for which the operation of aggregating individuals is conducted.

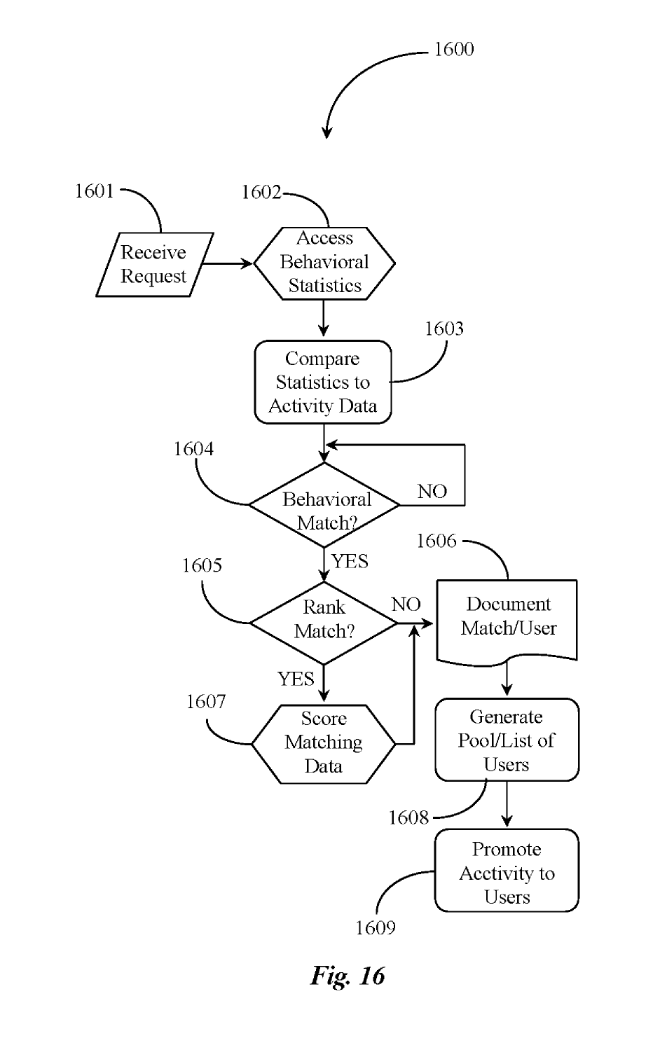

FIG. 16 is a process flow chart 1600 depicting steps for promoting a group activity based on behavioral attributes. At step 1601 the system receives a request to aggregate potential participants for a group activity pending in the system based at least in part on past evidence of activity participation discovered and logged as a result of ongoing monitoring of participation data. Such a request might be made by a system component for an activity that is hosted by a third-party activity vendor. In one embodiment a user might submit the request for a pending group activity that the user is hosting. While profile matching might be used to aggregate individuals who are more likely to get along, conducting the operation based solely on past participation histories may result in aggregation of individuals that are more likely to accept invitations to the activity and that already have prior experience in attending such activities.

In step 1602 the system may access behavioral statistics about activity participation from a data repository. Such raw statistics may be compiled through monitoring participation states of individuals over time. Behavioral statistics may include but are not limited to incidents of past participation in group activities that are the same as or similar to the group activity for which participants are sought. At step 1603 the statistics accessed in step 1602 are compared to activity data generic to the specific group activity for which potential participants are sought. Activity data may consist of keywords and phrases that are descriptive of the activity itself and any requirements required of potential participants to attend and participate in the activity.

At step 1604 the system determines for each potential participant identified in the statistical data if there is any match relative to past behavior, more particularly if the individual has attended and or participated in the same group activity in the past or any similar activities with which the potential participant might have been involved. For example if the group activity that is subject of the process is a fishing derby for bass and a potential participant had attended a fishing derby for trout, a match would be registered. The match would not be a 100 percent match however, because of the difference in the type of fish. A 100 percent match would be if the system determined that a potential participant had attended the same derby before, where the activity is an annual event.

If the system determines that there is no match for a participant at step 1604 the process loops back and makes a determination for the next participant. In actual practice the system may discover the matching events and then identify the users connected to those events. If the system determines that there is a match in step 1604, the process may optionally move to another determination step 1605 where the system may determine whether or not the match will be ranked for the strength of match. If the process ranks matches, then all of the matching events for a participant could be ranked for strength. If the process does not rank matches for strength of match, then the overall strength of a matching participant may be determined simply by the number of events in the participant's history that match the activity for which the participant's are sought.

If at step 1605 the system determines not to rank matches then the process moves to step 1606 where the system documents the discovered data for each participant. This may include quantifying the number of matches for each qualified participant, and perhaps determining the level of qualification by the number of incidents in the user's history that were considered a match. In one embodiment a time window of past history is enforced, such as to check only events over the past year for match. If the system determines to rank each match for a potential participant the process may move to step 1607, where the system may provide a score for each matching event. In this scenario each match is scored to determine the strength of the match in light of the activity for which participating individuals are sought. The system might rank each match and then quantify or otherwise determine a total rank or score for the participant relative to other participants who were vetted in the process.

In ranking participants, the system may rely upon specific criteria and certain weighting factors, rules, etc. One or more algorithms might be used during ranking. The process moves to step 1606 whether users are scored or not in step 1607. In the case of ranked or scored participants the system may as part of step 1606 document the user, the matching activities, and sort the information to order the candidates according to the highest score. In step 1608 the system might generate a pool of potential participants or a machine readable and/or human readable list of potential participants. This may depend upon the originator of the request of step 1601, be it the system or a user. At step 1609 the system invites the potential participants to attend and to participate in the activity. As described further above the invitations might be included in a text message, an email, or in a post or message sent to any interface or communications device operated by the user and connected to the network.

The process described above may provide a list or pool of users that may be more likely to participate in the promoted activity because of their involvement in the same or similar activities in the past. Other weighting factors may be considered in scoring the strength of a potential participant relative to other potential participants without departing from the spirit and scope of the invention. For example proximity of a potential participant may play a role in ranking the participant in terms of score. In one embodiment participant feedback about whether or not they enjoyed past activities determined by the system to match a promoted activity may play a role in ranking or scoring. Individuals who have history of repetitive participation in activities that are similar to a promoted activity are logically more likely to accept invitations to participate.

### Discovering Group Activities

In one embodiment of the present invention a network user may search a network-hosted data source for group activities that are registered in the system.

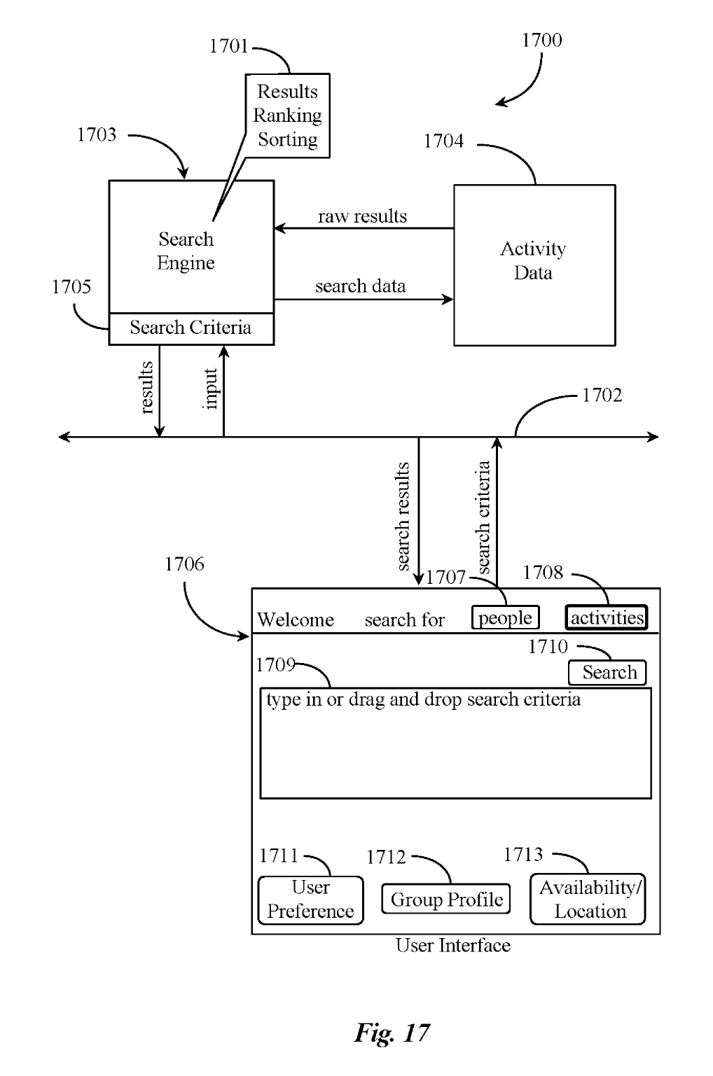

FIG. 17 is a block diagram 1700 depicting components involved in enabling a user search for group activities hosted on a network. Diagram 1700 depicts a search engine 1703. Search engine 1703 is hosted on and accessed from a server analogous to server 107 of FIG. 1. Search engine 1703 may be part of or integrated with GCAPP 109 of FIG. 1. Search engine 1703 includes a component 1701 for ranking and sorting search results. Component 1701 may be analogous to component 305 of FIG. 3. Search engine 1703 may be accessed by a user operating a network-connected device through a user interface 1706 displayed on the accessing appliance. Interface 1706 may be analogous to interface 303 of FIG. 3.

In this embodiment the Internet network is represented by a network backbone 1702. User interface 1706 includes at least two search options, a search option 1707 for searching people and a search option 1708 for searching for group activities. It is noted herein that there may be more than two search options or categories presented in interface 1706 without departing from the spirit and scope of the present invention. A user may select the option activities 1708 to initiate a search for group activities through interface 1706. Interface 1706 includes a text input field 1709 adapted to accept typed input from a user and input that a user copies and pastes or drags and drops into box 1709. Keywords, search terms, and phrases may be separated by commas, semicolons, or other separators.

In this embodiment search engine 1703 is adapted to use a variety of criteria for use in searching for activities that match the criteria. Interface 1706 includes a search-criteria category 1711 labeled user preference. User-preference category 1711 may be selected to cause automatic input of the user's activity preference profile. An activity profile attached to the user may describe all of the activity types in which the user might be interested. This data may include any activities the user is signed up for and any activities the user is following or has previously expressed an interest in.

A user may select input category 1711 to cause automatic inclusion of the activity profile as search criteria. The user may then activate search-action button 1710 to initiate the search. Interface 1706 includes a search-criteria option 1712 labeled group profile. The user may select this option to cause automatic inclusion of a group profile as search criteria for search activities. Group profile data includes desired attributes of other users who might participate in group activities with the user. A group profile may be attached to one or more activities in the system. In this regard the group profile attributes may describe the types or characteristics of persons that tend to participate in certain types of activities.

Group profile attributes may be equated to personal profile attributes of real network users who have a history of participating in various group activities. Therefore the attributes contained in a group profile may be matched to personal profiles of network users, each matching user associated with various activities in which those users have participated. By drawing on this statistical data from history of user-activity participation, the search engine may match users to a group profile and then compile a record of group activities that those users have participated in the past. The record compiled may then be used as search criteria to return a list of pending group activities matching the compiled historical record.

In this embodiment a user may select a search criteria option 1713 labeled availability/location to cause automatic inclusion of a user's current and future availability as well as the user's current and future location relative to the location of activities. Selecting option 1713 may cause automatic inclusion of this data to be used for searching for group activities in the system that match user availability dates and times and that fall within a pre-set range of the user's current or planned geolocation. The user's immediate availability and geolocation can be determined by GPS and calendar data.

The user's future availability and location may be determined through calendar information and location information related to calendar schedules. For example if a user has an appointment in a nearby town for which the location is revealed in the calendar data or implied from the name of the town, it may be inferred that the same user will have a general geolocation for a time before and a time after the appointment. The system may use this inferred information to search for pending activities that might be available along the route to and from the appointment.

In one embodiment an operating user may select more than one auto-search criteria option such as selecting option 1711 and 1712 to search for activities that match those the user prefers or is interested in and activities that match activities that people the user would like to interact with have participated in relative to participation history. In one embodiment the operating user may manually type in search terms, keywords, or phrases directly into box 1709 and then activate search button 1710 to initiate a search. The system will attempt to find any pending activities that might match to the user's typed search criteria. In still another embodiment, a user may select an auto option such as one of 1711-1713 and add some typed input to augment or further refine the search criteria.

The activities returned to the user may be ranked and sorted according to importance using component 1701. Likewise results might be prioritized according to specific criteria such as past participation in the same or similar activity by the searching user or by users that may be associated with the searching user, like friends or individuals the user may be following on the service. The activities returned may also include interactive links enabling the user to select an activity and elect to follow the activity or to join the activity as a participant. Upon receiving search criteria from the operating user, search engine 1703 may access a data source or repository 1704 containing the group activity data that is currently known to the system.

In one embodiment other criteria or constraints can be added to the search criteria. For example, an operating user may specify the search to return only activities that have already taken place or activities that are occurring now or within a specified timeframe of the search. Activity data returned to a searching operator may include the name of the activity, any group profiles associated with the activity, the location of the activity, and the proximity of the activity to the user (provided user location is known). The activity data may also include start time and end time, the minimum and or maximum number of users sought to participate, cost of the activity, and other activity details. For activities that have occurred in the past, there may be available photos taken when the activity happened, and available feedback from users about the activity. Activities that reoccur periodically such as annually, bi-annually, monthly, and so on may have rich media histories and comments associated. Such data may be made available by linking it to the search result for the activity. There are many possibilities.

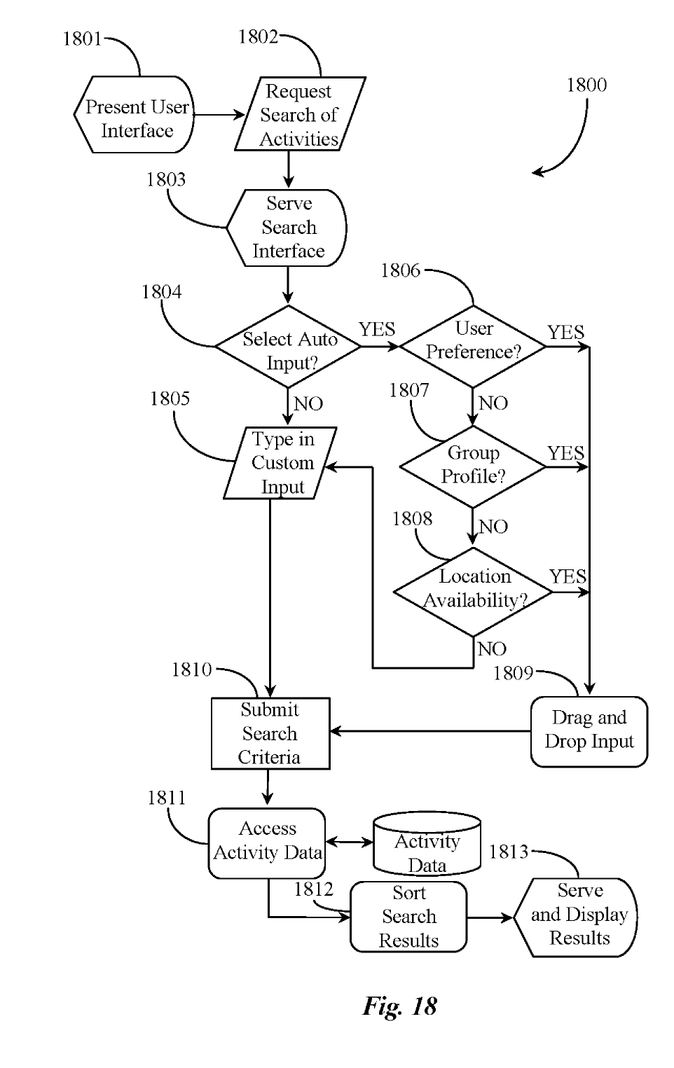

FIG. 18 is a process flow chart 1800 depicting steps for searching group activities hosted on a network. At step 1801a user receives an interface by connecting to the network and accessing the server responsible for providing access to services. The presented interface may be analogous to interface 107 of FIG. 1. At step 1802 the user may request a search of group activities known to the system. The phrase “known to the system” generally refers to any activity that has been promoted by the system presently or in the past, therefore having a record in the system of the present or prior activity. In one embodiment activities might be scheduled out indefinitely if the activity is held periodically, like annually, such as a recurring blues festival. The request for search activities can be initiated by selecting an action button in the interface such as “search activities”.

Upon requesting to search activities through the interface, the system may return a search function interface at step 1803 containing all of the components required to compile search criteria and to submit the criteria to initiate a data search for activities. The search-function interface may contain at least a text-input field and a search button for submitting the search criteria. At step 1804 the operating user may determine whether or not to select a search-criteria category for automatic inclusion of search criteria. If at step 1804 the operating user determines not to select a search-criteria category, the process may skip to step 1805 where the user may type in custom search criteria.

If the user determines to select an automatic search-criteria category at step 1804, the process may move to step 1806, where the user may determine if user preferences for a specific type or types of activities might be selected to cause the criteria to be automatically included in the search operation. If the user determines to select user preference as search criteria, the process may move to step 1809 where the operating user may drag and drop or copy and paste the criteria into the text input field. In one embodiment the selected option results in automated inclusion of all of the information into the search-input text field. If the user determines not to select user preferences as search criteria, the process may move to step 1807 where the user determines if a group profile will be selected for automatic inclusion into the text input field.

If the user selects a group-profile option for auto inclusion of the data as search criteria at step 1807, the process moves again to step 1809 where the user may drag and drop the profile into the text input field. It may be automatically included if the link is to a single group profile. In the event that there are more than one profile to select from, the user may review them before making a selection of a single profile that may be copied and pasted or dragged and dropped into the text input field.

If the user decides not to include a group profile as search criteria at step 1807, the process may move to step 1808 where the user determines whether to select location and or availability information to use as automated search criteria. User availability and location information can be retrieved from a user's calendar application that may contain certain location data linked to events in which the user is participating. Current user location may be obtained through a third-party GPS service. In one embodiment the operating user may determine “yes” at one or all of the determination steps 1806-1808. The data may be included together to further refine the search results. Likewise, the user may include data from step 1805 with data that is automatically included or included by drag and drop or copy and paste operation.

At step 1810 the operating user submits the search criteria to the server hosting the search function. At step 1811 the search function accesses the activity data from a data repository or other data source analogous to repository 1704 (FIG. 17) containing the group activity data. At step 1812 a sorting and ranking component analogous to component 1701 of FIG. 17 may rank and sort the search results according to various pre-set rules or constraints. At step 1813 the server serves the results, which are displayed on the user's connected appliance. The results may include various interactive links that upon activation may enable certain processes, such as applying to participate in or to follow an activity. Links may be included that enable the operating user to research past occurrences of a repeated group activity to see photos and user comments that were posted relative to the activity. In one embodiment such data may also be posted on the operating user's social interaction timeline, message board, or event calendar.

### Impromptu Group Activity Suggestion

In one embodiment of the present invention group activities may be created and promoted to users based on the behavior of a creating user or on location and availability data of one or multiple users.

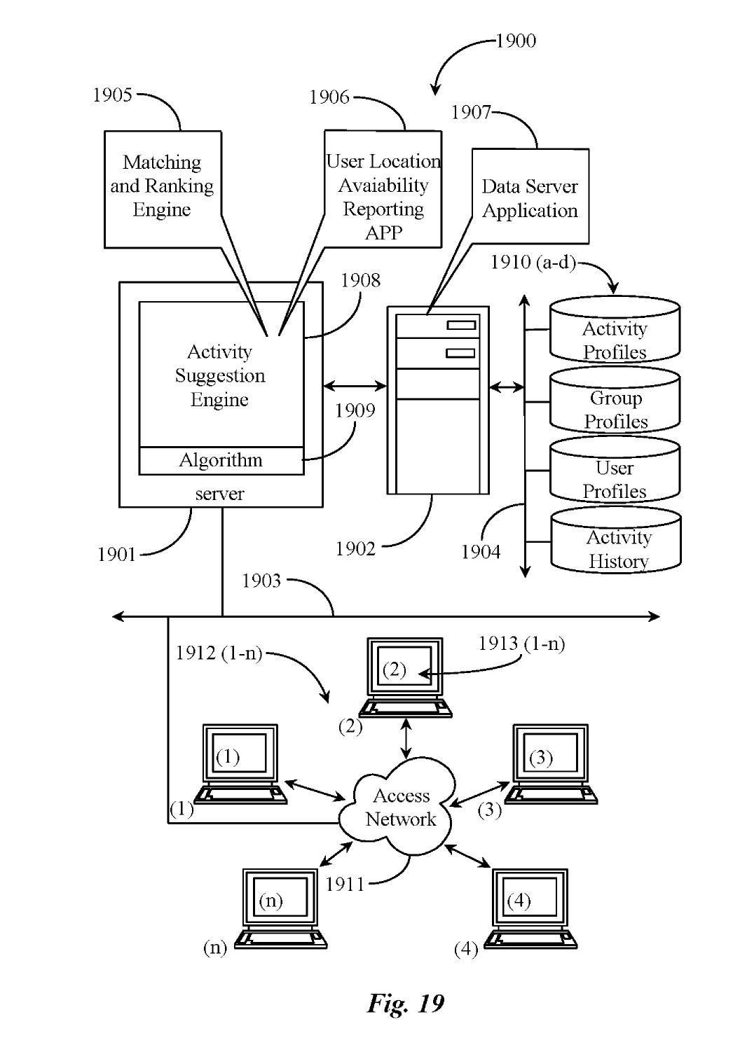

FIG. 19 is a block diagram 1900 depicting components involved in suggesting and promoting group activities to users based on location data and user availability. Diagram 1900 depicts a server 1901 having connection to a network backbone 1903 representing the Internet network in this example. Server 1900 may be analogous in description to server 107 described with respect to FIG. 1 above. Server 1901 has direct access to a server 1902 adapted as a data server with respect to data contained in one or more data repositories depicted herein as repositories 1910 (a-d).

Server 1901 hosts an activity suggestion engine 1908. Activity suggestion engine 1908 may be a part of or integrated with GCAPP 109 described further above with respect to FIG. 1. Activity suggestion engine 1908 is adapted to accept one or more types of data relative to network users registered with the service in order to determine what if any group activities known to the system might be suggested and promoted to one or more of the users whose data was analyzed with the aid of one or more algorithms 1909.

Activity-suggestion engine 1908 may function in cooperation with a data-matching and ranking engine 1905. Matching and ranking engine 1905 is adapted to infer matches within different sets of user data and to rank the importance of such matches in selecting, in this case, specific activities known to the system that may be more likely to be accepted when selected for suggestion and promotion to a certain set of users. The activity suggestion engine may also receive input from a first or third-party location and availability-reporting application 1906. Availability and reporting application 1906 may reside on server 1901 as depicted, or it may reside on another server, such as server 102, without departing from the spirit and scope of the present invention.

Server 1902 has direct access in this example, via a local area network (LAN), to data repositories 1910 (a-d). Repositories 1910 (a-d) are depicted as separate repositories for illustrative and descriptive purposes only, because of the existence of several different categories of user data discussed in this embodiment. In one embodiment all of the different user data types may reside in a single data repository without departing from the spirit and scope of the present invention.

Repositories 1910 (a-d) may include activity-profile data (1910 a). Activity-profile data is data submitted by a user that describes the types of group activities in which the submitting user is interested in participating. Repositories 1910 (a-d) may include group profile data (1910 b). Group profile data is data submitted by a user that describes the types of individuals that a user might want to interact with during participation in specific group activities.

Repositories 1910 (a-d) may include user-profile data (1910 c). User-profile data is data posted or otherwise published or made accessible by a user that describes various facts about and attributes, including characteristics of the user. Repositories 1910 (a-d) may include activity-history data (1910 d). Activity-history data is data compiled through monitoring user behavior that describes which group activities that a user has been involved with either through promotion, following, expressing interest in, or in which the user has directly participated.

Diagram 1900 includes an access network 1911 having connection to Internet 1903. Access network 1911 may be analogous to network 104 of FIG. 1. Access network 1911 provides Internet access to users 1912 (1-n). In this embodiment, users 1912 (1-n) represent all users registered with the service of the present invention. Each user appliance connected through access network 1911 has an electronic user interface 1913 (1-n) displayed and may be assumed to be connected online and to server 1901 over network 1903.

In use of the present invention, among other data, user location and availability information may be accessed by the system to determine if there may be an opportunity to suggest and promote one or more group activities to a group of users. In this operation different data types might be reviewed and matched to determine, along with location data and availability data, groups of users who might have a higher probability of accepting invitations to group activities than would be the case with random activity promotion to users in general.

In one embodiment activity-suggestion engine 1908 might access and review user data stored in one or more of repositories 1910 (a-d). Data server 1902 serves user data to server 1901 upon request. Activity profiles submitted by users describe types of activities in which the users are interested. Activity-suggestion engine 1908 may rely on this information when determining which of many available group activities might have a higher proportion of acceptance if they were suggested to those users. Group profiles describe types of individuals that a user may desire to interact with during a group activity. Activity suggestion engine might rely upon this information with the aid of matching and ranking engine 1905, to determine subgroups of users who may have a higher probability of getting along with one another. This might be combined with analysis of activity-profile information to further refine subgroups who like the same activities and who may get along better.

User-profile data characterizes the personal facts and characteristics of a specific user. User profiles may reference one or more activity types. Activity suggestion engine 1908 might review user-profile data in combination with group profile data and activity profile data with the above-described data types to further refine subgroups that might have a higher percentage probability of accepting a group activity suggestion and invitation to the activity. Activity-history data may also be leveraged to determine group activities that the targeted users have participated in before. This information may be combined with activity preference data to further refine a pool of group activities that might be suggested and promoted to certain subgroups within the user base.

Ultimately location information and user availability plays a huge roll in whether a user will accept a group activity suggestion and invitation. In one embodiment those users who are drawn from the user base after analyzing data about them and, perhaps, refining the base into smaller subgroups of users, are further analyzed with respect to current and future location information and current and future availability information. For example, if a user is not available for participation in a group activity because of location (too far away) or availability, meaning the user cannot be there at the proposed date and time of the activity as evidenced in published calendar or scheduling information, that user would not be included within a subgroup of users who are located within a preset geographic range of the suggested group activity, and have no scheduling conflicts with respect to the proposed data and time of the suggested activity.

In one embodiment location-information and availability data may be the sole criteria for impromptu suggestion and promotion of group activities to those users. In this embodiment all activities known in the system that might be suggested to users are scheduled to occur at a place the users may travel to and at a time that does not already conflict with user schedules. No other data need be analyzed except for to refine the base of users according to various aspects inferred by the results of analysis of the data. In one embodiment all of the various data types might be processed along with determination of location and availability to derive one or more target group of users whereby suggestions and invitations made by the system are more apt to be accepted and successful. It is noted herein that this process may be part of an ongoing or continual process that happens in the background and may be transparent to users until such activities are suggested and promoted.

In one embodiment the group activities suggested to users may be hosted by third-party activity vendors in local areas where certain groups of users reside. In this case the user does not have to sponsor, host, or create the group activity. In another embodiment a group activity might be suggested to one user who may accept the suggestion and with acceptance of the suggestion, have the additional responsibility of creating the group activity in the system. This might be undertaken if a user has never or infrequently hosted a group activity. In this case the system may suggest a group activity for creation by the user and may also show to the user the list of potential participants and their likelihood ratio of accepting the invitation. The system might also include the best possible dates and times for scheduling the new group activity based on analysis of the location and availability data of the potential participants.

In one embodiment just location and availability is used to suggest possible group activities sponsored by third-party activity vendors. In this embodiment it might be detected that an active group of users is in an acceptable range of the activity and that they are free s to participate in the activity. It may be that some of these users might know one another and may be friends, family, or network friends. This data might also be made available to the system through review of social graph information. For example a registered user with a Facebook™ account might have 300 friends with 20 of those friends residing in the user's hometown. This group of 20 users may be exploited to determine subgroups that would get along well together and that collectively they support certain types of activities or have certain activity preferences in common. When two or more of these users are in the range of an unfilled group activity and are deemed available to participate (calendar/scheduling data) those users may be invited to an existing activity on the fly, the activity to happen shortly in the vicinity in which that they are currently.

In another embodiment the system may suggest creating a new activity for which it has verified that a group of users may have a high probability to accept an invitation. In this case a user having the highest activity participation rate or perhaps, activity creation rate in past history might be asked by the system to create a specific activity for which the system as already vetted potential participants who are now or will be in the vicinity of the activity and whose scheduling data indicates they can attend the activity. The system may also, in one embodiment, approach an activity vendor with the prospect of creating an activity in the same light. In these embodiments the system might also suggest the best date and time for the activity.

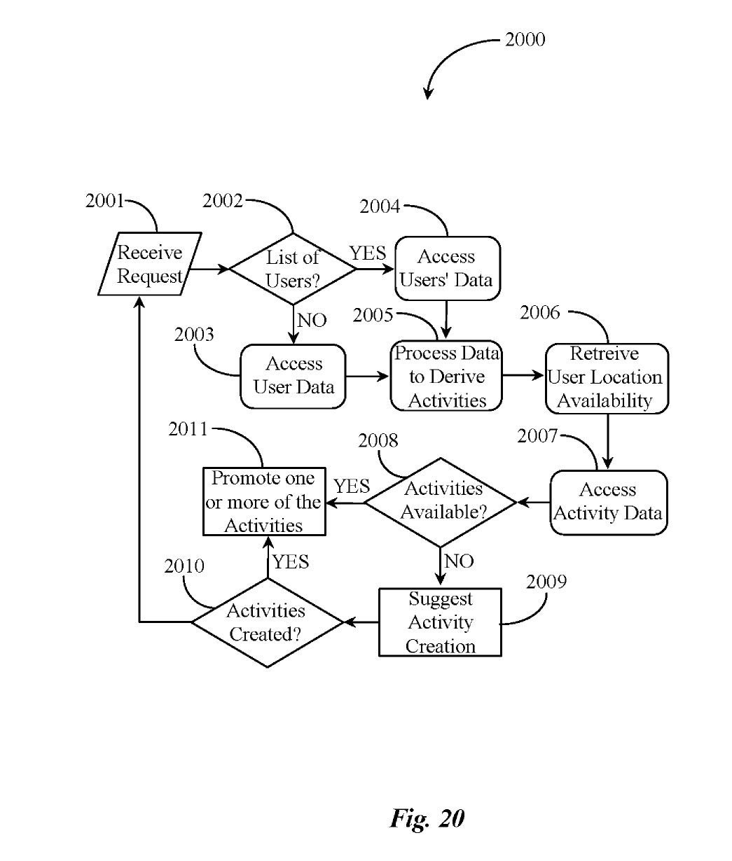

FIG. 20 is a process flow chart 2000 depicting steps for suggesting and promoting one or more activities to users based on location and availability data. At step 2001 the system may receive a request from another component of the system, from an activity vendor, or from a user. The request might be a query as to whether there might be an activity the system could suggest for a user to participate in or to create and promote. Likewise a vendor might query the system about what types of activities would be good to create and promote for a specific area in a specific time frame.

Process 2000 may vary slightly according to the source of the request. In the case of a system request, the system may be attempting to fill scheduled activities submitted for promotion by users and or activity vendors. In a variation of this aspect, the system might create or suggest creation of a group activity based on prior knowledge of potential participants in the vicinity and having a schedule that could accommodate participation in the activity. In the case of a user request or activity vendor request, the system may aid those entities in filling the activity using process 2000.

In step 2002 the system may determine whether the request is accompanied by a target set or base of users. This determination may define the scope of processing. If the system determines in step 2002 that there is no list or pool of pre-targeted users, the system may access data for all users in step 2003. If the system determines in step 2002 that there is a pre-targeted set or list of users, the system may access data about only those users that were prelisted in step 2004. For example a user might send the request in step 2000 with a set of users that the operating user is friends with and that live or reside in the vicinity of the user, and may have a history of participating in activities with the operating user.

In either case the process moves to step 2005 where the system may process and analyze the accessed data to derive a list of activities that might have a higher likelihood of being promoted successfully in a certain area during a certain time period. The types of data processed may vary, but activity profile, group profile, user profile, and activity history data may be important data to access in order to help the system determine activities for suggestion and promotion.

Once the data is processed and analyzed, the system may have a list of activities along with the set of users who may be targeted in promotion of the activity. At step 2006 the system may retrieve current and future location and availability of the users in the set of users considered for targeting. This information may aid the system in determining which users among a larger group will be available and reside closely enough to participate in a particular activity. At step 2007 the system might access current activity data in the system. This might include activities that are listed but currently have no scheduling information or are otherwise disabled unless one or more conditions can be met to activate and schedule the group activity.

At step 2008 the system may determine if there are already available group activities in the system, scheduled or not, that the system might suggest to a user or to a user group. Available activities might be refined according to the activity data derived at step 2005. A matching algorithm might be leveraged to produce the matching activities in the system. In one embodiment the system may also be an activity host or sponsor. If there are activities available that would fit the population of users in the vicinity, those users having schedules that may accommodate participation in those activities, the process may move to step 2011 where the system suggests and promotes one or more of the activities.

In the discovery of the activities available, the data may be ranked to prioritize the activity types that are most likely to be accepted by the population of users according to the review and analysis of the user data. If the system determines that there are no activities in the system that would be a good fit for the studied population of users, then the system might move to step 2009 where the system may suggest creation of a new activity or activities. In this embodiment the system may approach the user in the population having the highest rate of activity creation and may suggest that the user create a particular group activity, and may also suggest when and where the activity should occur. The system may also display to the approached user or activity vendor a list of potential participants along with probability scores associated with how likely it might be to get them to participate.

At step 2010 the system may determine if any new activities that were suggested for creation were created. If the system determines that an activity was created for the likely population of users, the process then moves to step 2011 where the system may promote one or more of the activities. If the system failed to get a response, and determines that no activities were created, the process may resolve back to step 2001 where a new request might be received to trigger the process again. Process 2000 may operate in the background and may be largely transparent to users with the exception of those users, including activity vendors that are making requests.

In one embodiment activities may be suggested on the fly where no exact scheduling information exists for the activity. For example a user might create a new activity in which the user wants to participate, but may not provide an exact date and time that the activity might be held. In one aspect the user may specify a day for the activity, but may not know exactly what time the activity should occur. In one example a user may want to go to lunch in the context of a group activity where other participants may attend the lunch activity.

After specifying that the user will be going to a group activity called “lunch”, the user may discover that they will now go to that activity without committing to an exact time. The user may log into the system and alert the system that they are starting the activity or are on the way to the activity. The system using GPS and similar technologies may triangulate the user's location in light of the activity location, calculate the speed of travel to the activity location or based on their mode of travel to the location, and estimate a time that the user will arrive at the activity location. In one embodiment the system may monitor the user location and may infer based on trajectory that the user is moving toward the activity location.

The activity might be promoted in real time as the user is headed toward the activity. Potential activity participants in this case may be users who are co-workers of the requesting user or simply users that might already be in the vicinity of the activity. These users may be notified about the activity, the activity location, and the estimated time of arrival of the requesting user if the user is not already at the activity location. In one embodiment the activity may be created in the morning of the day it will occur and other users might be invited though the activity has no start or end time. When the user leaves for the activity, he or she might specify a time for the activity to start or may simply say to the system that they are now on the way to the activity, or the system, if monitoring the movements of the user, may simply infer by the user's travel that the user is headed toward the activity.

The system may alert other users about the activity and movement of the requesting user. The other users may be those that were invited when the activity was created or users who are following the requesting user and are in the same vicinity, or users who are simply near the same location and have open schedules. In one embodiment where the other users are being monitored as to location, the system might inform all of the potential participants as to the whereabouts and estimated arrival times of other users who have agreed to join the activity or that may be inferred as traveling toward the activity. Maps may be generated and sent as part of an update to the connected devices of participants that want to join the activity.

### Automatic Price Setting for Group Activities

In one embodiment of the present invention group activities may be associated with a fee to participate. Such fees or pricing may be originally set for a group activity and then adjusted automatically based on one or more conditions being met.

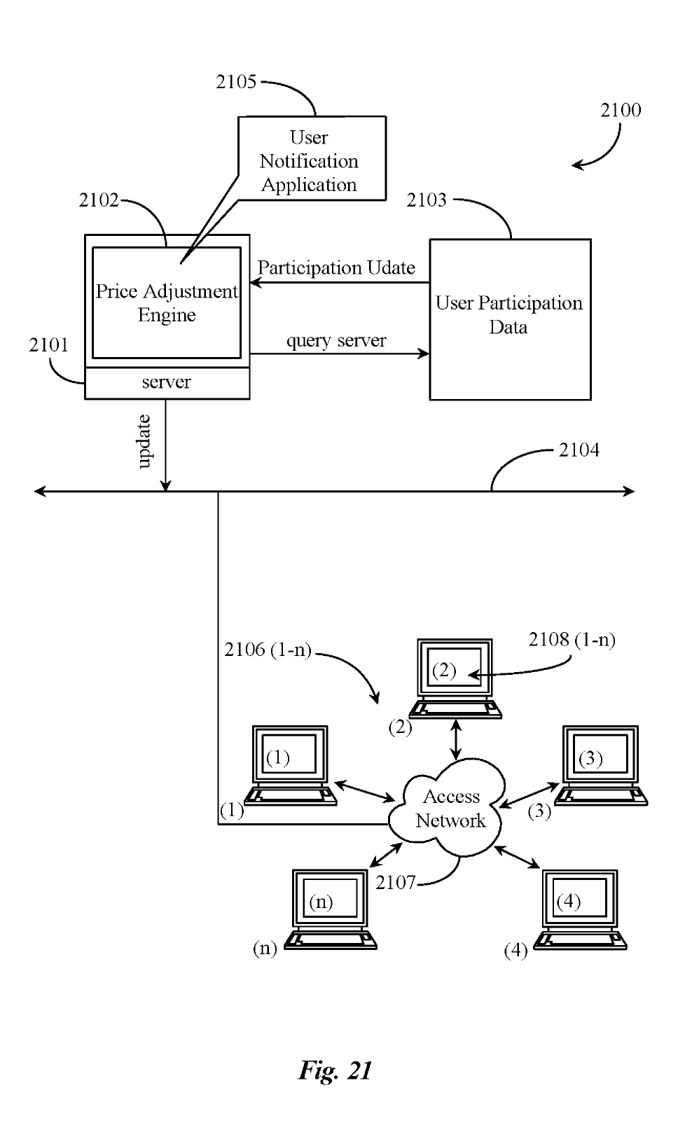

FIG. 21 is a block diagram 2100 depicting components involved in automatic price adjustment for group activities. Diagram 2100 depicts an Internet network 2104 represented herein by an Internet backbone. Internet 2104 supports a server 2101 which may be analogous to server 107 of FIG. 1. Server 2101 hosts a price-adjustment engine 2102. Price-adjustment engine 2102 may be part of or integrated with GC APP 109 of FIG. 1. Price-adjustment engine 2102 is adapted in this embodiment to receive and disseminate a pricing model or structure associated with a specific group activity being promoted in the system. A pricing model may be created for a group activity for which a fee or price is required for some or all participants to the activity. Price-adjustment engine 2102 may also receive participation data about users that have signed on or otherwise have registered to participate in the group activity. User participation data may include the number of users currently registered to participate in the group activity, the gender mix and age ranges of the participants, and other pertinent data about participants relative to the activity.

In this embodiment server 2101 has direct access to a data server 2103 adapted to serve user-participation data in a push or notification model or as a result of a query. In one embodiment element 2103 is a data repository directly accessible from server 2101. A group activity may include a pre-set pricing model that defines certain parameters about the pricing structure for the activity. Such a pricing model may be created during activity creation and may be stored along with the group activity in a data repository. The pricing may include different pricing attributes for different types of users who might participate in the activity. For example men may be required to pay a specified dollar amount to participate while women may be required to pay a different price or, perhaps nothing to attend the group activity.

Likewise, children (if allowed) may pay still a different price to attend the activity. The pricing model may also contain rules or constraints that describe different pricing attributes that apply according to perceived changes in the group participation parameters including maximum and minimum number of participants, whether participants are activity members (members of an organization promoting the group activity), have discount proof to reduce their pricing, can show pre-payment for the activity, and any other conditions that might be deemed a reason for adjusting current pricing parameters attached to the activity.

Diagram 2100 depicts an access network 2107 having connection to Internet network 2104. Access network 2107 may be analogous to carrier network 104 of FIG. 1. Access network 2107 is adapted to provide Internet access to users 2106 (1-n). Users 2106 (1-n) may be assumed in this example to be registered users that may practice the present invention as it relates to participating in group activities promoted over the network. Users 2106 (1-n) may access server 2101 through access network 2107 and over Internet 2104 via electronic interface 2108 (1-n). Electronic interface 2108 (1-n) may be analogous to interface 115 of FIG. 1.

For a given group activity, price adjustment engine 2102 may start with a basic pricing model for the activity, the model including one or more adjustment rules or constraints that may or may not be triggered based on current participation states of users 2106 (1-n), including other states related to the group activity or to the organization or user promoting the activity. As the group activity participation roster evolves, users who have registered to participate or otherwise have expressed an interest in the activity, such as by following the activity, may receive periodic updates relative to adjusted pricing to participate in the activity.

Price adjustment engine 2102 with the aid of a user notification application 2105 may push periodic updates to users 2106 (1-n) over Internet 2104 and access network 2107. In one embodiment a group activity may accept a minimum number of participants in order to be activated and scheduled, where each participant would pay a maximum fee divided by the number attending. As more invitees to the activity register to participate, price adjustment engine 2102 may automatically adjust the price down per user according to any upward change in the number of users committed to participate, up to a maximum number of users permitted to participate. Likewise if a number of users cancel, bringing the total number of participating users down, price adjustment engine 2102 may adjust the per user price back up, keeping with the current number of users registered to participate. An example of such an activity might be a dinner cruise on a boat where the total price to take the boat out is static and divided by the number of users attending the cruise.

User participation data 2103 is data about the users who are connected to a group activity for which the price adjustment engine is monitoring the user participation state. User participation data may include data about user associations with a particular group activity. For example a group activity may be a repetitive activity held annually. In this case user participation data may include history of participation in a same group activity. Such data may trigger a price adjustment for users having such history as part of a loyalty program, for example. Users who have participated in the activity in the past might receive a discount for continuing to patronize the activity year after year.

Use participation data 2103 may also include membership data relative to an organization promoting the activity, where having a membership results in a lower price to participate in the activity. In one embodiment an auction model might be used to set pricing for a group activity. In such an embodiment the group activity might be deactivated until enough users meet a minimum bid (participation fee) to enable the activity to be scheduled. Users who are willing to bid higher may be assigned to better seating, or may receive some amenity that minimum bidders don't receive, etc. Such a model may be applicable to group activities sponsored by non-profit groups, such as benefits where user dollars are a donation and the activity includes a minimum donation amount to attend.

In one embodiment, price adjustment engine 2102 includes a link to a third-party secure network transaction server (not illustrated) where users 2106 (1-n) may pay group activity fees online prior to engaging in the activity. Price adjustment engine 2102 may provide such a secure online payment option in notifications to users that contain the latest pricing information. In one embodiment pricing might be variable for a group activity over time or according to season.

In one embodiment a group activity may have a basic price to attend and then added fees for joining any sub activities that might be available to users within the framework of the main group activity or event. Price adjustment engine 2101 may set pricing for specific users based on those users attending the main event plus any of the supported sub events affecting their total fee. For example, a main event might be a business expo and sub events might be activities hosted by certain businesses having tables or booths at the event.

In one embodiment the price adjustment engine may also monitor user active participation at a main activity and if that user participated in certain sub activities, then a rebate or discount on the total price might be granted the user. For example if the main event is a health expo and the user visited and paid for medical tests or engaged in some other service offered as a sub activity at the main event that user might receive a credit, discount rebate or might be charged a lower total fee after the fact based on what the user did at the event.

In one embodiment user participation data 2103 may include group-profile data and user-profile data. Such data might be analyzed to determine pricing for those users. In one embodiment user participation data 2103 includes past purchase history relative to past occurrences of the group activity. Price-adjustment engine 2102 may be operated by a third party hosting the activity wherein the third party uses the application to adjust pricing. In another embodiment the engine might be operated by a third-party transaction provider that is not connected to the host of the activity or to the entity responsible for filling the activity with participants. In both of these cases the service may provide access to the price-adjustment engine for third-party use.

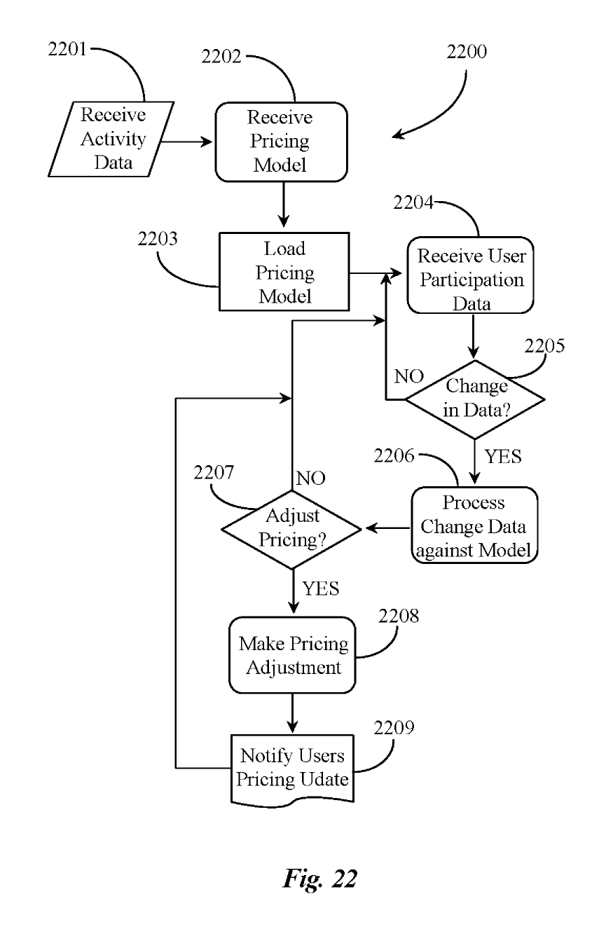

FIG. 22 is a process flow chart 2200 depicting steps for adjusting pricing for a group activity based on one or more changed conditions. At step 2201 the service might receive activity data including a full description of a group activity and the scheduling and active or non-active status for the activity. A group activity may be in an active state or scheduled to occur, or it may be in a disabled state waiting on one or more conditions to be satisfied before the activity is enabled or scheduled to occur. Price-adjustment engine 2102 and notification application 2105 of FIG. 21 may coordinate to set price and notify users when a group activity that was not activated becomes active in the system.

At step 2202 the price-adjustment engine may receive a pricing model associated with the activity. In one embodiment several different activity types may share a basic pricing model. In one embodiment a pricing model unique to a specific activity might be created and stored along with the activity data. At step 2203 the price adjustment engine may load the pricing model in order to set the initial price structure for participating in the group activity. The pricing model may include one or more rules and constraints including one or more algorithms for processing data based on those rules and constraints.

At step 2204 the price-adjustment engine receives user participation data. This data may be pushed to the pricing engine periodically as users that were invited to attend the activity register to participate, commit to follow, or otherwise express some interest in participating. In another embodiment the data may be accessed periodically using a query as described further above with respect to FIG. 21. Users who have registered to participate, applied to follow, or just want to be notified about the activity may have their data analyzed by price-adjustment engine 2102 and may be updated periodically or upon changes in data by user notification application 2105 of FIG. 21. If user-participation data is sufficient for the price-adjustment engine to set an initial fee structure for the activity, the process might result in an initial notification to the users associated with the activity and for whom data is being reviewed.

It may be assumed in this embodiment that the participating and other associated users have already received at least an initial notification reflecting a pricing structure for the activity. At step 2205 the system may determine upon the next access to user participation data whether or not there are any changes to the participation state for the users. If at step 2205 the system determines there is no change in user participation data since the last notification sent out to participants and other associated users, the process may loop back the step 2204 for the next round of data review.

If the system determines that there is a change in the user participation data, the price adjustment engine may process the change data against the pricing model at step 2206. The process may then proceed to step 2207 where the system determines if the data processing performed at step 2206 results in a change in pricing structure. If the system determines at step 2207 that no price adjustment is warranted according to the last review of data, the process may loop back to step 2204 for the next round of data analysis. If the price-adjustment engine determines at step 2207 that a price adjustment is warranted or required due to the results of data analysis, then the pricing engine makes the pricing adjustment at step 2208. The price adjustment may affect one, all or some of the participating users depending on the nature of the change data.

At step 2209 the user-notification application notifies all of the users about the price adjustment in the form of an update. Notification may be achieved by pushing the data into personal interfaces like interface 2107 (1-n) of FIG. 21, or it may be sent via text message, email, or some other communication method, including messaging and or posting on personal social interaction profile pages of users. The process may then resolve back to step 2204 for the next round of data review.

At some point in the process the pricing adjustments may result in a final fee structure for a group activity that is not subject to any more changes. Notification of this may reflect that fact by notifying all users that the current fee is final. A simple example would be a group activity having a maximum allowable number of participants where the user fee is an amount to be divided by the number of registered participants and therefore contingent upon the number of participants registered to attend the event. At the maximum number of users, the fee may be the lowest possible fee per user. The variety of possible pricing schemes is limited only by pricing models created for activities.

### Dynamic Group Profile Generation

In one embodiment a group profile may be created from data about users who are committed to participate, currently participating in, or who have participated in a group activity in the past, and then the profile is attached to that activity.

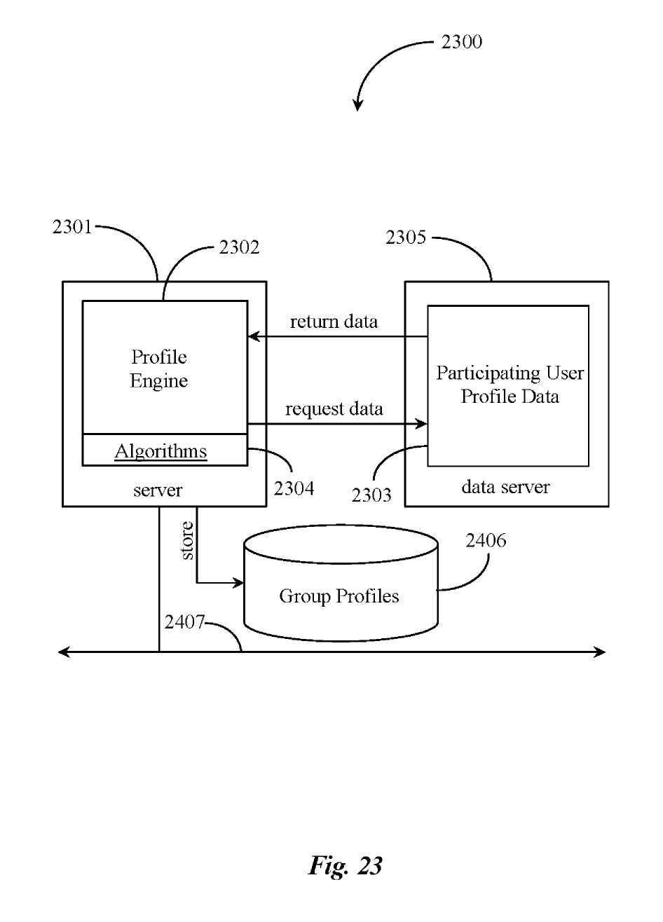

FIG. 23 is a block diagram 2300 depicting components involved in generating a group profile from profile attributes of participating users. Diagram 2300 includes a server 2301 connected to an Internet network represented herein by a network backbone 2407. Server 2301 may be analogous to server 107 of FIG. 1. Server 2301 hosts a profile-generation engine 2302. Profile-generation engine 2302 is adapted to generate group profiles from the attributes found in personal profile data attached to users. In this embodiment profile engine 2302 is adapted to generate a group profile that is specific to users who have a current, future, or past participation link to a specific group activity.

Server 2301 has direct access in this embodiment to a data server 2305. Data server 2305 is adapted to serve data about users who are linked to a specific activity through some participation state. The data is represented herein as participating user-profile data 2303. Participating user-profile data includes the personal profile attributes of each user linked through a participation state to a specified activity for which the group profile is generated. The participation states may include users who are committed to participating in the specified activity in the future, users who are currently participating in the activity, and users who have participated in the activity in the past.

Data 2303 may be accessed from a data repository containing data about users. The portion of data accessed for the purpose of generating a group profile specific to an activity may include user identification and any attributes contained in information about the user including personal profile attributes. These attributes may include many demographic attributes such as gender, age, ethnicity, education level, profession, etc. The attributes may also include those that may be descriptive of the user's character, beliefs, experiences, skill levels, likes, dislikes, etc.

Profile engine 2302 may be requested or ordered from time to time to generate a group profile for a specified activity using the attributes of users who have participated in the activity, are participating in the activity, and or who have signed up to participate in the activity, but have not yet participated. In generating the group profile for the activity, profile engine 2302 may perform one or more mathematical processes using one or more algorithms 2304.

In use of the present invention profile engine 2302 is called upon to create a group profile for a specific activity. It is assumed in this example that the engine has access to the activity data including the description of the activity and a list or roster of users who are linked to the activity through a state of participation associated with the activity. Profile engine 2302 may request participating user-profile data 2303 from data server 2405. The request may include the identifications of all of the users who have participation states associated with the activity. Data server 2303 returns the data to server 2301, and with the aid of profile engine 2302, the data is processed for user profile attributes that the users have generally in common with one another.

Profile engine 2302 may leverage one or more algorithms 2304 to process the data returned by server 2405. In processing the data profile engine 2302 accounts for each instance of an attribute for each of the identified users. In this way the attributes are accounted for in total numbers across all of the identified users. In one embodiment all of the attributes are counted per instance and the highest numbers of a same attribute shared among the identified users are considered as ranking for that attribute in the group profile. Attributes like age, gender, etc. provide the demographics for the group profile.

Profile engine 2302 creates a group profile from the personal profile attributes of the individuals who were connected to the activity through participation states. The participation states may include those who participated in the activity in the past, those who are currently participating in the activity and or those who have signed on to participate but have not yet participated in the activity. The roster of users for which attributes are collected may include only those who have participated in the past, only those who are currently participating, or only those who have signed on to participate. In one embodiment the roster of users may include a combination of or all of the above participation states.

Profile engine 2302 stores the created group profile in a data repository such as data repository 2406 for latter reference. In this embodiment the group profile is associated with the specific activity. For the activity the profile confirms the more prominent attributes shared among the individuals that had a participation state relative to the activity. In the group profile ratios may be used to express the age and gender of the group. There may be other such attributes not shared by all of the users. These attributes may be expressed in terms of a ratio to the total number of users sampled. In one embodiment there may be one or more thresholds established for some or all of the counted attributes, wherein the attribute must be shared by a minimum number of the users in order to be included in the group profile.

The created group profile accurately describes an aggregation or group of actual users who had participation states with the activity. A user may search for an activity by submitting a group profile created by that user. The attributes in the submitted group profile may be matched to the attributes in the group profile created for and attached to a group activity. The group profile attached to an activity that most closely matches the user-generated group profile may be served as the highest ranked result. The revealed group activity might be considered the top activity the user might consider participating in the future based on the profile match. The next result may point to another activity having a group profile that did not match as well as the first listing. Activities might be listed in ascending or descending order.

A group profile generated for a specific activity might also be used to promote the activity. For example the system may access a group profile attached to a user's account, and in the background may match that profile to a pool or collection of group profiles attached to the activities for which they were created. The activities identified as associated with the closest matching profiles may be suggested to the user or promoted to the user. The first disclosure to the user that a specific activity is being recommended to the user may include the indication that the types of individuals that that user may wish to interact with most have participated in the following activity. The disclosure may include a mechanism for the user to select and join any of the suggested activities.

In another embodiment activities may be grouped according to matching of group profiles created for the activities. For example if there are 5 group profiles each attached to a different activity, and three of those profiles match beyond a preset threshold, the three activities attached to those profiles may be grouped based on the match. In one embodiment the group of activities may be attached to all three matching profiles, such that the list of activities attached to a group profile may grow due to discovery of other activities attached to similar group profiles.

In one embodiment the user participation data includes statistics including purchase history, participation frequency, and contribution history relative to promoting or facilitating the activity. In one embodiment the group profile created for an activity is periodically modified as a result of ongoing procurement and evaluation of newer information about the participating users. In one embodiment the user participation information further includes participation data about certain sub activities provided and included in the main group activity. In one embodiment a group-activity profile is generated for the activity every time the activity reoccurs. In one embodiment the user participation data includes purchase history participation frequency and contribution history relative to promoting or facilitating or hosting the group activity.

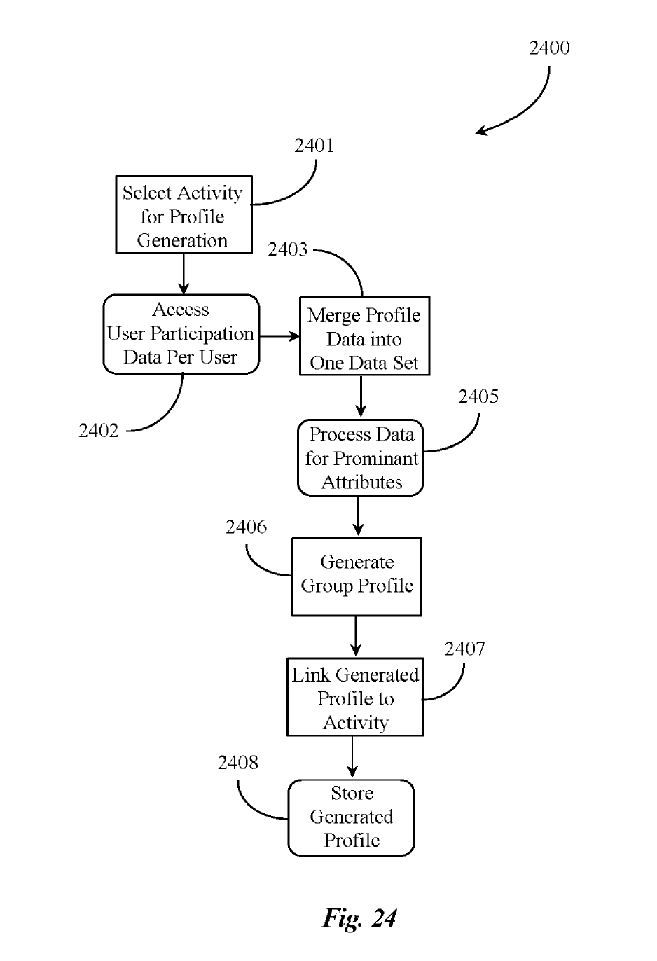

FIG. 24 is a process flow chart 2400 illustrating steps for creating a group profile from participant data. At step 2401 the system may select an activity for profile generation. The activity selected may or may not have one or more group profiles already attached to it. The activity selected has a number of individuals associated with it via some participation state. The participation state may be individuals who have participated in the activity in the past, individuals who are currently participating in the activity and/or individuals who have signed on to participate in the activity but have not yet done so. Each individual associated with the activity through some participation state has a personal profile that is accessible to the system.

At step 2402 the system accesses user participation data per user. The users may be listed in the system as associated to the group activity selected by participation state. At step 2403 the system, aided by the profile engine, merges personal profile data of the users into a single data set. The identification of the users may not be retained other than to identify their portion of the merged data. At step 2405 the profile engine processes all of the data for prominent attributes. A prominent attribute is one that is repeated for an acceptable number of users or beyond a threshold of instances of the attribute repeated in the data set.

At step 2406 the group profile engine generates a group profile containing the more prominent attributes shared by all of the individuals sampled. The group profile provides an accurate list of attributes for the group that actually had a participation state with the activity selected. At step 2407 the system links or otherwise associates the group profile to the activity and at step 2408 the activity and the associated profile are stored for future reference.

In one embodiment the system may create group profiles for activities that have a high likelihood of repeated occurrence. In one embodiment a group profile created for one activity might be linked to similar activities if the activity descriptions matched one another beyond a certain match threshold. In another embodiment only one group profile may be attached to one activity. However, a new group profile could be created for an activity that has a group profile already associated with it, where the new profile replaces the older profile. A user may search for an activity by submitting a group profile generated by that user. The generated profile may be compared to group profiles created for activities, and the highest matching activities may be returned to the user in search results. In one embodiment the group profiles created for activities might be used in promotion of those activities where the system matches the group profiles to group profiles of users, and upon significant match may promote the linked activity to the user.

### Triggering Automated Notification of a Group Activity

In one embodiment of the present invention, a user may configure one or more special conditions that when detected may trigger automated notification of a group activity.

Referring now to FIG. 4, user notification application 405 is leveraged to provide certain notifications to users that certain other users being followed are joining or expressing an interest in joining certain activities. In this embodiment the notification application provides such notification based on monitoring of user participation states for certain activities. In this case the conditions that trigger automated notification are detected states of participation relative to other users the operating user is following. The notification may also be made for certain activities being followed.

Referring now to FIG. 21, user notification application 2105 is adapted to provide notifications to users of price adjustments relative to a pending group activity for which the users are signed up to participate or are following. In both cases a notification is provided to one or more users based on conditions that may occur relative to user participation states and price changes made to an activity before it is scheduled to occur.

User-notification application 405 and 2105 (analogous) may also be adapted to initiate automated “sign on” to an activity based on one or more special conditions, that if detected during monitoring or data collection may cause the application to commit a user to a group activity based on the existence of one or more special conditions. A special condition may be that user A has joined a particular group activity in which the operating user is interested. When the system detects the joining of user A to the specified group activity it may call up an application for joining the same activity and may fill the application and submit the application to join on behalf of the user. The notification application may also provide notification to the user that he or she has been automatically signed up to join an activity based on one or more special conditions set by the operating user are true in the system data.

In one embodiment user may elect to follow one or more pending activities or one or more activity types that are known to the system and are pending in the system or otherwise have not yet occurred. The system may add the operating user as a follower of an activity or more broadly, an activity type. In this regard the user may specify the activities or types of activities to follow. By adding the identification of the following user to the data associated with one or more activities or activity types, the system may check status of the activity relative to interested individuals and individuals signed on to participate on behalf of one or more operating users who are following.

The operating user may utilize an interface analogous to interface 406 of FIG. 1 to set any special conditions that may trigger automated sign up of that user to participate in a group activity. For example the operating user may configure a rule or more than one rule that governs triggering of automated joining of an activity. For example an operating user may specify for a followed group activity that if user A and user C join the activity, then they too will be automatically signed up to participate. In one example a user A and a user B may have both declared that when the other user joins an activity, then the other will be automatically signed up for the activity. The data submitted includes at least the identity of the users whose actions are pivotal for the user to be signed on by proxy.

An operating user might specify more than one condition or a combination of conditions that must coexist for the system to act to sign up the operating user to participate. For example a condition set by an operating user for activity X (followed activity) may be one wherein, if user C joins and the overall gender mix for the activity includes 50% or greater females to males, then the operating user may request to be automatically signed up to join the activity. As a follower of the activity the operating user is known in the data associated with the activity as a follower. Therefore the special conditions that would trigger automated join of the activity are submitted with the user request and stored with the activity participation data.

Activities may be monitored for current participation data periodically. Each time there is new data, the system may access that data and determine if any users following the activity need to be signed on based on the satisfaction of one or more special conditions set by that user.

In addition to signing up an operating user to a followed activity based on the special condition requirement, the notification application may also notify the use of the incident and the fact that the user is scheduled to participate in the activity. The user may also give permission for the system to update remote and or locally-held calendar information to reflect the registration of that user to participate in a group activity based on the special condition or conditions coming true before the activity is scheduled to occur.

In another embodiment the process of configuring special conditions for signing on to an activity may not be specific to any one activity. In FIG. 4, the operating user may follow people instead of activities, as depicted by options 407 and 408. In this case, the user may include one or more special conditions, such as a condition wherein when the followed individual joins an activity, the operating user may request to be automatically signed up to join the same activity. A more complex condition that might be created by the operating user may be wherein if followed users A and D, but not C, join a same activity, the operating user may request to be automatically signed up to participate in the activity. In this case the operating user does not know ahead of time what the activity is, but has committed to join anyway based on the conditions being satisfied.

In a case where an operating user is following a group activity conditions not specifically related to followed users might also be set for triggering automated signing of the user to the activity. For example, conditions may be set on certain gender ratios, certain attendance numbers, education level, and other user or group profile attributes. In one embodiment instead of automatically joining the group activity based on the satisfaction of the special condition or conditions, the operating user may simply trigger an automated notification whenever the special conditions are satisfied relative to the other users and activities the operating user may be following.

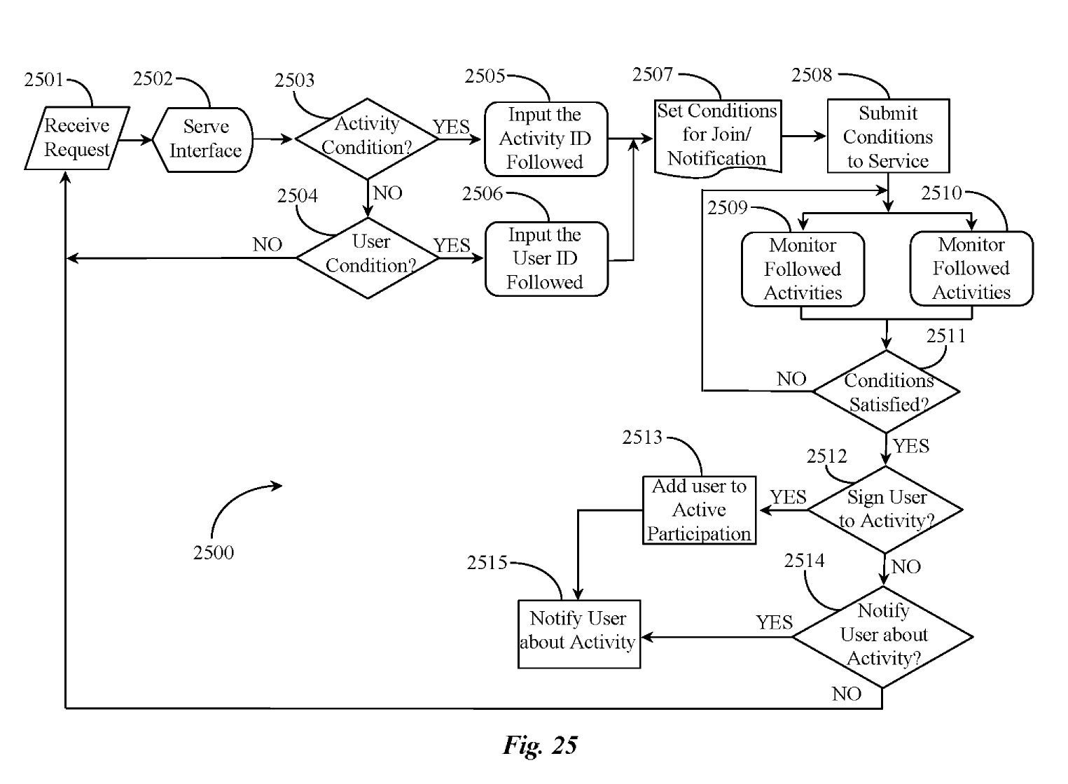

FIG. 25 is a process flow chart 2500 depicting steps for triggering automated registration for or notification of a group activity. In step 2501 the system may receive a request from a user operating from a connected network-capable appliance, the request to configure one or more special conditions for triggering automatic join or notification of a group activity. At step 2502 the system serves an interface for enabling the requesting user to configure special conditions upon which if true the user would join an activity. In this example, the interface is server hosted and accessible over the Internet network.

The interface served at step 2502 includes at minimum a text input field for accepting user input and a submission button allowing the user to submit the input. In one embodiment the interface is part of the user interface that enables multiple functions including the setting of special conditions that would trigger an automated joining and or invitation to a specific activity. In one embodiment the interface includes one or more categories of following other users in the system and following activities in the system.

In step 2503 the operating user may determine if one or more special conditions will be tied to a specific activity the user is following. If at step 2503 the operating user determines not to configure one or more special conditions tied to a specific followed activity, the process may move to step 2504 where the operating user may determine if one or more special conditions will be tied to a user that the operating user is following. If the operating user determines at step 2504 that the one or more special conditions will not be tied to a user that is being followed, then the process may end for that user, the process resolving back to step 2501 to process a request from another user.

If the operating user determines at step 2503 that one or more special conditions will be configured and tied to an activity that the user is following, the process moves to step 2505 where the operating user may input the activity identification (ID) of the activity being followed to which the conditions will be associated. Likewise, if at step 2504, the operating user determines that one or more special conditions will be configured and tied to a user that the operating user is following, the process moves to step 2506 where the operating user may input the user identification (ID) of the user being followed to which the conditions will be associated.

In one embodiment the operating user may determine positively for both determination steps, configuring special conditions that may be tied to one or more followed activities and one or more followed users. In this case the operating user may input both the identifications of the activities and users into the text input field. At step 2507 the operating user may set special conditions for automatic joining of an activity and/or notification of the activity that is ultimately associated with the occurrence of those special conditions.

In one embodiment at step 2507 one or more special conditions for triggering automatic sign up for a pending group activity may be selected from a menu of special conditions. In another embodiment the operating user may simply type in the special conditions into the text input field using natural language typing. At step 2508 the operating user may submit the input data to the service through the interface and connection to the server over the Internet.

The process then moves to step 2509 or to step 2510 depending upon what the operating user has done in previous steps. In one embodiment where the operating user has submitted one or more special conditions relative to a followed activity, the process moves to step 2509 where the system begins monitoring the followed activity on behalf of the user. The fact that the user is following the activity allows the system to associate the user to the activity and monitor the activity for the occurrence of the conditions tied to that activity, which were submitted by the following user.

In an embodiment where the operating user has submitted one or more special conditions relative to a followed user, the process moves to step 2510 where the system begins monitoring the followed user on behalf of the operating user. In this embodiment the one or more special conditions are not associated with any specific activity until the followed user takes some action that satisfies the one or more special conditions, whereupon the activity is then identified and becomes a target of automatic join and/or automatic notification on behalf of the operating user.

In one embodiment where the operating user has submitted input that includes conditions associated with a followed activity and a followed user, the process may undertake steps 2509 and 2510 simultaneously on behalf of the operating user. The system may monitor followed activities periodically or continuously until the activity has occurred. The system may monitor followed users periodically or continuously until the followed users take some action that satisfies the one or more special conditions set by the operating user.

In both described monitoring states the system makes a determination at step 2511 whether the special conditions monitored for in steps 2509 and 2510 have been satisfied. For example for an activity being followed, a special condition might be created by the operator wherein if the user participation list reaches 30 individuals, the operator would be automatically signed up to participate in the activity. Another condition that may trigger automatic registration to participate in an activity might be when the price for participating in the activity dips to twenty dollars or below. For a followed user a condition that might trigger automatic registration may be when user A and user B both sign up for an activity.

If at step 2511 the system finds through monitoring that the condition or conditions set by the operating user are not satisfied, the process may resolve back to monitoring steps 2509 and or 2510. If at step 2511 the system finds through monitoring that the condition or conditions set by the operating user are satisfied, the process moves to step 2512, where the system may determine if satisfaction of the conditions results in automatic registration of the user to participate in the group activity identified. If the system finds that satisfaction of the conditions results in automated registration to the group activity, then the system may register the user to participate in the activity and adds the user identification to an active list of participants at step 2513.

If the system determines that satisfaction of the condition or conditions do not result in automatic registration of the user to participate in the activity, the process may move to step 2514 where the system may determine if satisfaction of the one or more conditions results in automated notification about the activity to the operating user. It is not required that the user agree to automated registration to an activity in order to practice the present invention. The user might simply require notification of the activity at such time that conditions set by the user have been satisfied.

Referring now back to step 2513, once the user is registered to participate in a group activity as a result of satisfaction of one or more pre-configured conditions, the process moves by default to step 2515 where the system sends notification of the activity to the operating user. If the operating user has elected not to be automatically registered to participate in a group activity based on satisfaction of the one or more special conditions, then the process moves directly to step 2515 bypassing step 2513. If the system finds that the user has not indicated to receive at least one of the responses (auto join; auto notify), then the process may end for that user with an error message before resolving back to step 2501 for taking a next request.

In an embodiment where the system automatically registers a user to participate in an activity the user might be notified about a tentative registration contingent on the user resolving any scheduling conflicts that may exist relative to the time and date that the activity is scheduled to occur. In one embodiment the system may check the schedule and or calendar of the operating user to determine if auto registration results in a data conflict with another user commitment, such as existing registration to participate in another activity. The system may present these conflicts to the user for resolution if they are found in the system.

In another embodiment the automated registration is considered a priority and any conflicts may be automatically resolved by the system, such as automatically canceling competing commitments already made by the operating user before auto registration. Notification of such actions performed for the operating user may be sent to that user as actions are taken. The operating user may have an opportunity to manually reset such changes made by the system in one embodiment.

### Notification Engine

In one embodiment a notification engine is provided to give notifications and alerts to users based on a variety of conditions resulting from attribute matching, system activity, or according to user-specified conditions.

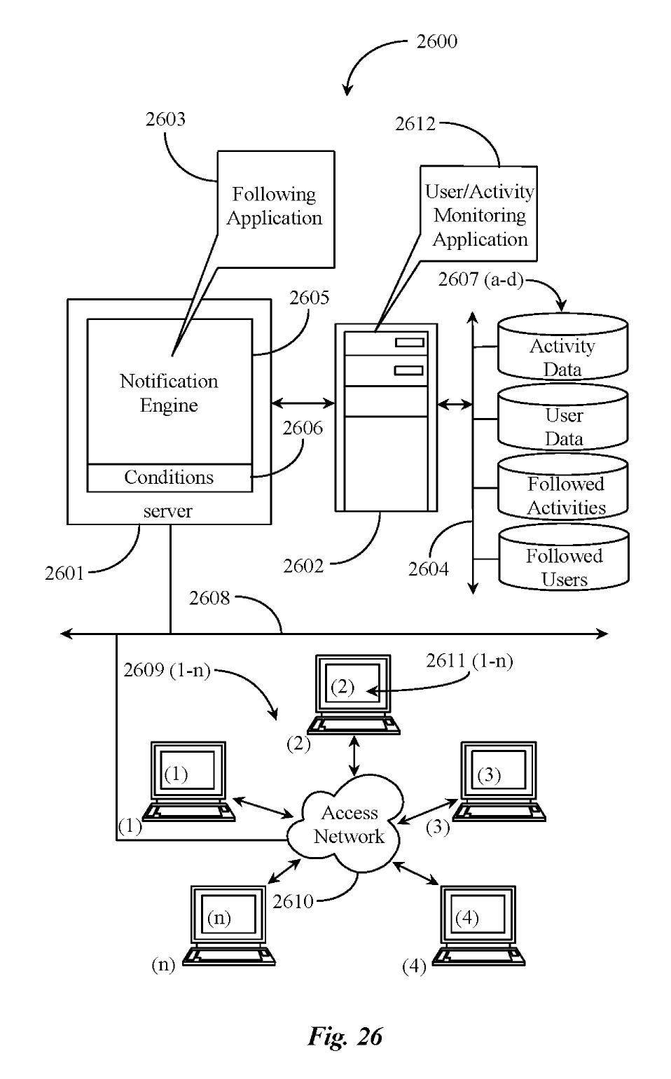

FIG. 26 is a block diagram 2600 depicting basic components for providing automatic notification, which may include invitations to users of pending activities. Diagram 2600 depicts an Internet network represented herein by an Internet backbone 2608. Internet backbone 2608 supports a server 2601. Server 2601 may be analogous in description to server 107 of FIG. 1. Server 2601 hosts a notification engine 2605. Notification engine 2605 is adapted to provide automatic notification to users represented herein as users 2609 (1-n). Notification engine 2605 may be configured to provide automated notification to users of pending activities according to a variety of conditions represented herein as conditions 2606. Notwithstanding, one of the main functions of notification engine 2605 is to provide automatic notification to a user whenever that user has been matched to a pending activity due to profile matching. Notification engine 2605 may be part of or integrated with GCAPP 109 of FIG. 1.

Server 2601 has direct access in this example to a data server 2602 such as over a local area network (LAN), data link, or over the Internet in one embodiment. Server 2602 has access to one or more data repositories 2607 (a-d). Repositories 2607 (a-d) are supported on a data network 2604, which might be a LAN network or some other internal network. In this example, categories of data are separated in several data repositories for illustrative purposes only. In actual practice the data may be aggregated in a single data repository without departing from the spirit and scope of the present invention.

Data repositories 2607 (a-d) include one for containing activity data 2607 (a). Activity data includes all of the recorded data about activities that are in the system whether those activities are scheduled for occurrence or not. Repository 2607 (b) contains user data including all of the recorded data about users registered with the service of the invention. User data includes personal profile data and group profile data attached to user accounts. Repository 2607 (c) contains data about activities that are being followed by users. Repository 2607 (d) contains data about users that other users are following. Data about followed activities and followed users is recorded by a monitoring application 2612 hosted on data server 2602 in this embodiment. Application 2612 monitors activity states and user/activity states of those activities and users being followed in the system by one or more users. Data aggregated by application 2612 is deposited in the repositories 2607 (a-d).

Server 2601 supports a following application 2603. Following application 2603 is adapted to receive updated data in cooperation with user and activity monitoring application 2612. Following application 2603 works with notification engine 2605 to provide automated updates or notifications to users who are following certain other users and activity states. A profile-attribute matching engine (not illustrated) provides notification engine 2605 with the identifications of individuals whose personal profile attributes match submitted group profile criteria that have been submitted for the purpose of aggregating potential activity participants to be invited to participate in the activity.

Users 2609 (1-n) represent users that are registered with the service of the invention. Users 2609 (1-n) are assumed in this embodiment to be connected to server 2601 through an access network 2610 and the Internet 2608. Each of users 2609 (1-n) has an instance of user interface 2611 (1-n) in display on their respective appliances. Interface 2611 (1-n) may receive notifications from notification engine 2605 over Internet 2608 and through access network 2610.

Notification engine 2605 may provide various types of notifications and alerts based on conditions 2606. For example, a user 2609 (1) may request notification about activities of any other user being followed by the user receiving the notification. One example is when a user being followed signs up to participate in an upcoming activity. In this case notification engine 2605 provides an alert that the user has just signed on to participate in the activity. The notification may include details about the activity and a mechanism for the following user to sign up as well.

In one embodiment notification engine 2605 provides automated notifications to users whenever those users have been matched by the system to a pending activity based on profile attributes. In this embodiment a user, such as one of users 2609 (1-n), may receive the notification that they are matched to an activity and are invited to participate in the activity. The notification may be in the form of a message, a pop-up, a post, an email, or some other communication. Interface 2611 (1-n) is uniquely adapted to receive such notifications, however notifications might be received using other media without departing from the spirit and scope of the invention. In one embodiment notification engine 2605 may send notifications to user interfaces like personal profile pages the users maintain on social media sites. The notifications include at least the activity type, activity details, activity schedule information, and the activity location.

In one embodiment, notification engine 2605 may include logic for prioritizing notification processing and sending for many users. For example notification engine 2605 may prioritize notifications and alerts by activity schedule with those users receiving notifications first for activities that are closer to occurring. In one embodiment notification engine 2605 includes logic for predicting positive response rates for user acceptance of automated invitations to activities, and may adjust the number of invitations sent accordingly. For example, if it is predicted that 20% of 20 invitations will be declined or ignored, the notification engine may stack more invitations to compensate. Likewise, the engine may also include logic for re-considering next available matches that might have been below a specific threshold in light of a sparse acceptance rate for invitations to a group activity for those users matching at or above the threshold.

In one embodiment a search engine working in conjunction with a matching engine may provide a list of users that match a specific group activity as potential participants to be invited to the activity. In this case, the requesting user may edit the search results and then submit them to the notification engine for automatic invitation to all of the users still on the list. In one embodiment, whenever a requesting user creates an activity, that user might order automatic invitation to a specific list of users that are invited every time the user creates a group activity. In one embodiment notification about a pending activity may include interactive indicia for joining the activity and for expressing interest in following the activity. In the latter case the user may schedule periodic notifications about the activity up until the activity occurs.

### Filling Vacancies for Activity Vendors

In one embodiment activity vendors may host or sponsor group activities that may be fulfilled in terms of aggregating participants by the service of the present invention.

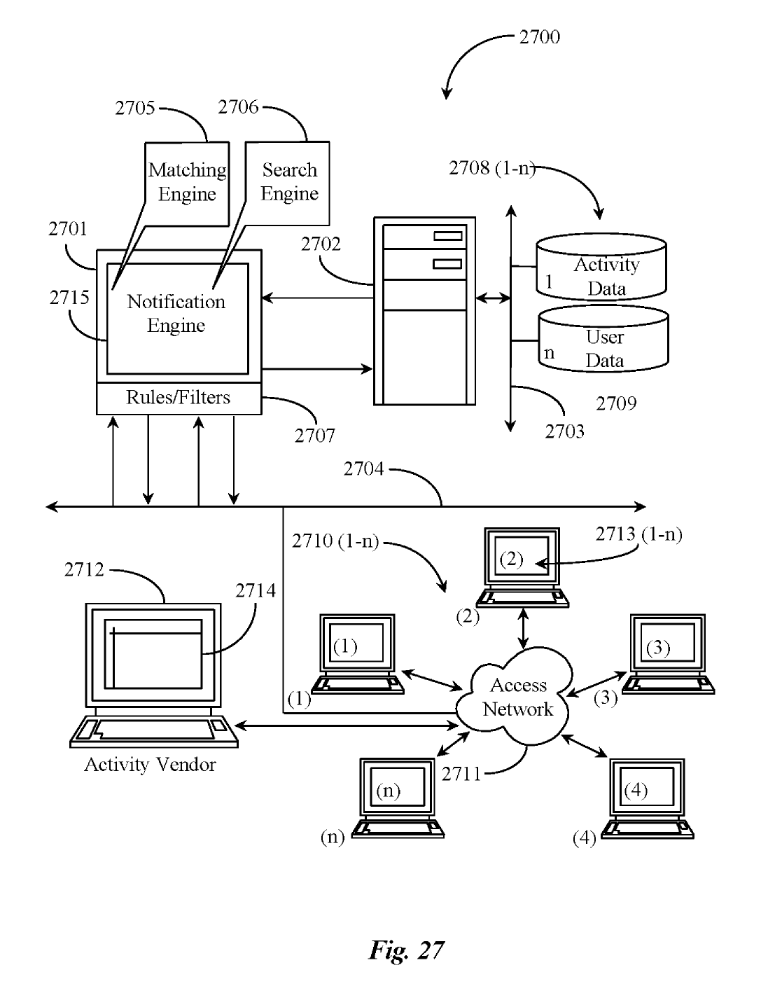

FIG. 27 is a block diagram 2700 depicting basic components for fulfilling vendor requirements in vendor-hosted or sponsored group activities. Diagram 2700 depicts an Internet network 2704 which represents all the lines, equipment, and access points that make up the Internet network as a whole including any connected sub-networks. Internet 2704 supports a server 2701. Server 2701 may be analogous to server 107 of FIG. 1. Server 2701 is accessible over Internet 2704 from an access network 2711. Access network 2711 provides Internet access to users represented herein as users 2710 (1-n). Access network 2711 may also provide Internet access to activity vendors such as an activity vendor 2712.

Activity vendor 2712 may represent any business that hosts and/or sponsors group activities. Different activity vendors may provide different types of group activities. In this embodiment users 2710 (1-n) may be assumed connected to server 2701 through a user interface represented herein as interface instances 2713 (1-n). Activity vendor 2712 may also be assumed connected to server 2701 through a vendor interface 2714. Vendor interface 2714 may include one or more application program interfaces (APIs) adapted to integrate the vendor's online service application with the service of the present invention. Activity vendor 2712 may host or sponsor group activities for which a fee or cost is required to be paid to participate. Activity vendor 2712 may leverage the service of the present invention to promote and help fill vacancies in group activities hosted or sponsored by the vendor.

In one embodiment activity vendor 2712 hosts or sponsors one or more group activities for which there are few if any requirements for user participation. In some cases group activities are made available to potential participants on a conditional basis, for example participants must be 21 if alcohol is served. Vendor 2712 may, through API and interface 2714, upload rich activity data to server 2701 describing a group activity and any other data about activity requirements such as cost to participate, minimum and or maximum age of participants, schedule information, and duration of the group activity. Activity vendor 2712 may not particularly care about who participates in a group activity as long as they meet minimum requirements and can pay activity fees.

Server 2701 hosts a notification engine 2715 that is adapted to provide notification to users 2710 (1-n) of activities pending in the system, including any activities sponsored or hosted by activity vendors. In one embodiment, activity vendor 2712 may be a third-party activity vendor that brokers between the service and a number of activity-related businesses that have available group activities for promotion. Notification engine 2715 may be part of or integrated with GC APP 109 of FIG. 1. Server 2701 also hosts a matching engine 2705 and a search engine 2706. Matching engine 2705 and search engine 2706 may also be integrated with or part of GC APP 109 of FIG. 1.

Server 2701 has access to a data server 2702. Server 2702 is adapted to serve data upon request or query. Server 2701 is adapted to serve data about activities stored in a data repository 2708 (1) labeled activity data. Server 2701 may also serve data relative to users registered with the service of the present invention. Activity data may include activity titles, activity descriptions, activity requirements for participation, activity schedule data, and other related information about the activity. Server 2701 may also be adapted to serve data about users stored in a data repository 2708 (n) labeled user data. User data includes user identification, contact information, schedule information, personal profile data, group profile data, and activity profile data. Data repositories 2708 (1-n) are accessible over a LAN 2703. They may also be accessed by direct data link or may be internal to server 2702.

Activity vendor 2712 may register with the service of the present invention for the purpose of fulfilling any vacancies relative to activities the vendor is offering. An activity vendor may offer group activities such as cruises, ski trips, white water rafting, horseback riding, and other types of group activities that generally require a minimum number of users and a minimum fee for participation. Activity vendor may upload rich activity data to server 2701 through interface 2714. Server 2701 may use the activity description data as search criteria to search for any same or similar activities that might be known to the system using search engine 2706. In this way, through one or more search queries, server 2701 may access data about existing activities, pending activities, and past activities from data server 2702.

Group activity data may include identification of any past, present, or future participants related to the group activity. The system might, in one embodiment, access such a list or lists of identified users to form a target base for filling the vendor-sponsored activity. The similarity of the activities may prove beneficial to the system in the prospect of promoting the activity over the network on behalf of the activity vendor. Users who already are linked to very similar group activities may be more likely to register to participate in the vendor-sponsored activity.

In one embodiment the service may generate a group profile from activity data relative to the description about any requirements of users for participating in the group activity. For example, if the group activity is horseback riding, it is probable that the activity vendor might require that participants have basic riding skills and are between certain age maximums and minimums to qualify to participate. The generated group profile might be tied to the group activity and used as criteria in matching the profile attributes to personal profile attributes of users held in data repository 2708 (n) leveraging matching engine 2705.

For group activities sponsored by third-party activity vendors the dynamics of the group that participates in the activity may be a lot less stringent than the dynamics of a group culled from group profile matching as described further above in this specification. This is because the group activity is not hosted by a user looking for participants having certain traits that the user desires in interaction with the group. However, certain user traits may none-the-less be important in promoting vendor-sponsored group activities, especially those that are repetitively held and involve sales of certain products, raising funds, certain education requirements, professional expertise, etc.

Notification engine 2715 provides timely notification to users 2710 (1-n) who may be matched to a vendor-sponsored group activity. Notification engine 2715 may send invitations to users 2710 (1-n) to participate in a group activity sponsored by an activity vendor. Notification engine 2715 may include various rules and filters 2707 to aid in focusing on a target user group invited to the activity. A filter may include a geolocation threshold as a requirement for invitation to the activity. Filters might also be provided to filter out users who match attributes for the activity participation but may have other issues with which the activity vendor does not want to deal. For example the user has a history of non-payment of activity fees in the past, or, the user is a business rival of the activity vendor.

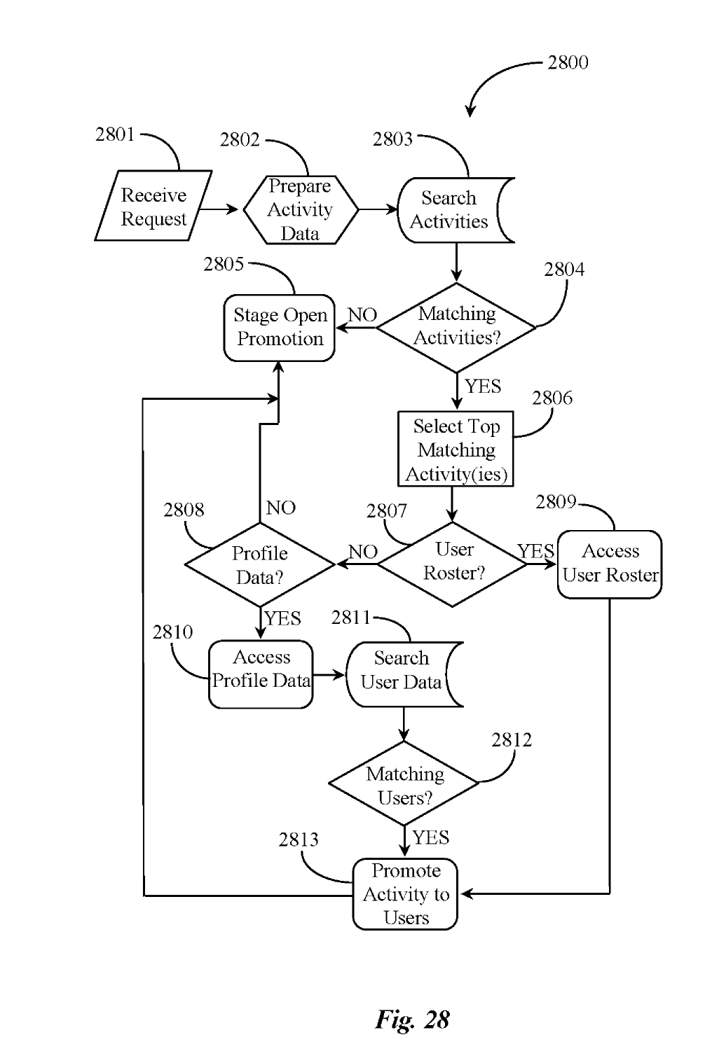

FIG. 28 is a block diagram depicting steps for fulfilling group activity requirements for third-party vendors. At step 2801 the system might receive a request from an activity vendor to promote a group activity on behalf of the vendor. The request may include rich activity data that fully defines and describes the activity and all of the related data such as scheduling data. In one embodiment the activity vendor is a user registered to use the service of the invention and may be enabled to create a group profile that the activity vendor might attach to the activity data.

At step 2802 the system may receive the activity data from the activity vendor including any group profile data attached to the activity data. Depending upon the activity type it may be important to the activity vendor that participants have certain traits, skills, and other characteristics that may be required or desired of potential activity participants. At step 2802 the system may create an activity profile of the attributes that describe the activity and may use these attributes in a search operation to search for the same or similar activities that have been promoted by the system in the past or that are currently known to the system, such as pending activities that are scheduled to occur and that might have users signed on to participate.

At step 2803 the system, with the aid of search engine 2706 of FIG. 27, may search for activities that match the activity profile used as search criteria. In one embodiment the activity vendor or the system may impose a preset matching threshold for the level of match of activities to the vendor sponsored activity.

At step 2804 the system may determine whether or not any matching activities were found that match the vendor-sponsored group activity subject to the data search. If at step 2805 the system determines that there are no activities that match the vendor-sponsored group activity, the process might skip to step 2805 where the system may take the course of an open promotion. An open promotion seeks to promote the activity to any available user known to the system.

If the system determines at step 2804 that there are activities that match the vendor-sponsored activity, then the system may select the top matching activity or activities at step 2806. By selecting activities that match, the system has access to all of the data about the selected activities. At step 2807 the system may determine if the activity data associated with the selected activities includes a user roster or rosters of identified participants. A roster may include participants that have participated in a group activity in the past or participants that are slated to participate in an activity still to be held or scheduled.

If the system determines that there are no user lists or rosters associated with the selected activity or activities, the process may move to step 2808 where the system may determine if there is any group profile data associated with the selected activities. The selected activities may have one or more group profiles that list the attributes of users who would most likely participate in the activity or that have participated in similar activities in the past. If at step 2808 there is no profile data associated with the selected activities, the process may resolve back to step 2805 where the system may stage an open promotion as described further above.

If at step 2807 the system determines there are one or more user rosters attached to the selected activity or activities, then the system may access the data in step 2909. In one embodiment the process may move directly to step 2913 where the system promotes the vendor-sponsored group activity to the users found in the user roster or rosters. Users who have a track record of participating in the same or a similar activity may have a higher likelihood of accepting an invitation to participate in the vendor-sponsored activity.

If at step 2808 the system finds that there are one or more group profiles attached to the selected activity or activities, then the system may access that data in step 2910. The system may search user data at step 2811 using the group profile as search criteria. At step 2812 the system may determine if there are any matching users whose personal profile attributes match the group profile data.

If the system determines that there are no matching users, or in one embodiment, an insufficient number of matching users at step 2812, then the process may resolve to step 2805 where the system stages an open promotion. If the system determines that there are matching users at step 2812 then the system may promote the activity to those matching users at step 2813.

For a vendor-sponsored group activity, there may be certain benefits to users who are registered with the service of the present invention. For example, participants may receive discounts, membership, and other perks that might be redeemed or realized through redirecting participants to a server operated by the third-party activity vendor. Such connections might be supported through the interface used by registrants to the service of the invention where APIs to third-party applications might be provided to those who participate in service promoted group activities on behalf of those vendors.

### Auto-Mitigation of Conflicting Time Slots

In one embodiment of the present invention an automated scheduling assistant is provided to resolve issues where a same individual is scheduled to participate in two or more activities that overlap in terms of scheduled occurrence of the activities.

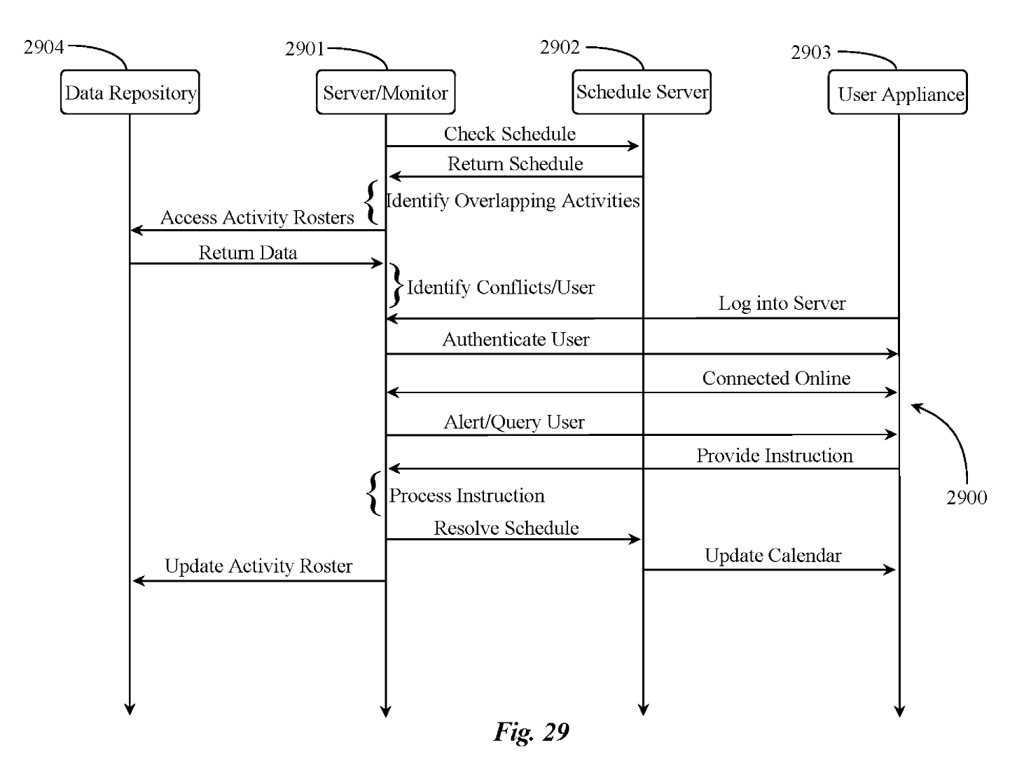

FIG. 29 is a sequence diagram 2900 depicting interaction between basic components integral to a system for managing conflicting user participation time slots for overlapping activities. Diagram 2900 includes a server 2901 running a monitoring application adapted to monitor for group activities that have overlapping time slots. Server 2900 may be analogous to server 107 of FIG. 1. A schedule server 2902 is provided and is adapted to maintain scheduling information for users participating in group activities. Scheduling server 2900 includes a processor and access to at least one data repository, the processor containing all of the data and instruction required to enable function as a scheduling server.

When a group activity in the system is scheduled to occur, scheduling server 2902 registers the group activity schedule and maintains any updates or changes to the group activity schedule. In one embodiment a user represented herein as a user appliance 2903 may log into server 2902 and view a group activity schedule including time slots that the user is scheduled for relative to activity participation. A user may sign up to participate in group activities that are scheduled and that are not yet scheduled due to a requirement to meet certain conditions before scheduling can occur.

In some cases users who sign on or otherwise commit to participating in more than one group activity can run into a conflict with group activity schedules. For example a user A may be committed to participating in a first group activity that is already scheduled. The same user may also sign up to participate in a second group activity that is not yet scheduled to occur. It is possible that the second group activity will be scheduled during the same period as the first activity. The group activities may occur at the same time or may have overlapping time slots.

In one embodiment of the invention, server 2901, with the aid of a monitoring application, may monitor schedule server 2902 for group activities that are scheduled to occur on the same date where the time slots allotted for the activities overlap one another or are identical. In one embodiment monitoring may be continuous or it may be performed periodically in another embodiment. In this example server 2901 communicates with server 2902 periodically, such as every hour, to access scheduled group activities with overlapping time slots. Server 2901 might access schedule information for a day, a week, a month, or some other arbitrary period. Server 2902 may provide access to the data or may return the data to server 2901 as the result of a query.

Server 2901 identifies all of the group activities that have overlapping schedules. Server 2901 may access activity rosters for the conflicting activities from a data repository 2904. A data server connected to the repository may return the roster data to server 2901. Server 2901 may identify, through data processing of the roster data, any users listed as participants in two or more of the conflicting group activities. When the identified participant logs into server 2901 and is authenticated and is connected online, server 2901 may send an alert with a query to a participant that has a scheduling conflict.

The alert simply informs the user that there are one or more conflicting items in the scheduling data relative to group activities in which the user is scheduled to participate. The alert or notification may be in the form of a pop-up, an email, a text message, a posting, or some other communication directed toward the user. In one embodiment the notification or alert includes a query or prompt for that user to provide some instruction as to what the user or the system should do toward resolving the conflict. For example there may be sent an interactive menu to the user that contains two or more options for resolving the conflict. In this case the user may select one of the presented options thereby providing instruction back to the server as to what to do to resolve the issue. In this case the user sends instruction back to the server. The server then processes the instruction.

In one embodiment the menu sent in the alert or notification simply provides two options for the user to consider. One option may instruct the system to resolve the issue automatically based on information known by the system about the user, the activity, and the scheduling issue. Another option may instruct the system to do nothing and allow the user to make manual edits to resolve the issue. In one embodiment an option may be available that involves actions by both the user and the system. For example, user A may be committed to participating in two group activities that share an overlapping time slot. In one embodiment, where it is not possible for the user to attend both activities, the system might ask the user in which group activity they prefer to participate.

Alternatively, if the system determines that the user could potentially participate in both activities save for the overlapping portion of the time slots, the user might be required to indicate if this is desired or if the user wishes to cancel participation in one activity. Therefore the user may indicate a priority relative to participation in one of the overlapping group activities or participation in two or more of the conflicting group activities. Once the system receives input from the user, the system may take that information and execute the rest of the resolution to the conflict.

In conflict resolution the system may update the scheduling information in scheduling server 2902 according to the conflict resolution data. This may include canceling participation in a group activity on behalf of the user. This may also include rescheduling the participant for portions of the time slots allotted for more than one group activity. In this case the scheduling server may provide time-based alerts to the user during participation in a first group activity, such as when to depart for the next group activity, in order to make a portion of the time slot for that next group activity.

Once server 2902 is updated the server, aided by a scheduling application, may update a calendar application on the user's end device with the resolved scheduling data. Server 2902 may also make any adjustments to the activity rosters attached to scheduled activities, such as removing a user from the roster, or, if enabled, adjusting the roster to indicate user participation, but for a time period that is smaller than the total time-slot for the group activity.

In an embodiment that may be fully automated, the system might use all the information about the activities and about the user to make a determination on behalf of the user which activity to participate in and in which activity to cancel participation. For example if the user has a group of friends participating in one activity and no friends participating in another for which the user is scheduled to participate, then the system may by default choose the activity that according to the data, most favors the user.

In another example of this one activity may be ranked higher than another in the user's activity profile data. Therefore, the system may select the activity that has higher priority to the user and cancel the user's participation in the lower-priority activity. If there are no ranking data for activities and no indication of friends participating in either of the conflicting activities, the system might then determine from group profile attribute matching described further above, which activity has a participating group that more closely matches the user's group profile. Other variable might be compared as well such as cost factors, geolocation factors, etc.

In one embodiment, where the system makes an adjustment in scheduling, such as canceling participation of the user in a group activity, the system may also update other users who might be following that user, or who are network friends with that user. In one embodiment, wherein the participant is the host or creator of a group activity that they will not participate in, the system may ask the user to turn the activity over to another host so that the activity may occur without the original host or creator.

### Unscheduled Group Activities

In one embodiment of the invention group activities may be created in an unscheduled state and may then be managed in the system with no schedule.

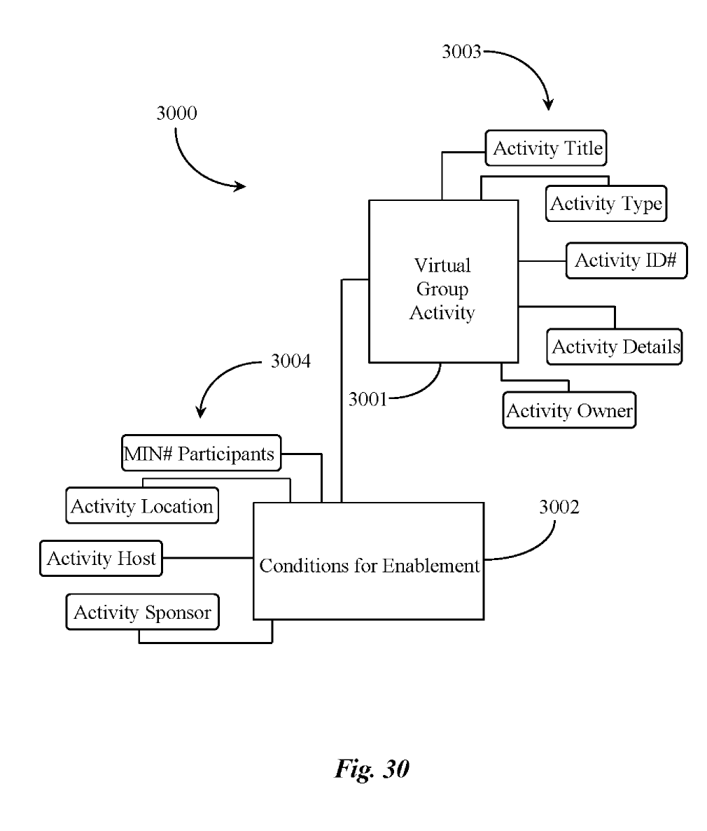

FIG. 30 is a block diagram 3000 depicting an unscheduled group activity. Diagram 3000 depicts an unscheduled group activity 3001 including basic attributes 3003, which may be associated with the group activity 3001 during creation of the activity and registration of the activity within the system of the invention. Unscheduled group activities may be created by a user, a third-party activity vendor, or the system without departing from the spirit and scope of the present invention.

Basic attributes 3003 may include a title or name for the activity. The title may be searched in order to find the unscheduled activity and other unscheduled activities having the same or similar title. A title might be Olympic Pool Swim Meet. Unscheduled activity 3003 may include an activity type. An activity type more generically classifies the unscheduled group activity by activity type. For example, swimming may be an activity type that is broader than the title of the activity. The fact that the activity is unscheduled may also be part of the classification of the activity in the system. Each unscheduled activity created has an unscheduled activity identification number. An identification number for an unscheduled group activity is unique to that activity and distinguishes the activity from all other activities in the system. In one embodiment the identification indicia used for unscheduled activities is different than identification indicia used to identify enabled group activities.

Activity attributes 3003 include activity details. Activity details may include any pre-known requirements for participating in the activity should the unscheduled activity become an enabled activity. Activity details might not include details that are common to an enabled activity like scheduling information, location information, exact cost or participation fees, or other such details that may not be available until the activity becomes an enabled activity. Attributes 3003 include the owner identification for the unscheduled activity. The owner may be analogous to whoever created the unscheduled activity and submitted the unscheduled activity for system registration.

Unscheduled group activity 3001 may have certain conditions 3002 listed with or otherwise associated with the unscheduled group activity that must be met before the unscheduled activity may become an enabled activity that can be scheduled to occur. Conditions 3002 may include, but are not necessarily limited to certain attributes that would have to be realized before the activity could be scheduled to occur. Attributes 3004 may include a minimum number of participants that have pledged to join the unscheduled activity if enabled. For example, if a minimum of twenty users have pledged to join an activity once enabled or before the activity is enabled, that condition may be considered met for enablement of the unscheduled activity.

Attributes 3004 may include an activity location. For example, the owner of an unscheduled activity may not know where the activity may be held and may have to secure a location before the activity may be enabled in the system. A music event needs a venue before it may occur, so a virtual music event is the activity that does not yet have a venue. Once the venue is found, such as a city that will allow the activity in a city park, for example, the activity might be enabled. Other attributes 3003 that might fall under conditions 3002 may include identifying a host for the activity or one or more sponsors for the activity.

There may be other attributes not listed herein that may be required before an unscheduled activity may be enabled without departing from the spirit and scope of the invention. For example the creator of the activity might specify both a minimum number of pledges of participation and that the number contains a specific gender mix before the activity may be enabled. In another example the creator may specify that a percentage of pledges reside within a specific geographic range from a proposed location for the unscheduled activity.

In one embodiment the system may, during promotion of the unscheduled activity, modify conditions or request modification of some conditions for enabling the activity if it appears that the activity will be abandoned otherwise. This decision may be undertaken by the activity owner. For example, a user may create an unscheduled activity with pre-conditions for enablement that are not realistic or otherwise have little chance of being met in a limited time frame.

An activity owner may be responsible for setting any pre-conditions that have to be realized before an unscheduled group activity may be enabled as a scheduled activity pending in the system. In one embodiment the system may make certain statistics available to those who may create unscheduled activity, the statistics collected over time and relative to the process of promotion and subsequent enablement of unscheduled activity as scheduled activities in the system. In this way users may gain experience in what types of conditions to set for a specific activity type.

An unscheduled group activity may be searched by users and may also be promoted to users in order to get the preconditions met for enabling the activity. In one embodiment the system may impose a time window for meeting preconditions to enable an unscheduled group activity in the system. In this sense an unscheduled activity may have a time to live (TTL) in the system before it is abandoned due to the inability during promotion of the unscheduled activity to meet certain preconditions that are set by the creator for enabling the activity.

Once all of the preconditions for enabling an activity are satisfied, the system may obtain the scheduling information for the activity from the creator and schedule the activity for occurrence. The system may, during activity enablement, retire the identification indicia for the unscheduled activity and give it a new activity identification number or indicia identifying it as a real activity promoted in the system. It is noted herein that a group activity that is not an unscheduled activity may still have one or more conditions that have to be met before scheduling the activity. For example, an event that is held every year may have a roster of users that have to agree when they are all available before the scheduling is done.

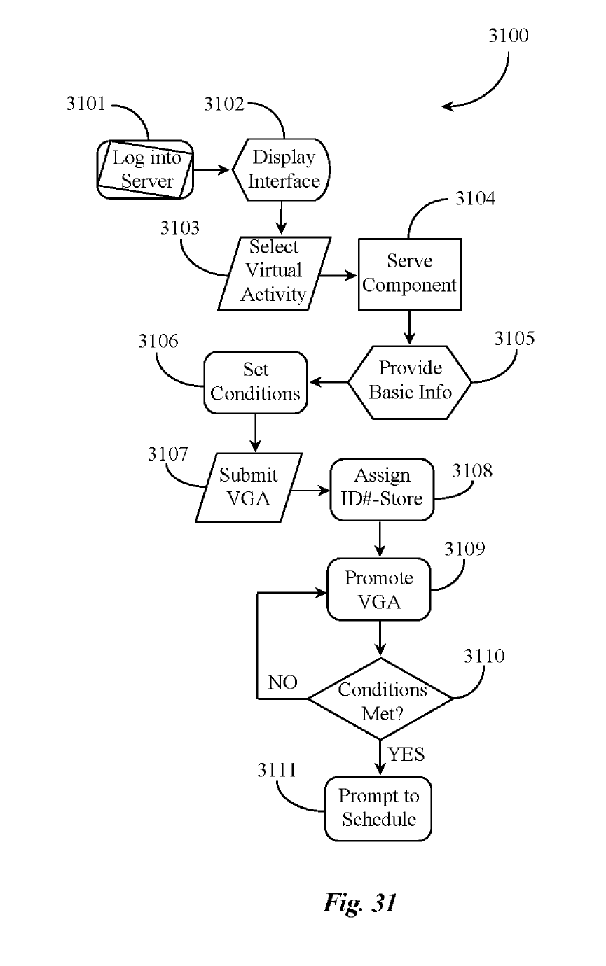

FIG. 31 is a process flow chart depicting steps for creating and filling requirements for enabling an unscheduled activity. At step 3101 a user may log into a server such as server 107 of FIG. 1 and access a user interface analogous to interface 115 of FIG. 1 displayed on the user's accessing appliance at step 3102. The interface may include an interactive option for creating an unscheduled activity, the option selected by the user at step 3103. The system may respond to the selection by serving an interface component for configuring and submitting the configured unscheduled group activity. In an embodiment where the system might create an unscheduled group activity, steps 3101 through 3104 may be eliminated. In this embodiment an activity vendor and a user are synonymous.

At step 3105 the creator of the unscheduled group activity may provide the basic attributes for the unscheduled activity. These attributes may be selected from a menu of attributes or they may be typed into a text input field. At step 3106 the creator may set one or more conditions that must be met before the activity will be enabled in the system, for example scheduled to occur. Conditions may be selected from a menu or may be typed into a text input field that is part of the interface component. At step 3107 the creating user may submit the unscheduled group activity (VGA) to the system for registration and promotion.

At the service location, the system may assign a unique identification number or indicia to identify the VGA in the system and may store the VGA for later access. In step 3109 the system promotes the unscheduled group activity looking for users that may pledge for a number of reasons to participate in the activity once it is an enabled activity. During promotion of the unscheduled activity the system attempts to get all of the preconditions for enabling the activity met. At step 3110, the system determines whether or not the conditions for enabling the VGA are in fact met satisfactorily.

If at step 3110 the conditions have not been satisfactorily met for enabling the VGA, the process may loop back to step 3109 where the system continues to promote the VGA. If at step 3110 the system determines that the preconditions for enablement of the VGA are met, the process moves to step 3111 where the system may prompt the connected user to schedule the group activity. If the system is the creator, step 3111 is not necessary and the system schedules the enabled event.

### Rating User Participation in Group Activities

In one embodiment the group curation application analogous to GC APP 109 of FIG. 1 includes a mechanism that enables users to rate the participation of other users that have participated in a group activity.

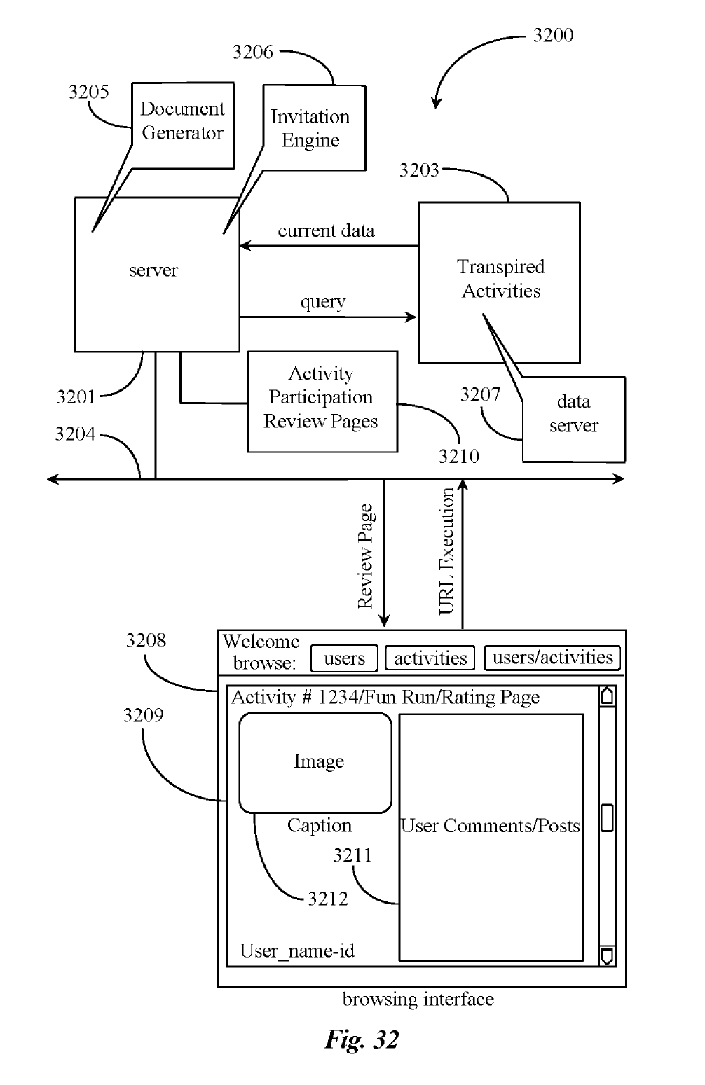

FIG. 32 is a block diagram 3200 depicting basic components for enabling user participation rating relative to a group activity. Diagram 32 depicts a server 3201. Server 3201 may be analogous to server 107 of FIG. 1. Server 3201 is accessible to users over the Internet represented herein by a network backbone 3204. Server 3201 has direct access in this example to a data repository 3203 adapted to store records of transpired activities. A record of a transpired activity may include all of the descriptive data about the activity including title, activity type, location, date transpired, number of participants, participant identifications, and similar information documenting the event. Transpired activity records 3203 may include some media associated with the activity such as promotional media including pictures and video.

A data server 3207 is provided and is accessible to server 3201, the server adapted to serve transpired activity data upon request from server 3201. Server 3201 may, during the course of normal server activity, access server 3207 periodically by query and request one or more transpired group activity records and any related information and media. Data server 3207 may serve current data relative to transpired activity records to server 3201 upon request or in a push mode without departing from the spirit and scope of the present invention. In push mode server 3207 may push current data when the number of transpired activities reaches a certain threshold.

Server 3201 supports a document generator 3205. Document generator 3205 is adapted to generate interactive Web-navigable documents with media to represent each of the group activities that have occurred in recent history. The interactive Web documents may be hypertext transfer protocol (HTTP) Web pages including wireless application protocol (WAP) pages for wireless devices. Various Web protocols might be leveraged to create or generate one or more versions of a group activity page for access by users. Document generator 3205 may include pictures with captions and other media that might be associated with a transpired activity.

Server 3201 may publish each generated Web document as an activity participation review page that includes a navigable universal resource locator (URL). Server 3201 may store generated Web documents in a data repository 3210 as activity participation review pages. As part of the document generation process server 3201 aided by generator 3205 may access the identifications of all of the users who participated in a transpired group activity and may give those users permission to interact with the generated Web document, including allowing them to make comments and upload pictures and video clips they might have taken during the activity.

Server 3201 supports an invitation engine 3206. Invitation engine 3206 is adapted to generate invitations to users who participated in the activities represented by the Web documents. The invitations may include instruction to visit the published Web documents and to interact with them in a social context, and to rate the participation of other users. Invitations may be sent to all users identified as active participants in a transpired group activity. The invitations may be in the form of an email, a text message, a posting, a pop-up, a notification or an alert. Rating participants of a transpired activity may be as simple as posting a few comments and perhaps uploading a picture or a media clip showing the user at the activity. Rating may be more complex, such as scoring other users participation in the activity. In one embodiment there might be a designed rating system that users might leverage to rate the participation of other users who attended the same activity.

In one embodiment server 3201 serves the published Web documents to users who are authorized by Web permissions and invitation to access the documents. Server 3201 may serve such documents to a browser interface 3208 running on a client device. The interface may be part of interface 115 described above with reference to FIG. 1. In one embodiment users who did not participate in a group activity represented by a generated Web document may still access and view the document by browsing the collection or pool of such documents using browsing interface 3208, but may not interact with the document, upload or download media relative to the document, or rate any user participation. However, enabling general access to the documents may provide feedback to a user who did not attend but is interested in attending a future activity of the same or similar type.

Interface 3208 depicts a Web document 3209 served to a client device by server 3201 upon URL request from the client device. It is assumed herein that the user received an invitation with a URL to access document 3209. In one embodiment each Web document contains personal review space for each user documented as an active participant in the transpired group activity. In this example document 3209 may be open to the personal workspace allotted for the invited user. The user name and identification number or other identifying information may be represented on the document in the space allotted for that user to post comments, upload media, etc.

Document 3209 includes a title (Fun Run Rating Page) with an activity number (1234). Document 3209 includes an allotted review section 3211 for the user to make posts or comments. In this example the user has uploaded an image and has inserted a caption for the image. In one embodiment users may be permitted to upload a limited amount of media including pictures and video up to a certain memory threshold or limit enforced for each user. In another embodiment users are not restricted and may continue to upload comments and media relative to their allotted section in the document. Alternatively users may be enabled to interact anywhere within the document. Uploads and posts may be documented as they log in to contribute according to an access timeline. Posts, comments and uploaded media may be time stamped and attributed to the contributing user.

In one example, a Web document may be generated that represents a beach party attended by several users. One user may comment on the contributions of another such as “Mike made S'mores for everyone and played really great campfire songs for us! That user might upload a clip of Mike playing one of the songs. If a rating system is used the rating user may select a rating option. In one embodiment a rating system might include both negative rating options and positive rating options. In this way users who participated, but negatively affected the event, according to another user's opinion, might be singled out. Other users may dispute a negative rating or comment. Users may debate and agree or disagree about the participation ratings of other users. In one embodiment where each user has a section of the document to work in, no other users may comment or upload media to that user's section in the document.

In one embodiment of the invention the system aggregates rating data about users over numerous activities in which those users have participated. In this scenario the system may maintain a user participation rating for a user that reflects an average rating or score based on all of the user's participation ratings over a period of time, for example 1 month. This indication might include a star system such as five stars for excellent down to one star for mediocre.

In one embodiment of the present invention server 3201, with the aid of document generator 3205, generates activity participation review pages when the group activities are first enabled and scheduled in the system. In this scenario the pages may not be accessible until the group activity has transpired. In one embodiment users who are registered to participate in the scheduled group activity might receive invitation to the activity Web document when they receive notification of the activity in which they have been selected or matched to participate. The Web document may contain interactive indicia that allow a user to sign up to participate in the activity through the Web document.

In one embodiment rating is limited to identifying a user to be rated and then selecting from a drop down menu or other menu type a rating statement from a set of rating statements provided by the system. In one embodiment rating data may be used as part of the criteria for ranking users who are matched to future activities. In this scenario negative ratings might affect whether or not particular users are invited to future activities.

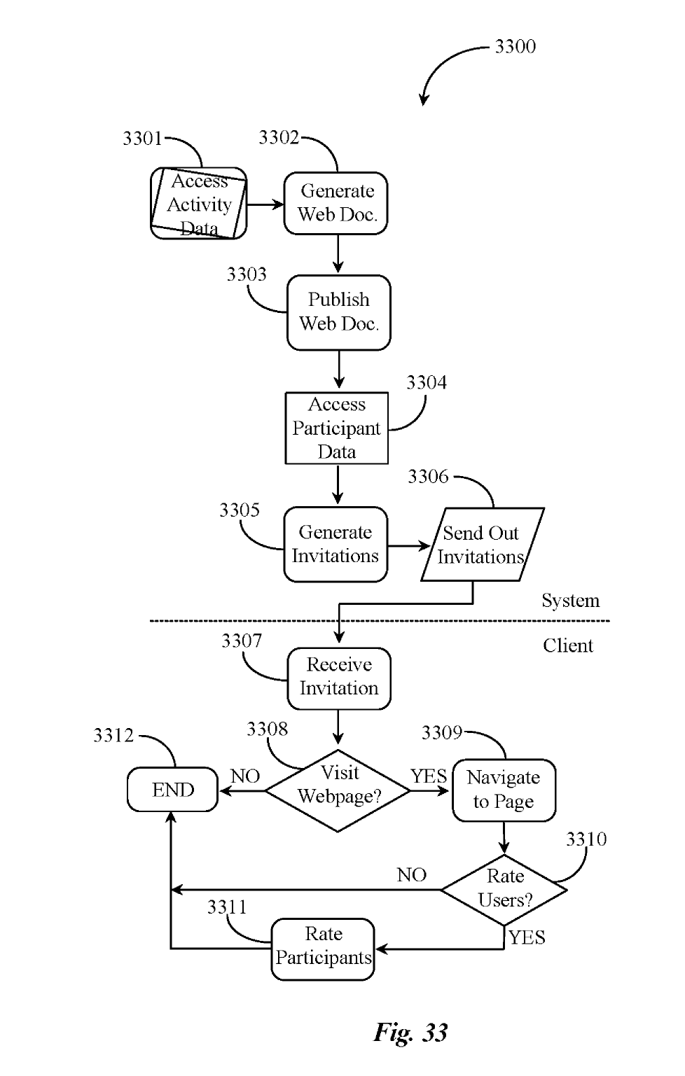

FIG. 33 is a process flow diagram 3300 depicting steps for publishing a ratings page and inviting participants to rate other participants. At step 3301 a server analogous to server 3201 of FIG. 32 accesses activity data relative to one or more group activities that have been scheduled and have transpired. The activity data may be accessed upon request, such as a server query requesting transpired activities for a set period of time in system history. The activity data may include the activity title, activity type, description, location and date of the activity, as well as the identifications of all of the activity participants.

At step 3302 the server, aided by a document generation engine, generates one or more Web documents that document each activity subject to the data acquisition by the server. The Web document may be a HTTP Web document or any navigable Web document in any supported format for access by users operating both wired and or wireless appliances. Each generated Web document represents an activity review page for the activity it represents.

At step 3303 the server publishes each generated activity review page such that those generated pages are accessible over the network using a URL address. Each review page may include any media that was available and was associated with the activity before the activity transpired. At step 3304 the system accesses participant data for each activity review page generated. The participant data includes identification of each participant and sufficient contact information for notifying the participants.

For each generated document representing a transpired group activity the system generates invitations to visit the generated Web document at step 3305 for all of the participants that participated in the group activity represented by that document. At step 3306 the system sends the generated invitations to each participant. The invitations may be in the form of alerts, notifications, text messages, emails or other communications. Steps 3301 through 3306 are undertaken by the service of the invention.

At step 3307 a participant of a group activity for which an activity review page was generated receives an invitation to visit the generated page and perhaps rate other participants and upload any media the user might have taken at the event. In step 3308 the user may make a determination after receiving an invitation whether to actually visit the page or not. If at step 3308 the user decides not to visit the page the process may end at step 3312. The user may visit the page at a later point in time. If and when the user decides to visit the generated Web page the process may move to step 3309 where the user navigates to the generated Web page.

At step 3310 the user may determine whether or not to rate users on the page. Rating users may involve posting comments, selecting rating statements or scores from a menu, and so on. If the user decides not to rate other users while visiting the site the process may end at step 3312. If a user decides not to rate other users at step 3310 the user may still view other rating information provided by other users. If the user decides to rate one or more other users who participated in the activity the process moves to step 3311 where the user might rate the participation of one or more other users.

One user might rate one or a few other users. One user may rate all of the other participants. To rate participation of other users a user is required to have participated in the same activity. If a user has not participated he or she would not receive an invitation, and if they were to navigate to the page after, for example, browsing such pages, the page may be “read only” or otherwise not interactive for that user. After a user rates one or more other users at step 3311 the process may end at step 3312. In one embodiment a user may continue to access a page and rate other participants over a period of time. In one embodiment the system may impose a rating window within which rating comments by participants may be accepted. In addition to rating information users may, in one embodiment, upload pictures, video clips, embed URLs, or provide links to other pages.

Rating information provided about group activity participants may be used by the system to help rank such participants when matched by attributes to future activities. In this light a participant who has a negative participant rating for a certain activity may be invited to fewer activities in the future, while one who consistently has high participation ratings may score higher and thus may be invited to future activities with more frequency.

### Ranking User Profile Attributes

In one embodiment users may rank, rate or attach a level of importance to any of their properties attached to their accounts. Properties that users may rank include group profile attributes that are used to curate other users to participate in group activities.

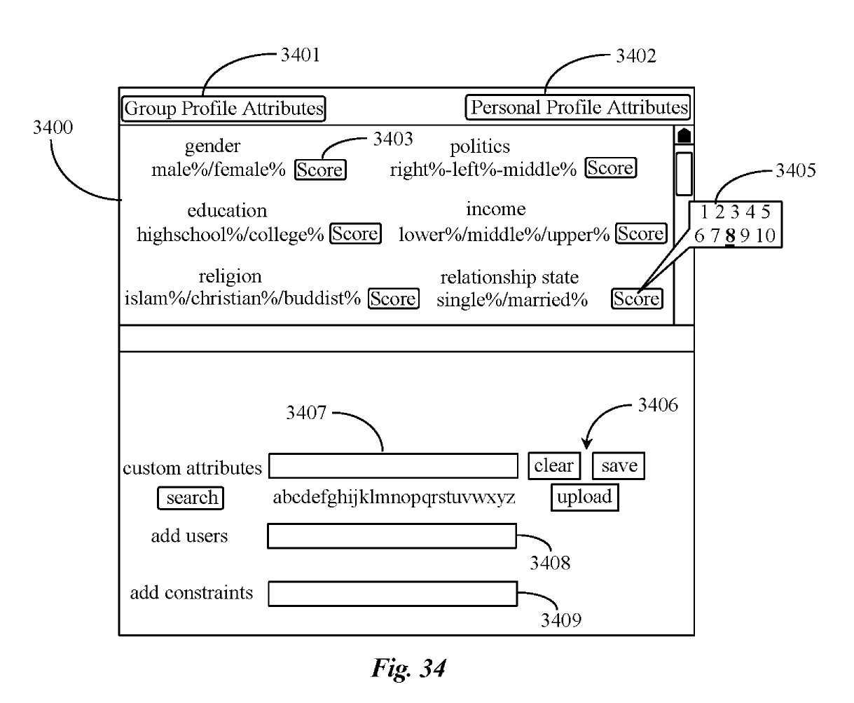

FIG. 34 is a display view of an interface component 3400 for enabling a user to rank profile attributes. Interface component 3400 may be similar to a group profile template 1100 described further above with respect to FIG. 11. It was described further above that a user may create a group profile from a template for one or more group activities. A group profile enables the system to curate other users for the purpose of inviting those users to participate in a group activity to which a group profile is attached. The system attempts to aggregate those other users whose personal profile attributes match the group profile in some significant way or to a level that satisfies the goal.

Interface component 3400 may be part of or integrated with GC APP 109 of FIG. 1. When a user creates a group profile, he or she may provide attributes and mathematical constraints and other rules that the system will rely upon in its curation process. In this example component 3400 includes an option 3401 for selecting group profile attributes and an option 3402 for selecting personal profile attributes. A user operating interface component 3400 may score or rank group profile attributes and personal profile attributes. In one embodiment a user may also rank activity profile attributes. An activity profile may include activities in which a user has some interest.

Scoring or ranking a property attached to a user account, such as a profile attribute, implies that the system will use the score in the process of curation at least for the property that is ranked. For example, if a user likes practicing yoga as an activity, and the attribute yoga is part of that user's group profile for use in finding other users to participate in an activity in which the user wants to participate, the user may apply a rank to the attribute yoga to indicate the level of importance that the user attributes to his or her admiration for the practice of yoga.

In this example a score button 3403 accompanies each listed attribute in the user's group profile attributes. In this example the score button may be selected to call up a ranking interface 3405 in which the user may select one of a number of importance levels or scores. In this particular example scoring interface 3405 is a number system from 1 to 10. Therefore the user may select any number from 1 to 10 to apply a level of importance to the attribute or property. For example, a user may desire that the relationship states of potential participants that might be aggregated to fill an activity in which the user will participate should be at least 60% single. If the user applies a 10 to that (property) of the attribute relationship status, the system will understand that it should not curate any mix of users where less than 60% are single.

A user may type custom attributes into an input field 3407 and may add specific users with an input field 3408, and may add constraints to an attribute using input field 3409. Options 3406 enable clearing, saving, and uploading profile attributes. In one embodiment a user may select personal profile attributes and may apply some level of importance to one or more of those attributes using the ranking system. For example, assume a user likes yoga as previously described above. This is a personal profile attribute for the user falling under the category of things in which the user has interest. The user may insert this into a group profile wherein the user desires that other users that might participate in an activity with the user at least have a strong interest in yoga, regardless of the activity for which the potential participants are being aggregated. The system would enforce that each of the users that might be invited to an activity in which the user will participate at least have a strong liking for yoga.

A user might simply create a constraint to control curation based on profile attribute matching, like Christian followed by 100%. That would imply that the user will not want to interact with any non-Christians during a particular activity. However, if a user is Christian, he may further rank an attribute associated with Christianity such as 6 day Creationist. The score for 6 day Creationist might be 10 indicating that of the Christians aggregated for the activity the user has a very strong desire that they not only be Christian but that they be 6 day Creationists. One with skill in the art will recognize that there may be attributes or properties attached to a user's account for which scoring does not make sense. However for some attributes, including nascent interests, scoring such interests in personal and group profile information may aid the system to better match other users to an activity that will be attended by the requesting or operating user.

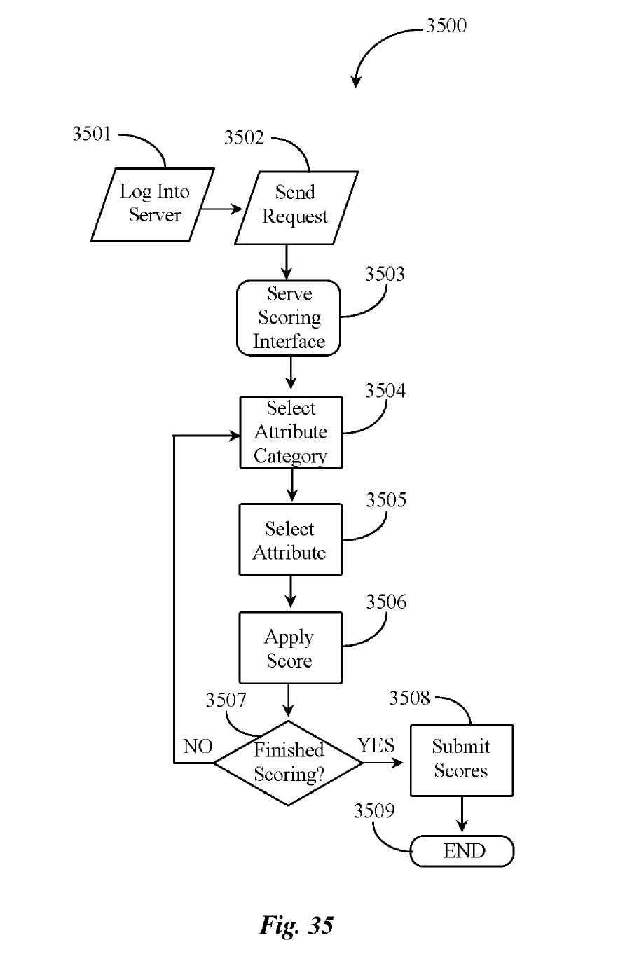

FIG. 35 is a process flow chart 3500 depicting steps for ranking profile attributes. At step 3501 a user may log into the server and access the general interface for practicing the present invention. At step 3502 the user may send a request to the server for a scoring interface for applying some level of importance to some or more attributes or other properties of the user.

At step 3503 the server responds by serving the scoring interface. The scoring interface may be associated with a group profile template or any other configuration interface for creating and adding new properties or attributes for any purpose. At step 3504 the user may select an attribute category. At step 3505 the user may select an attribute. At step 3506 the user may, leveraging the scoring tool, apply a score to that attribute.

At step 3507, the user may determine if he or she is finished scoring attributes or other properties. At step 3507, if the user is not finished, the process resolves back to step 3504, and the process may loop until the user is finished. It is noted that the user may apply scores to all of the attributes or properties before submitting those scores. Likewise a user may call up these attributes and change scores. In step 3507, if the user is finished scoring, the user may submit all of the scores to the service at step 3508. The process may then end at step 3509.

In one embodiment the scoring tools include a drop-down menu containing different importance level indications from which to select. In one embodiment a user may input rating information in the form of natural typed language into a text interface. In one embodiment the scoring tool includes two or more checkboxes next to an attribute, the check boxes representing levels of importance. In one embodiment the system may automatically score user attributes from profiles or other properties automatically based on repeated instances of use of those attributes in the past.

### Additional Embodiments

A system for creating and managing a group activity over a data network, the group activity having a plurality of assigned seats and requiring participation by two or more users, the system comprising:

a non-transitory, computer-readable data storage medium comprising program code to be executed; and

a processor that is adapted to execute the program code to automatically aggregate a plurality of users into participants for the group activity having the plurality of assigned seats, the participants automatically grouped into one or more smaller subgroups based on desired attributes of each member of the smaller subgroup, the program code enabled to execute functions for:

a generation of a personal profile of each user, the personal profile describing attributes about each user, wherein the attributes are one or more attributes selected from the group consisting of gender, race, sexual orientation, education level, school attended, job title, job description, physical characteristics, religious affiliation, political affiliation, and memberships;

a generation of one or more preference profiles of a desired participant for the group activity, the preference profiles comprising a set of attributes that defines types of users that other users desire to interact with during participation in the group activity;

an identification of a subset of the users to determine a plurality of participants for participation in the group activity, wherein the plurality of participants corresponds to the subset of the users identified for participation in the group activity;

a comparison of information in the personal profiles to the preference profiles of the identified participants to determine a degree of match between members within smaller subgroups of the participants, wherein the smaller subgroups are subgroups of the participants, which participants are themselves the identified subset of the users of the system;

a sub-grouping of the identified participants into the one or more smaller subgroups according to the degree of match between each member of the smaller subgroups, the smaller subgroups comprising a subset of the participants identified for participation in the group activity, which participants are themselves the identified subset of the users of the system; and

an assignment of the identified participants in the group activity, grouped into the one or more smaller subgroups, to the plurality of assigned seats in the group activity, wherein the assigned seats are spaces in the group activity in which seats can be assigned ahead of participation in the group activity, wherein the identified participants are assigned to the assigned seats in such a way as to optimize the degree of match between participants assigned to nearby seats.

The system above, further comprising:

an identification of the personal profiles of the users that meet the one or more preference profiles to determine the plurality of participants in the group activity, the plurality of participants being a subset of the users.

The system above, further comprising:

a presentation of the group activity, the identified participants in the group activity, the plurality of smaller subgroups of the identified participants, and the plurality of assigned spaces and the users assigned to each assigned space to one or more of the users.

The system above, wherein a union of all of the smaller subgroups comprises all participants identified for participation in the group activity.

The system above, wherein the subgroups comprise two people in a pair.

The system above, wherein the assigned spaces are seats in an environment selected from the group consisting of transportation, buses, airplanes, boats, theater, movies, opera, dinner arrangements, auditoriums, and arenas.

The system above, wherein the processor is further adapted to execute program code to implement:

determination of initial pricing to be enforced for participation in the group activity;

evaluation of information about users scheduled to participate in the group activity periodically after the initial pricing is determined;

adjustment of the pricing for the group activity based on results of the periodic evaluation; and

publishing of an updated pricing accessible to the users over the data network.

The system above, wherein each personal profile comprises at least one respective attribute, each preference profile comprises at least one respective attribute, and personal profiles of users that meet the preference profile comprise personal profiles that share a defined amount of attributes with the preference profile.

The system above, wherein each personal profile comprises at least one respective attribute, each preference profile comprises at least one respective attribute, and personal profiles of users that meet the preference profile comprise personal profiles that share a defined combination of attributes with the preference profile.

The system above, wherein each personal profile comprises at least one respective attribute, each preference profile comprises at least one respective attribute, and personal profiles of users that meet the preference profile comprise personal profiles that share a defined key attribute with the preference profile.

The system above, wherein said processor is adapted to execute the program code to further implement a notification of each user with a personal profile that meets the preference profile.

The system above, wherein a user comprises a system-identified user on a social interaction network accessible by the system and said processor is adapted to execute the program code to further implement an access of profile information of said user on the social interaction network to generate a personal profile for said user.

A system that accesses and executes program code from a non-transitory, computer-readable data storage medium for providing a group curation platform for automatically aggregating a plurality of system users into participants for a group activity having a plurality of assigned spaces, the participants automatically grouped into a plurality of subgroups based on desired attributes of each member of the subgroup, the system comprising:

at least one processor that executes the program code to implement an algorithm that:

creates a personal profile for each of a plurality of system users from information supplied by each respective system user;

creates a system user group activity from information supplied by a first system user; creates one or more preference profiles of a desired system user for a respective group activity from information supplied by said first system user;

aggregates desired system users for a respective group activity based on a correspondence of a respective personal profile of each system user with the preference profile; compares information in the personal profiles to determine a strength-of-match between system users populating the group activity;

groups the participants into the plurality of subgroups according to the strength-of-match between each member of the subgroup; and

assigns the participants of the group activity, grouped into the subgroups, to the plurality of spaces in the group activity.

The system above, wherein correspondence of a respective personal profile of each system user with the preference profile comprises an overlap of attributes between said respective personal profile of a user and the preference profile.

The system above, wherein the preference profile is a subset of the personal profile of said first system user.

The system above, wherein the group activity comprises information regarding the skill level required for the group activity.

The system above, wherein said at least one processor executes the program code to further implement an algorithm that creates a system user group activity from information supplied by an activity vendor and creates a preference profile of a desired system user for a respective group activity from information supplied by said activity vendor.

The system above, wherein said at least one processor executes the program code to further implement an algorithm that promotes a respective group activity to each system user of the aggregated desired system users for the respective group activity, and invites individuals having personal profiles that have a defined level of match with the preference profile to participate in the respective group activity.

A method for automatically aggregating a plurality of individuals into participants for a group activity having a plurality of assigned spaces, the participants automatically grouped into a plurality of subgroups based on desired attributes of each member of the subgroup, said method being implemented by a processor that accesses and executes program code, stored in a non-transitory, computer-readable data storage medium, the method comprising:

generating a personal profile for each one of the plurality of individuals from information supplied by each respective individual;

generating a group activity from information supplied by a first individual;

generating a preference profile of a desired participant for a respective group activity from information supplied by said first individual;

initiating a search of the personal profiles of the plurality of individuals to find personal profiles that have a defined level of match with the preference profile; and

returning the results of the search to said first individual, including recommended subgroups of the individuals into the plurality of subgroups and the plurality of assigned spaces, according to the strength-of-match between each member of the subgroup.

### CONCLUSIONS

One of ordinary skill in the art knows that the use cases, structures, schematics, and flow diagrams may be performed in other orders or combinations, but the inventive concept of the background uploading of media files remains without departing from the broader spirit of the invention. Every embodiment may be unique, and methods/steps may be either shortened or lengthened, overlapped with the other activities, postponed, delayed, and continued after a time gap, such that every user is accommodated for background uploading of media files.

The present invention may be implemented in hardware and/or in software. Many components of the system, for example, network interfaces etc., have not been shown, so as not to obscure the present invention. However, one of ordinary skill in the art would appreciate that the system necessarily includes these components. A user-device is a hardware that includes at least one processor coupled to a memory. The processor may represent one or more processors (e.g., microprocessors), and the memory may represent random access memory (RAM) devices comprising a main storage of the hardware, as well as any supplemental levels of memory e.g., cache memories, non-volatile or back-up memories (e.g. programmable or flash memories), read-only memories, etc. In addition, the memory may be considered to include memory storage physically located elsewhere in the hardware, e.g. any cache memory in the processor, as well as any storage capacity used as a virtual memory, e.g., as stored on a mass storage device.

The hardware of a user-device also typically receives a number of inputs and outputs for communicating information externally. For interface with a user, the hardware may include one or more user input devices (e.g., a keyboard, a mouse, a scanner, a microphone, a web camera, etc.) and a display (e.g., a Liquid Crystal Display (LCD) panel). For additional storage, the hardware my also include one or more mass storage devices, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware may include an interface with one or more networks (e.g., a local area network (LAN), a wide area network (WAN), a wireless network, and/or the Internet among others) to permit the communication of information with other computers coupled to the networks. It should be appreciated that the hardware typically includes suitable analog and/or digital interfaces between the processor.

The hardware operates under the control of an operating system, and executes various computer software applications, components, programs, codes, libraries, objects, modules, etc. indicated collectively by reference numerals in FIG. 1U to perform the personalization techniques described above.

In general, the method executed to implement the embodiments of the invention, may be implemented as part of an operating system or a specific application, component, program, object, module or sequence of instructions referred to as “computer program(s)” or “computer code(s).” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), and digital and analog communication media.

Although the present invention has been described with reference to specific exemplary embodiments, it will be evident that the various modification and changes can be made to these embodiments without departing from the broader spirit of the invention. Accordingly, the specification and drawings are to be regarded in an illustrative sense rather than in a restrictive sense. It will also be apparent to the skilled artisan that the embodiments described above are specific examples of a single broader invention which may have greater scope than any of the singular descriptions taught. There may be many alterations made in the descriptions without departing from the spirit and scope of the present invention.

It will be apparent to one with skill in the art that the group curation system of the invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

What is claimed is:

1. A system for automatically adjusting a pricing for participation in a group activity having a plurality of participants from among a plurality of users of the system, the system comprising a non-transitory, computer-readable data storage medium comprising program code that can be executed; and a processor that is adapted to execute the program code to implement:
a generation of a personal profile of each user;
a generation of one or more preference profiles of a desired participant for a group activity;
an identification of the personal profiles of the users that meet the one or more preference profiles;
a determination of initial pricing for participation in the group activity;
a recommendation of a subset of the users as the plurality of participants in the group activity based on the preference profiles and the personal profiles of the users;
an evaluation of information about the users which have opted to participate in the group activity periodically after the initial pricing is determined;
an adjustment of the initial pricing for participation in the group activity based on results of the evaluation; and
a publication of an updated pricing that is accessible to the users, enabling additional users to sign up for the group activity based on the updated pricing.

2. The system of claim 1, wherein each personal profile comprises at least one respective attribute, each preference profile comprises at least one respective attribute, and personal profiles of system users that meet the preference profile comprise personal profiles that share a defined amount of attributes with the preference profile.

3. The system of claim 1, wherein each personal profile comprises at least one respective attribute, each preference profile comprises at least one respective attribute, and personal profiles of users that meet the preference profile comprise personal profiles that share a defined combination of attributes with the preference profile.

4. The system of claim 1, wherein each personal profile comprises at least one respective attribute, each preference profile comprises at least one respective attribute, and personal profiles of system users that meet the preference profile comprise personal profiles that share a defined key attribute with the preference profile.

5. The system of claim 1, wherein said processor is adapted to execute the program code to further implement a notification of each user with a personal profile that meets the preference profile.

6. The system of claim 1, wherein a system user comprises a system-identified user on a social interaction network accessible by the system and said processor is adapted to execute the software program code to further implement an access of profile information of said system user on the social interaction network to generate a personal profile for said system user.

7. The system of claim 1, wherein information about the users comprises information about users newly scheduled to participate in the group activity after the initial pricing.

8. The system of claim 1, wherein the updated pricing is generated regarding users for whom information has changed since a previous iteration.

9. The system of claim 1, wherein the updated pricing is generated based on information about user participation history comprising at least purchase history.

10. The system of claim 1, wherein the updated pricing is generated based on changes in one or a combination of number of total participants, gender mix of participants, membership status of participants relative to the group activity, age mix of the participants, and past behavior of participants at a same or similar activity.

11. The system of claim 1, wherein the updated pricing is generated based on information about registration to specific sub-activities included in the group activity.

12. The system of claim 1, wherein the initial and updated pricing is generated by a third-party vendor hosting and managing the group activity.

13. The system of claim 1, wherein the updated pricing is generated based on information about amounts of monies users have spent on the group activity prior to participation.

14. A method for automatically adjusting a pricing for participation in a group activity having a plurality of participants from among a plurality of users, said method being implemented by a processor that accesses and executes program code stored on a non-transitory, computer-readable data storage medium, the method comprising:
generating a personal profile of each user;
generating one or more preference profiles of a desired participant for the group activity;
identifying the personal profiles of the users that meet the one or more preference profiles;
determining an initial pricing for participation in the group activity;
recommending a subset of the users as the plurality of participants in the group activity based on the preference profiles and the personal profiles of the users;
evaluating information about the users which have opted to participate in the group activity periodically after the initial pricing is determined;
adjusting the initial pricing for participation in the group activity based on results of the periodic evaluation; and
publishing an updated pricing that is accessible to the users, enabling additional users to sign up for the group activity based on the updated pricing.

15. The method of claim 14, wherein information about the users comprises information about users newly scheduled to participate in the group activity after the initial pricing.

16. The method of claim 14, wherein the updated pricing is generated regarding users for whom information has changed since a previous iteration.

17. The method of claim 14, wherein the updated pricing is generated based on information about user participation history comprising at least purchase history.

18. The method of claim 14, wherein the updated pricing is generated based on changes in one or a combination of number of total participants, gender mix of participants, membership status of participants relative to the group activity, age mix of the participants, and past behavior of participants at a same or similar activity.

19. The method of claim 14, wherein the updated pricing is generated based on information about registration to specific sub-activities included in the group activity.

20. The method of claim 14, wherein the updated pricing is generated based on information about amounts of monies users have spent on the group activity prior to participation.
